(19) United States
(12) Patent Application Publication
(10) Pub. No.: US 2022/0127781 A1
(43) Pub. Date: Apr. 28, 2022

(54) SILK COATED LEATHER AND PRODUCTS AND METHODS OF PREPARING THE SAME

(71) Applicant: EVOLVED BY NATURE, INC., Medford, MA (US)

(72) Inventors: Gregory H. ALTMAN, Providence, RI (US); Carlos J. BOSQUES, Arlington, MA (US); Alexander J. WOLFE, Cambridge, MA (US); Sara A. JOHNSON, Medford, MA (US); Enrico MORTARINO, Hickory, NC (US); Maria L. UFRET, Grafton, MA (US); Sanghamitra SEN, Somerville, MA (US)

(21) Appl. No.: 17/260,336

(22) PCT Filed: Jul. 18, 2019
(86) PCT No.: PCT/US19/42448

§ 371 Date: Jan. 14, 2021

Related U.S. Application Data
(60) Provisional application No. 62/700,062, filed on Jul. 18, 2018.
(60) Provisional application No. 62/875,130, filed on Jul. 17, 2019.

(51) Int. Cl. D06M 14/06; C14C 11/00

(52) U.S. Cl. CPC D06M 14/06; C14C 11/003

(57) ABSTRACT

Silk processed, coated, repaired, and/or infused leather or leather articles, and methods of preparing the same are disclosed herein. In some embodiments, the invention relates to silk-coated leather apparel and products for use in home and automotive applications, such as leather coated with pure silk fibroin-based proteins or protein fragments thereof. In some embodiments, the invention relates to silk and silk protein fragments compositions, and methods of making and using thereof, for processing leather, for example coating leather, and/or repairing, hiding, or masking defects on or within leather, and/or as a mixing agent, additive, or replacement for leather processing chemicals.

### FIELD OF THE INVENTION

In some embodiments, the invention relates to silk-coated leather apparel and products for use in home and automotive applications, such as leather coated with pure silk fibroin-based proteins or protein fragments thereof. In some embodiments, the invention relates to silk and silk protein fragments compositions, and methods of making and using thereof, for processing leather, for example coating leather, and/or repairing, hiding, or masking defects on or within leather, and/or as a mixing agent, additive, or replacement for leather processing chemicals.

### BACKGROUND OF THE INVENTION

Silk is a natural polymer produced by a variety of insects and spiders, and comprises a filament core protein, silk fibroin, and a glue-like coating consisting of a non-filamentous protein, sericin. Silk fibers are lightweight, breathable, and hypoallergenic.

### SUMMARY OF THE INVENTION

Silk coated leather products and methods of preparing the same are disclosed herein. Silk and silk protein fragments, and silk and silk protein fragments (SPF) compositions as described herein, may be used to lock in color, as a surface treatment, in place or in addition to of any chemical used during any chemical processing step, to alter appearance, hand, texture, and/or quality of leather.

In some embodiments, silk and silk protein fragments, and silk and silk protein fragments compositions as described herein, may be used for finishing leather, for example to alter the sheen or luster of leather, and/or to achieve finishes such as matte, glossy, mirror, embossed, etc.

In some embodiments, silk and silk protein fragments, and silk and silk protein fragments compositions as described herein, may be used for repairing, masking, or hiding defects in leather or in hides, for example follicle defects, or other mechanical defects, whether superficial, or within the leather or hide.

In some embodiments, silk and silk protein fragments, and silk and silk protein fragments compositions as described herein, may be used to alter and/or improve the appearance of leather, hides, and/or leather products, or to change the grade of leather or hides, and thus to widen the array of applicable market areas for a given leather type.

In some embodiments, silk and silk protein fragments, and silk and silk protein fragments compositions as described herein may be used to improve the hand of leather, for example its feel, or description of softness.

In some embodiments, silk and silk protein fragments, and silk and silk protein fragments compositions as described herein, may be used as a pigment delivery system during the finishing phase, or at any other appropriate process step, to lock in color, adjust final coloration, or alter pigment chemistry or to improve colorant delivery.

In some embodiments, silk and silk protein fragments, and silk and silk protein fragments compositions as described herein, may be used before or after any mechanical processing step typical of leather processing, including, but not limited to, before or after Uniflex treatment, Finiflex treatment, heat stamping treatment, polishing treatment, skin trimming, or drying. In some embodiments, silk and silk protein fragments, and silk and silk protein fragments compositions as described herein, may be used prior to any mechanical process described herein. In some embodiments, silk and silk protein fragments, and silk and silk protein fragments compositions as described herein, may be used during a finishing or dyeing process. In some embodiments, silk and silk protein fragments, and silk and silk protein fragments compositions as described herein, may be used prior to any press treatment described herein

In some embodiments, silk and silk protein fragments, and silk and silk protein fragments compositions as described herein, may be used by spraying on leather.

In some embodiments, silk and silk protein fragments, and silk and silk protein fragments compositions as described herein, may be used by stamping on leather.

In some embodiments, silk and silk protein fragments, and silk and silk protein fragments compositions as described herein, may be integrated into and onto leather.

In some embodiments, silk and silk protein fragments, and silk and silk protein fragments compositions as described herein, may be used prior, during, or after a leather processing step, for example a finishing process, in lieu of any chemistry used for stabilizing, altering sheen, luster, color, darkness, tone, finish, hand, weight, etc.

In some embodiments, silk and silk protein fragments, and silk and silk protein fragments compositions as described herein, may be used prior, during, or after a leather processing step, for example a finishing process, in addition to any chemistry used for stabilizing, altering sheen, luster, color, darkness, tone, finish, hand, etc.

In some embodiments, silk and silk protein fragments, and silk and silk protein fragments compositions as described herein, may be used to serve one or more chemical function during the tanning stage up to and through the dyeing stage of leather processing.

In some embodiments, silk and silk protein fragments, and silk and silk protein fragments compositions as described herein, may be used to serve one or more or mechanical function during the tanning stage up to and through the dyeing stage of leather processing.

In some embodiments, silk and silk protein fragments, and silk and silk protein fragments compositions as described herein, may be used to serve one or more functions during the tanning stage up to and through the dyeing stage of leather processing.

In some embodiments, silk and silk protein fragments, and silk and silk protein fragments compositions as described herein, may be used prior, during, or after a leather processing step, for example a finishing process, to alter the contact angle of solvents applied to semi-finished or finished leathers.

In some embodiments, silk and silk protein fragments, and silk and silk protein fragments compositions as described herein, may be used prior, during, or after a leather processing step, for example a finishing process, as a defect filling agent of either pre- or post-dyed skins. In some embodiments, such use includes combination with a pigment, dye, blending agent, softening agent, rheology modifier etc.

In some embodiments, silk and silk protein fragments, and silk and silk protein fragments compositions as described herein, may be used prior to, during, or after any process described herein, and for any purpose described herein, and such use be augmented by the additional use of one or more physicochemical processing treatments, including but not limited to O₂ plasma, use of a crosslinking agent, a photo-crosslinking agent, or an ultraviolet treatment.

In some embodiments, silk and silk protein fragments, and/or silk and silk protein fragments compositions as described herein, can be mixed with, or replace classes of materials including, but not limited to, aqueous lacquers, waxes, oils, protein or other binders, fillers, hand-modifiers, levelling agents, solvent lacquers, water-based lacquers, penetrators, acrylic resins, butadiene resins, compact resins, hybrid resins, impregnation resins, rheology modifiers, solvent dullers, solvent urethanes, water-based dullers, water-based topcoats, chromes, dye dispersing agents, acidic dyes, basic dyes, chromium-based or other dyes, and/or colorants.

In some embodiments, the leather preparation process may include the treating of leather with a silk and/or SPF composition described herein. In some embodiments, the silk and/or SPF composition may include one or more chemical agents as described hereinbelow (e.g., silicone, polyurethane, etc.).

In an embodiment, the invention described herein includes a method of treating leather with a silk and/or SPF composition described herein, wherein the method may include the steps of: dyeing the leather; mechanically stretching the leather; trimming the leather; polishing the leather; applying (optionally by spray application) a pigment, and/or an acrylic coating to the leather; chemically fixing the leather, stamping the leather, applying a silicone or other finish to the leather; providing a Uniflex treatment to the leather; and/or filling a defect on the surface or within the leather with a silk or SPF composition; wherein one or more of the foregoing steps includes applying the silk and/or SPF composition to the leather before, during, or after the recited steps.

In an embodiment, the invention described herein includes a method of treating leather with a silk and/or SPF composition described herein, wherein the method may include the steps of: dyeing the leather, drying the leather; mechanically stretching the leather; trimming the leather; performing a first polish of the leather; applying (optionally by spray application) a colorant, and/or an acrylic to the leather; performing a second polish of the leather, providing a Finiflex treatment to the leather; and/or filling a defect on the surface or within the leather with a silk or SPF composition; wherein one or more of the foregoing steps includes applying the silk composition to the leather before, during, or after the recited steps.

In some embodiments, a silk and/or SPF composition described herein may be applied to leather or a leather article by any of the methods described herein, but also by hand-spraying, spraying using a mechanical spray setup, applying by brush, bath coating, rubbing, wet-mixing, washing, drumming, soaking, extruding, injecting, plastering, roller coating, and/or filling.

In some embodiments, a silk and/or SPF composition described herein may be applied alone, mixed with one or several chemicals (e.g., chemical agents), as one coat or multiple coats at multiple times using varied application methods, to leathers that have or have not been: dyed, chrome-treated, sprayed with: pigment, acrylic, fixation agents, finishing agents, and/or colorants. In some embodiments, a silk and/or SPF composition described herein may be applied to a finished leather or leather article, a mechanically treated leather or leather article, or a drummed leather or leather article. In some embodiments, a silk and/or SPF composition described herein may be applied into a defect of a finished leather or leather article, a mechanically treated leather or leather article, or a drummed leather or leather article.

In some embodiments, a silk and/or SPF composition described herein may be applied to leather or a leather article as a defect filler pre-dyeing and prior to finishing. In some embodiments, a silk and/or SPF composition described herein may be applied to leather or a leather article as a defect filler after dyeing and prior to finishing. In some embodiments, a silk and/or SPF composition described herein may be applied to leather or a leather article as a defect filler after dyeing and after finishing.

In some embodiments, a silk and/or SPF composition described herein may be applied to leather or a leather article as a defect filler, wherein application is by hand. In some embodiments, a silk and/or SPF composition described herein may be applied to leather or a leather article as a defect filler, wherein application is by finger. In some embodiments, a silk and/or SPF composition described herein may be applied to leather or a leather article as a defect filler, wherein application is by using a brush-type applicator. In some embodiments, a silk and/or SPF composition described herein may be applied to leather or a leather article as a defect filler, wherein application is by using a marker-type applicator. In some embodiments, a silk and/or SPF composition described herein may be applied to leather or a leather article as a defect filler, wherein application is by using a pen-type applicator. In some embodiments, a silk and/or SPF composition described herein may be applied to leather or a leather article as a defect filler, wherein application is by using a pipette-type applicator. In some embodiments, a silk and/or SPF composition described herein may be applied to leather or a leather article as a defect filler, wherein application is by using a syringe-type applicator. In some embodiments, a silk and/or SPF composition described herein may be applied to leather or a leather article as a defect filler, wherein application is by using an eyeliner brush-type applicator and any brush or brush-like applicator. In some embodiments, a silk and/or SPF composition described herein may be applied to leather or a leather article as a defect filler, wherein application is by using a heated stamp device applicator. In some embodiments, a silk and/or SPF composition described herein may be applied to leather or a leather article as a defect filler, wherein application is by using a sponge applicator. In some embodiments, a silk and/or SPF composition described herein may be applied to leather or a leather article as a defect filler, wherein application is by using a roller-coater In some embodiments, a silk and/or SPF composition described herein may be applied to leather or a leather article as a defect filler, wherein application is by “glue-gun”-like applicator.

In some embodiments, a silk and/or SPF composition described herein may be applied as a defect filler to bovine skin leather or leather article. In some embodiments, a silk and/or SPF composition described herein may be applied as a defect filler to sheep skin leather or leather article. In some embodiments, a silk and/or SPF composition described herein may be applied as a defect filler to lamb skin leather or leather article. In some embodiments, a silk and/or SPF composition described herein may be applied as a defect filler to horse skin leather or leather article. In some embodiments, a silk and/or SPF composition described herein may be applied as a defect filler to crocodile skin leather or leather article. In some embodiments, a silk and/or SPF composition described herein may be applied as a defect filler to alligator skin leather or leather article. In some embodiments, a silk and/or SPF composition described herein may be applied as a defect filler to avian skin leather or leather article. In some embodiments, a silk and/or SPF composition described herein may be applied as a defect filler to animal skin leather or leather article. In some embodiments, a silk and/or SPF composition described herein may be applied as a defect filler to split leather or leather article. In some embodiments, a silk and/or SPF composition described herein may be applied as a defect filler to suede leather or leather article. In some embodiments, a silk and/or SPF composition described herein may be applied as a defect filler to wet blue leather or leather article. In some embodiments, a silk and/or SPF composition described herein may be applied as a defect filler to altered leather or leather article. In some embodiments, a silk and/or SPF composition described herein may be applied as a defect filler to aniline leather or leather article. In some embodiments, a silk and/or SPF composition described herein may be applied as a defect filler to bonded leather or leather article. In some embodiments, a silk and/or SPF composition described herein may be applied as a defect filler to brushed leather or leather article. In some embodiments, a silk and/or SPF composition described herein may be applied as a defect filler to buffed leather or leather article. In some embodiments, a silk and/or SPF composition described herein may be applied as a defect filler to Bycast leather or leather article. In some embodiments, a silk and/or SPF composition described herein may be applied as a defect filler to chamois leather or leather article. In some embodiments, a silk and/or SPF composition described herein may be applied as a defect filler to plonge leather or leather article. In some embodiments, a silk and/or SPF composition described herein may be applied as a defect filler to chrome-tanned leather or leather article. In some embodiments, a silk and/or SPF composition described herein may be applied as a defect filler to combination tanned leather or leather article. In some embodiments, a silk and/or SPF composition described herein may be applied as a defect filler to Cordovan leather or leather article. In some embodiments, a silk and/or SPF composition described herein may be applied as a defect filler to corrected grain leather or leather article. In some embodiments, a silk and/or SPF composition described herein may be applied as a defect filler to crockproof leather or leather article. In some embodiments, a silk and/or SPF composition described herein may be applied as a defect filler to drummed leather or leather article. In some embodiments, a silk and/or SPF composition described herein may be applied as a defect filler to embossed leather or leather article. In some embodiments, a silk and/or SPF composition described herein may be applied as a defect filler to enhanced grain leather or leather article. In some embodiments, a silk and/or SPF composition described herein may be applied as a defect filler to grained leather or leather article. In some embodiments, a silk and/or SPF composition described herein may be applied as a defect filler to metallized leather or leather article. In some embodiments, a silk and/or SPF composition described herein may be applied as a defect filler to naked leather or leather article. In some embodiments, a silk and/or SPF composition described herein may be applied as a defect filler to natural grain leather or leather article. In some embodiments, a silk and/or SPF composition described herein may be applied as a defect filler to Nubuck leather or leather article. In some embodiments, a silk and/or SPF composition described herein may be applied as a defect filler to patent leather or leather article. In some embodiments, a silk and/or SPF composition described herein may be applied as a defect filler to pearlized leather or leather article. In some embodiments, a silk and/or SPF composition described herein may be applied as a defect filler to plated leather or leather article. In some embodiments, a silk and/or SPF composition described herein may be applied as a defect filler to printed leather or leather article. In some embodiments, a silk and/or SPF composition described herein may be applied as a defect filler to protected leather or leather article. In some embodiments, a silk and/or SPF composition described herein may be applied as a defect filler to pure aniline leather or leather article. In some embodiments, a silk and/or SPF composition described herein may be applied as a defect filler to tanned/retanned leather or leather article. In some embodiments, a silk and/or SPF composition described herein may be applied as a defect filler to round hand leather or leather article. In some embodiments, a silk and/or SPF composition described herein may be applied as a defect filler to saddle leather or leather article. In some embodiments, a silk and/or SPF composition described herein may be applied as a defect filler to semi-aniline leather or leather article. In some embodiments, a silk and/or SPF composition described herein may be applied as a defect filler to shrunken grain leather or leather article. In some embodiments, a silk and/or SPF composition described herein may be applied as a defect filler to side leather or leather article.

In some embodiments, a silk and/or SPF composition described herein (with or without one or more chemical agents) may be used to treat leather before or after the liming step. In some embodiments, a silk and/or SPF composition described herein (with or without one or more chemical agents) may be used to treat leather before or after the deliming and/or bateing steps. In some embodiments, a silk and/or SPF composition described herein (with or without one or more chemical agents) may be used to treat leather before or after the pickling step. In some embodiments, a silk and/or SPF composition described herein (with or without one or more chemical agents) may be used to treat leather before or after the tanning step. In some embodiments, a silk and/or SPF composition described herein (with or without one or more chemical agents) may be used to treat leather before or after the neutralizing, dyeing, and/or fat liquoring steps. In some embodiments, a silk and/or SPF composition described herein (with or without one or more chemical agents) may be used to treat leather before or after any drying step. In some embodiments, a silk and/or SPF composition described herein (with or without one or more chemical agents) may be used to treat leather before or after the finishing step. In some embodiments, a silk and/or SPF composition described herein (with or without one or more chemical agents) may be used during the finishing step or as part of the finishing step. In some embodiments, a silk and/or SPF composition described herein (with or without one or more chemical agents) may be used in a stand-alone silk and/or SPF treatment step.

In some embodiments, a silk and/or SPF composition described herein (with or without one or more chemical agents) may be used to treat leather during the liming step. In some embodiments, a silk and/or SPF composition described herein (with or without one or more chemical agents) may be used to treat leather during the deliming and/or bateing steps. In some embodiments, a silk and/or SPF composition described herein (with or without one or more chemical agents) may be used to treat leather during the pickling step. In some embodiments, a silk and/or SPF composition described herein (with or without one or more chemical agents) may be used to treat leather during the tanning step. In some embodiments, a silk and/or SPF composition described herein (with or without one or more chemical agents) may be used to treat leather during the neutralizing, dyeing, and/or fat liquoring steps. In some embodiments, a silk and/or SPF composition described herein (with or without one or more chemical agents) may be used to treat leather during the drying step. In some embodiments, a silk and/or SPF composition described herein (with or without one or more chemical agents) may be used to treat leather during the finishing step. In some embodiments, a silk and/or SPF composition described herein (with or without one or more chemical agents) may be used during the finishing step or as part of the finishing step.

In some embodiments, a silk and/or SPF composition described herein (with or without one or more chemical agents) may be used to treat leather during a process including one or more steps, for example one or more dyeing steps. In some embodiments, the silk and/or SPF composition can be used prior, during, or after a dyeing step. In some embodiments, a silk and/or SPF composition described herein (with or without one or more chemical agents) may be used to treat leather during a process including one or more steps, for example one or more mechanical processing steps. In some embodiments, the silk and/or SPF composition can be used prior, during, or after a mechanical processing step. Mechanical steps include, but are not limited to drying, polishing, stamping, Uniflex and/or Finiflex, stretching, and/or trimming. In some embodiments, a silk and/or SPF composition described herein (with or without one or more chemical agents) may be used to treat leather during a process including one or more steps, for example one or more polishing steps. In some embodiments, the silk and/or SPF composition can be used prior, during, or after a polishing step. In some embodiments, a silk and/or SPF composition described herein (with or without one or more chemical agents) may be used to treat leather during a process including one or more steps, for example one or more chemical treatment steps. In some embodiments, the silk and/or SPF composition can be used prior, during, or after a chemical treatment step. Chemical treatment steps include, but are not limited to one or more pigment treatment steps, one or more acrylic, silicone, and/or polyurethane treatment steps, and/or one or more chemical fixation treatment steps.

In an embodiment, a method is provided for processing leather with silk fibroin and/or SPF that may include silk-based proteins or fragments thereof to provide a silk fibroin processed leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, processing a surface of the leather material with a silk fibroin solution or composition before, during, or after any processing step. In some embodiments, the method may include, processing a surface of the leather material with a silk fibroin solution or composition before, during, or after pigment delivery. In some embodiments, the method may include, processing a surface of the leather material with a silk fibroin solution or composition before, during, or after color locking. In some embodiments, the method may include, processing a surface of the leather material with a silk fibroin solution or composition before, during, or after final coloration adjustment. In some embodiments, the method may include, processing a surface of the leather material with a silk fibroin solution or composition before, during, or after pigment chemistry alteration. In some embodiments, the method may include, processing a surface of the leather material with a silk fibroin solution or composition before, during, or after colorant delivery improvement. In some embodiments, the method may include, processing a surface of the leather material with a silk fibroin solution or composition before, during, or after Uniflex treatment. In some embodiments, the method may include, processing a surface of the leather material with a silk fibroin solution or composition before, during, or after Finiflex treatment. In some embodiments, the method may include, processing a surface of the leather material with a silk fibroin solution or composition before, during, or after heat stamping treatment. In some embodiments, the method may include, processing a surface of the leather material with a silk fibroin solution or composition before, during, or after polishing treatment. In some embodiments, the method may include, processing a surface of the leather material with a silk fibroin solution or composition before, during, or after skin trimming. In some embodiments, the method may include, processing a surface of the leather material with a silk fibroin solution or composition before, during, or after a finishing process. In some embodiments, the method may include, processing a surface of the leather material with a silk fibroin solution or composition before, during, or after tanning. In some embodiments, the method may include, processing a surface of the leather material with a silk fibroin solution or composition before, during, or after dyeing. In some embodiments, the method may include, processing a surface of the leather material with a silk fibroin solution or composition before, during, or after stretching. In some embodiments, the method may include, processing a surface of the leather material with a silk fibroin solution or composition before, during, or after drying. In some embodiments, the method may include, processing a surface of the leather material with a silk fibroin solution or composition before, during, or after trimming. In some embodiments, the method may include, processing a surface of the leather material with a silk fibroin solution or composition before, during, or after polishing.

In an embodiment, a method is provided for coating leather with silk fibroin and/or SPF that may include silk-based proteins or fragments thereof to provide a silk fibroin coated leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, coating a surface of the leather material with the silk fibroin solution before, during, or after any processing step. In some embodiments, the method may include, coating a surface of the leather material with the silk fibroin solution before, during, or after pigment delivery. In some embodiments, the method may include, coating a surface of the leather material with the silk fibroin solution before, during, or after color locking. In some embodiments, the method may include, coating a surface of the leather material with the silk fibroin solution before, during, or after final coloration adjustment. In some embodiments, the method may include, coating a surface of the leather material with the silk fibroin solution before, during, or after pigment chemistry alteration. In some embodiments, the method may include, coating a surface of the leather material with the silk fibroin solution before, during, or after colorant delivery improvement. In some embodiments, the method may include, coating a surface of the leather material with the silk fibroin solution before, during, or after Uniflex treatment. In some embodiments, the method may include, coating a surface of the leather material with the silk fibroin solution before, during, or after Finiflex treatment. In some embodiments, the method may include, coating a surface of the leather material with the silk fibroin solution before, during, or after heat stamping treatment. In some embodiments, the method may include, coating a surface of the leather material with the silk fibroin solution before, during, or after polishing treatment. In some embodiments, the method may include, coating a surface of the leather material with the silk fibroin solution before, during, or after skin trimming. In some embodiments, the method may include, coating a surface of the leather material with the silk fibroin solution before, during, or after a finishing process. In some embodiments, the method may include, coating a surface of the leather material with the silk fibroin solution before, during, or after tanning. In some embodiments, the method may include, coating a surface of the leather material with the silk fibroin solution before, during, or after dyeing. In some embodiments, the method may include, coating a surface of the leather material with the silk fibroin solution before, during, or after stretching. In some embodiments, the method may include, coating a surface of the leather material with the silk fibroin solution before, during, or after drying. In some embodiments, the method may include, coating a surface of the leather material with the silk fibroin solution before, during, or after trimming. In some embodiments, the method may include, coating a surface of the leather material with the silk fibroin solution before, during, or after polishing.

In some embodiments, the method may include, filing and/or repairing a defect on the surface of the leather material with a silk fibroin composition, for example silk fibroin glue, paste, gel, wax, putty, or the like. In an embodiment, a method is provided for repairing leather with silk fibroin and/or SPF that may include silk-based proteins or fragments thereof to provide a silk fibroin repaired leather. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, repairing a surface and/or defect of the leather material with the silk fibroin solution or composition before, during, or after any processing step. In some embodiments, the method may include, repairing a surface and/or defect of the leather material with the silk fibroin solution or composition before, during, or after pigment delivery. In some embodiments, the method may include, repairing a surface and/or defect of the leather material with the silk fibroin solution or composition before, during, or after color locking. In some embodiments, the method may include, repairing a surface and/or defect of the leather material with the silk fibroin solution or composition before, during, or after final coloration adjustment. In some embodiments, the method may include, repairing a surface and/or defect of the leather material with the silk fibroin solution or composition before, during, or after pigment chemistry alteration. In some embodiments, the method may include, repairing a surface and/or defect of the leather material with the silk fibroin solution or composition before, during, or after colorant delivery improvement. In some embodiments, the method may include, repairing a surface and/or defect of the leather material with the silk fibroin solution or composition before, during, or after Uniflex treatment. In some embodiments, the method may include, repairing a surface and/or defect of the leather material with the silk fibroin solution or composition before, during, or after Finiflex treatment. In some embodiments, the method may include, repairing a surface and/or defect of the leather material with the silk fibroin solution or composition before, during, or after heat stamping treatment. In some embodiments, the method may include, repairing a surface and/or defect of the leather material with the silk fibroin solution or composition before, during, or after polishing treatment. In some embodiments, the method may include, repairing a surface and/or defect of the leather material with the silk fibroin solution or composition before, during, or after skin trimming. In some embodiments, the method may include, repairing a surface and/or defect of the leather material with the silk fibroin solution or composition before, during, or after a finishing process. In some embodiments, the method may include, repairing a surface and/or defect of the leather material with the silk fibroin solution or composition before, during, or after tanning. In some embodiments, the method may include, repairing a surface and/or defect of the leather material with the silk fibroin solution or composition before, during, or after dyeing. In some embodiments, the method may include, repairing a surface and/or defect of the leather material with the silk fibroin solution or composition before, during, or after stretching. In some embodiments, the method may include, repairing a surface and/or defect of the leather material with the silk fibroin solution or composition before, during, or after drying. In some embodiments, the method may include, repairing a surface and/or defect of the leather material with the silk fibroin solution or composition before, during, or after trimming. In some embodiments, the method may include, repairing a surface and/or defect of the leather material with the silk fibroin solution or composition before, during, or after polishing.

In an embodiment, a method is provided for coating leather with silk fibroin and/or SPF that may include silk-based proteins or fragments thereof to provide a silk fibroin coated leather, wherein the silk fibroin coated upon the silk fibroin coated leather may be heat resistant to a selected temperature. In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 0.1% by weight (w/w), or less than about 0.01% by weight (w/w), or less than about 0.001% by weight (w/w). In some embodiments, the method may include preparing a silk fibroin solution or other composition that may include a concentration of one or more of low molecular weight silk fibroin, medium molecular weight silk fibroin, and high molecular weight silk fibroin at less than about 1% by weight (w/w), or less than about 2% by weight (w/w), or less than about 3% by weight (w/w), or less than about 4% by weight (w/w), or less than about 5% by weight (w/w), or less than about 6% by weight (w/w), or less than about 7% by weight (w/w), or less than about 8% by weight (w/w), or less than about 9% by weight (w/w), or less than about 10% by weight (w/w), or less than about 11% by weight (w/w), or less than about 12% by weight (w/w), or less than about 13% by weight (w/w), or less than about 14% by weight (w/w), or less than about 15% by weight (w/w), or less than about 16% by weight (w/w), or less than about 17% by weight (w/w), or less than about 18% by weight (w/w), or less than about 19% by weight (w/w), or less than about 20% by weight (w/w), or less than about 21% by weight (w/w), or less than about 22% by weight (w/w), or less than about 23% by weight (w/w), or less than about 24% by weight (w/w), or less than about 25% by weight (w/w), or less than about 26% by weight (w/w), or less than about 27% by weight (w/w), or less than about 28% by weight (w/w), or less than about 29% by weight (w/w), or less than about 30% by weight (w/w), or less than about 31% by weight (w/w), or less than about 32% by weight (w/w), or less than about 33% by weight (w/w), or less than about 34% by weight (w/w), or less than about 35% by weight (w/w), or less than about 36% by weight (w/w), or less than about 37% by weight (w/w), or less than about 38% by weight (w/w), or less than about 39% by weight (w/w), or less than about 40% by weight (w/w), or less than about 41% by weight (w/w), or less than about 42% by weight (w/w), or less than about 43% by weight (w/w), or less than about 44% by weight (w/w), or less than about 45% by weight (w/w), or less than about 46% by weight (w/w), or less than about 47% by weight (w/w), or less than about 48% by weight (w/w), or less than about 49% by weight (w/w), or less than about 50% by weight (w/w). In some embodiments, the method may include, coating a surface of the leather material with the silk fibroin solution. In some embodiments, the method may include drying the surface of the leather material that has been coated with the silk fibroin solution or composition to provide the silk fibroin coated leather material, wherein drying the surface of the leather material comprises heating the surface of the material without substantially decreasing silk fibroin coating performance. In some embodiments, the method may include, filing a defect on the surface of the leather material with a silk fibroin composition, for example silk fibroin glue, paste, gel, wax, putty, or the like.

In an embodiment, the silk fibroin processed leather materials of the invention may be processed with one or more of low molecular weight silk, medium molecular weight silk, and high molecular weight silk to provide resulting coated leather materials having enhanced hydrophobic or hydrophilic properties. In an embodiment, the silk fibroin coated leather materials of the invention may be coated with one or more of low molecular weight silk, medium molecular weight silk, and high molecular weight silk to provide resulting coated leather materials having enhanced hydrophobic or hydrophilic properties. In an embodiment, the silk fibroin repaired leather materials of the invention may have one or more defects repaired, masked, or hidden with one or more of low molecular weight silk, medium molecular weight silk, and high molecular weight silk to provide resulting leather materials having enhanced properties, including an enhanced quality grade.

In an embodiment, the silk fibroin processed leather materials of the invention may be processed with compositions including low molecular weight silk and medium molecular weight silk. In an embodiment, the silk fibroin coated leather materials of the invention may be coated with compositions including low molecular weight silk and medium molecular weight silk. In an embodiment, the silk fibroin defect-repaired leather materials of the invention may be repaired with compositions including low molecular weight silk and medium molecular weight silk. In some embodiments, the w/w ratio between low molecular weight silk and medium molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk and medium molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk and medium molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the invention may be processed with compositions including low molecular weight silk and high molecular weight silk. In an embodiment, the silk fibroin coated leather materials of the invention may be coated with compositions including low molecular weight silk and high molecular weight silk. In an embodiment, the silk fibroin defect-repaired leather materials of the invention may be repaired with compositions including low molecular weight silk and high molecular weight silk. In some embodiments, the w/w ratio between low molecular weight silk and high molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk and high molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk and high molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the invention may be processed with compositions including medium molecular weight silk and high molecular weight silk. In an embodiment, the silk fibroin coated leather materials of the invention may be coated with compositions including medium molecular weight silk and high molecular weight silk. In an embodiment, the silk fibroin defect-repaired leather materials of the invention may be repaired with compositions including medium molecular weight silk and high molecular weight silk. In some embodiments, the w/w ratio between medium molecular weight silk and high molecular weight silk is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between medium molecular weight silk and high molecular weight silk is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between medium molecular weight silk and high molecular weight silk is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, the silk fibroin processed leather materials of the invention may be processed with compositions including low molecular weight silk, medium molecular weight silk, and high molecular weight silk. In an embodiment, the silk fibroin coated leather materials of the invention may be coated with compositions including low molecular weight silk, medium molecular weight silk, and high molecular weight silk. In an embodiment, the silk fibroin defect-repaired leather materials of the invention may be repaired with compositions including low molecular weight silk, medium molecular weight silk, and high molecular weight silk. In an embodiment, the w/w ratio between low molecular weight silk, medium molecular weight silk, and high molecular weight silk is about 1:1:8, 1:2:7, 1:3:6, 1:4:5, 1:5:4, 1:6:3, 1:7:2, 1:8:1, 2:1:7, 2:2:6, 2:3:5, 2:4:4, 2:5:3, 2:6:2, 2:7:1, 3:1:6, 3:2:5, 3:3:4, 3:4:3, 3:5:2, 3:6:1, 4:1:5, 4:2:4, 4:3:3, 4:4:2, 4:5:1, 5:1:4, 5:2:3, 5:3:2, 5:4:1, 6:1:3, 6:2:2, 6:3:1, 7:1:2, 7:2:1, or 8:1:1.

In an embodiment, the invention provides a silk and/or SPF processed leather article, wherein the processing comprises silk based proteins or fragments thereof having a weight average molecular weight range of about 5 kDa to about 144 kDa. In an embodiment, the invention provides a silk and/or SPF coated leather article, wherein the coating comprises silk based proteins or fragments thereof having a weight average molecular weight range of about 5 kDa to about 144 kDa. In an embodiment, the invention provides a silk and/or SPF defect-repaired leather article, wherein the defect filling comprises silk based proteins or fragments thereof having a weight average molecular weight range of about 5 kDa to about 144 kDa.

In an embodiment, the invention provides a silk and/or SPF processed leather article, wherein the processing comprises silk based proteins or fragments thereof having average weight average molecular weights of about 5 kDa to about 144 kDa. In an embodiment, the invention provides a silk and/or SPF coated leather article, wherein the coating comprises silk based proteins or fragments thereof having average weight average molecular weights of about 5 kDa to about 144 kDa. In an embodiment, the invention provides a silk and/or SPF defect-repaired leather article, wherein the defect filling comprises silk based proteins or fragments thereof having average weight average molecular weights of about 5 kDa to about 144 kDa.

In an embodiment, the invention provides a leather article processed with silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues. In an embodiment, the invention provides a leather article having a coating wherein the coating comprises silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues. In an embodiment, the invention provides a leather article including a one or more leather defect-filling portions, wherein the composition comprises silk based proteins or fragments thereof having an average number of amino acid residues of about 1 to 400 residues, or 1 to 300 residues, or 1 to 200 residues, or 1 to 100 residues, or 1 to 50 residues, or 5 to 25 residues, or 10 to 20 residues.

In an embodiment, the invention provides a leather article processed with silk based proteins or fragments thereof having a weight average molecular weight range of about 5 kDa to about 144 kDa. In an embodiment, the invention provides a leather article having a coating wherein the coating comprises silk based proteins or fragments thereof having a weight average molecular weight range of about 5 kDa to about 144 kDa. In an embodiment, the invention provides a leather article including a leather defect-filling composition, wherein the composition comprises silk based proteins or fragments thereof having a weight average molecular weight range of about 5 kDa to about 144 kDa.

In an embodiment, the invention provides a leather article processed with silk based proteins or fragments thereof having average weight average molecular weights of about 5 kDa to about 144 kDa. In an embodiment, the invention provides a leather article having a coating wherein the coating comprises silk based proteins or fragments thereof having average weight average molecular weights of about 5 kDa to about 144 kDa. In an embodiment, the invention provides a leather article including a leather defect-filling composition, wherein the composition comprises silk based proteins or fragments thereof having average weight average molecular weights of about 5 kDa to about 144 kDa.

In an embodiment, the invention provides a leather article processed with silk proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin. In an embodiment, the invention provides a leather article having a coating wherein the coating comprises silk based proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin. In an embodiment, the invention provides a leather article including a leather defect-filling composition, coating wherein the composition comprises silk based proteins or fragments thereof having a weight average molecular weight range of about 5 kDa to about 144 kDa, wherein the silk based proteins or fragments thereof comprise silk fibroin-based proteins or protein fragments having about 0.01% (w/w) to about 10% (w/w) sericin.

In an embodiment, the invention provides a leather article processed with silk proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin. In an embodiment, the invention provides a leather article having a coating wherein the coating comprises silk based proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin. In an embodiment, the invention provides a leather article including a leather defect-filling composition, coating wherein the composition comprises silk based proteins or fragments thereof having average weight average molecular weights of about 5 kDa to about 144 kDa, wherein the silk based proteins or fragments thereof comprise silk fibroin-based proteins or protein fragments having about 0.01% (w/w) to about 10% (w/w) sericin.

In an embodiment, the invention provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the invention provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the invention provides a leather article including a leather defect-filling compositions, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof.

In an embodiment, the invention provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the invention provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof. In an embodiment, the invention provides a leather article including a leather defect-filling compositions, wherein the composition comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof.

In an embodiment, the invention provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the invention provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the invention provides a leather article including a leather defect-filling composition, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof.

In an embodiment, the invention provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the invention provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof. In an embodiment, the invention provides a leather article including a leather defect-filling composition, wherein the composition comprises silk based proteins or fragments thereof having average weight average molecular weight of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof.

In an embodiment, the invention provides a leather article processed with silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the invention provides a leather article having a coating wherein the coating comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the invention provides a leather article having a leather defect-filling composition, wherein the composition comprises silk based proteins or fragments thereof having a weight average molecular weight range of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof.

In an embodiment, the invention provides a leather article processed with silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the invention provides a leather article having a coating wherein the coating comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof. In an embodiment, the invention provides a leather article having a leather defect-filling composition, wherein the composition comprises silk based proteins or fragments thereof having average weight average molecular weights of about 5 kDa to about 144 kDa, wherein the silk based proteins or fragments thereof are selected from the group consisting of natural silk based proteins or fragments thereof, recombinant silk based proteins or fragments thereof, and combinations thereof, wherein the silk based proteins or fragments thereof are natural silk based proteins or fragments thereof that are selected from the group consisting of spider silk based proteins or fragments thereof, silkworm silk based proteins or fragments thereof, and combinations thereof, wherein the natural silk based proteins or fragments are silkworm silk based proteins or fragments thereof, and the silkworm silk based proteins or fragments thereof is Bombyx mori silk based proteins or fragments thereof.

In an embodiment, the invention provides a leather article processed with a composition comprising silk based proteins or fragments thereof and a polymer and/or a copolymer, the silk based proteins or fragments thereof having a weight average molecular weight range of about 5 kDa to about 144 kDa. In an embodiment, the invention provides a leather article having a coating comprising silk based proteins or fragments thereof and a polymer and/or a copolymer, the silk based proteins or fragments thereof having a weight average molecular weight range of about 5 kDa to about 144 kDa. In an embodiment, the invention provides a leather article including a defect-filling composition comprising silk based proteins or fragments thereof and a polymer and/or a copolymer, the silk based proteins or fragments thereof having a weight average molecular weight range of about 5 kDa to about 144 kDa.

In an embodiment, the invention provides a leather article processed with a composition comprising silk based proteins or fragments thereof and a pigment and/or a colorant, the silk based proteins or fragments thereof having a weight average molecular weight range of about 5 kDa to about 144 kDa. In an embodiment, the invention provides a leather article having a coating comprising silk based proteins or fragments thereof and a pigment and/or a colorant, the silk based proteins or fragments thereof having a weight average molecular weight range of about 5 kDa to about 144 kDa. In an embodiment, the invention provides a leather article including a defect-filling composition comprising silk based proteins or fragments thereof and a pigment and/or a colorant, the silk based proteins or fragments thereof having a weight average molecular weight range of about 5 kDa to about 144 kDa. In an embodiment, the invention provides a leather article processed with a composition comprising silk based proteins or fragments thereof and a polymer and/or a copolymer, the silk based proteins or fragments thereof having a weight average molecular weight range of about 5 kDa to about 144 kDa. In an embodiment, the invention provides a leather article having a coating comprising silk based proteins or fragments thereof and a polymer and/or a copolymer, the silk based proteins or fragments thereof having a weight average molecular weight range of about 5 kDa to about 144 kDa. In an embodiment, the invention provides a leather article including a defect-filling composition comprising silk based proteins or fragments thereof and a polymer and/or a copolymer, the silk based proteins or fragments thereof having a weight average molecular weight range of about 5 kDa to about 144 kDa.

In an embodiment, the invention provides a leather article processed with a composition comprising silk based proteins or fragments thereof and a pigment and/or a colorant, the silk based proteins or fragments thereof having average weight average molecular weights of about 5 kDa to about 144 kDa. In an embodiment, the invention provides a leather article having a coating comprising silk based proteins or fragments thereof and a pigment and/or a colorant, the silk based proteins or fragments thereof having average weight average molecular weights of about 5 kDa to about 144 kDa. In an embodiment, the invention provides a leather article including a defect-filling composition comprising silk based proteins or fragments thereof and a pigment and/or a colorant, the silk based proteins or fragments thereof having average weight average molecular weights of about 5 kDa to about 144 kDa.

In an embodiment, the invention provides a leather article processed with silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to processing the leather article, do not spontaneously or gradually gelate and do not visibly change in color or turbidity when in a solution for at least 10 days. In an embodiment, the invention provides a leather article having a coating wherein the coating comprises silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to coating the leather article, do not spontaneously or gradually gelate and do not visibly change in color or turbidity when in a solution for at least 10 days. In an embodiment, the invention provides a leather article including a leather defect-filling composition, wherein the composition comprises silk based proteins or fragments thereof having a weight average molecular weight range of about 5 kDa to about 144 kDa, wherein the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and wherein the proteins or protein fragments, prior to repairing the leather article, do not spontaneously or gradually gelate and do not visibly change in color or turbidity when in a solution for at least 10 days.

In an embodiment, the invention provides a leather article processed with silk based proteins or fragments thereof having a weight average molecular weight range of about 5 kDa to about 144 kDa. In an embodiment, the invention provides a leather article having a coating wherein the coating comprises silk based proteins or fragments thereof having a weight average molecular weight range of about 5 kDa to about 144 kDa. In an embodiment, the invention provides a leather article including a leather defect-filling composition, wherein the composition comprises silk based proteins or fragments thereof having a weight average molecular weight range of about 5 kDa to about 144 kDa.

In an embodiment, the invention provides a leather article processed with silk based proteins or fragments thereof having average weight average molecular weights of about 5 kDa to about 144 kDa. In an embodiment, the invention provides a leather article having a coating wherein the coating comprises silk based proteins or fragments thereof having average weight average molecular weights of about 5 kDa to about 144 kDa. In an embodiment, the invention provides a leather article including a leather defect-filling composition, wherein the composition comprises silk based proteins or fragments thereof having average weight average molecular weights of about 5 kDa to about 144 kDa.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates general steps used in leather processing.

FIGS. 2A and 2B illustrate a process for repairing leather as described herein; FIG. 2A: leather defect prior to repairing; and FIG. 2B: repaired defect filled with a composition as described herein.

FIGS. 3A to 3C illustrate a process for repairing leather as described herein; FIG. 3A: leather defect prior to repairing; FIG. 3B: repaired defect filled with a composition as described herein; and FIG. 3C: repaired defect filled with a composition as described herein and then coated with Unithane 2132 NF.

FIGS. 4A to 4C illustrate a process for repairing leather as described herein; FIG. 4A: leather defect prior to repairing; FIG. 4B: repaired defect filled with a composition as described herein; and FIG. 4C: repaired defect filled with a composition as described herein and then coated with Unithane 351 NF.

FIGS. 5A to 5C illustrate a process for repairing leather as described herein; FIG. 5A: leather defect prior to repairing; FIG. 5B: repaired defect filled with a composition as described herein; and FIG. 5C: repaired defect filled with a composition as described herein and then coated with Silky Top 7425 NF.

FIGS. 6A to 6C illustrate a process for repairing leather as described herein; FIG. 6A: leather defect prior to repairing; FIG. 6B: repaired defect filled with a composition as described herein; and FIG. 6C: repaired defect filled with a composition as described herein and then coated with Uniseal 9049.

FIGS. 7A to 7C illustrate a process for repairing leather as described herein; FIG. 7A: leather defect prior to repairing; FIG. 7B: repaired defect filled with a composition as described herein; and FIG. 7C: repaired defect filled with a composition as described herein and then coated with a 6% low MW silk coating.

FIGS. 8A and 8B show an eyeliner brush-applicator for a defect filling process (FIG. 8A), and a brush pen/marker filled with silk as applicator for a defect filling process (FIG. 8B).

FIGS. 9A and 9B show a sample of undyed lambskin leather (left side—uncoated, right side—coated with 6% low MW silk, 4 seconds autospray; FIG. 9A), and a sample of dyed lambskin leather (left side—uncoated, right side—coated with 6% low MW silk, 4 seconds autospray; FIG. 9B).

FIGS. 10A and 10B show a sample of bovine leather coated with 6% low MW silk, 4 seconds autospray (FIG. 10A), and a sample of undyed lambskin leather coated with 6% low MW silk mixed with 1% Clariant Hostaperm Violet RL Spec Pigment.

FIGS. 11A and 11B show a sample of undyed lambskin leather defect filled with 21% med MW silk with brush pen, before (FIG. 11A), and after (FIG. 11B).

FIGS. 12A and 12B show a sample of undyed lambskin leather defect filled with 21% M silk with 1% Clariant Hostaperm Violet RL Spec Pigment applied with an eyeliner brush applicator, before (FIG. 12A), and after (FIG. 12B).

FIGS. 13A to 13C show application of a defect filler composition using an eyeliner-type applicator, resulting in enhanced control of the topography of silk deposition to more accurately match natural patters on leather surface; FIG. 13A: unfilled defect; FIG. 13B: one round of application using an eyeliner brush; and FIG. 13C: second round of application using an eyeliner brush (24% low MW silk).

FIGS. 14A and 14B show application of a defect filler composition using a brush pen applicator; FIG. 14A: unfilled defect; and FIG. 14B: filled defect.

FIGS. 15A and 15B show application of a defect filler composition using a pipette applicator; FIG. 15A: unfilled defect; and FIG. 15B: defect filled with 10 μL high concentration (˜21% w/v) silk composition.

FIGS. 16A and 16B show application of a defect filler composition using a pipette applicator; FIG. 16A: unfilled defect; and FIG. 16B: defect filled with 5 μL high concentration (˜21% w/v) silk composition.

FIGS. 17A and 17B show application of a defect filler composition using a pipette applicator; FIG. 17A: unfilled defect; and FIG. 17B: defect filled with 1 μL high concentration (˜21% w/v) silk composition.

FIGS. 18A and 18B show application of a defect filler composition using a pipette applicator; FIG. 18A: unfilled defect; and FIG. 18B: defect filled with 0.1 μL high concentration (˜21% w/v) silk composition.

FIGS. 19A and 19B illustrate before and after images of a leather sample coated with a GG-silk formulation variant; leather sample before (FIG. 19A) and after (FIG. 19B) coating with Silk+0.5% wt. GG pH 9.75; coating applied using wire bar coater 20 μm (TQC Industries); defect is in the center of the field of view of all images, magnification is approximately 3×.

FIGS. 20A and 20B illustrate before and after images of a leather sample coated with a GLY-silk formulation variant; leather sample before (FIG. 20A) and after (FIG. 20B) coating with Silk+10% vol. GLY pH 8; coating applied using wire bar coater 20 μm (TQC Industries); defect is in the center of the field of view of all images, magnification is approximately 3×.

FIGS. 21A and 21B illustrate before and after images (2D) of a leather sample coated with GG-silk before (FIG. 21A) and after (FIG. 21B) coating with Silk+0.5% wt. GG via point filling. Defect is in the center of the field of view of both images. Images were captured using a Taylor Hobson CCI HD optical profilometer.

FIGS. 22A and 22B illustrate before and after images (3D) of a leather sample coated with GG-silk before (FIG. 22A) and after (FIG. 22B) coating with Silk+0.5% wt. GG via point filling. Defect is in the center of the field of view of both images. Images were captured using a Taylor Hobson CCI HD optical profilometer.

FIGS. 23A and 23B illustrate before and after topography traces of a leather sample coated with GG-silk before (FIG. 23A) and after (FIG. 23B) coating with Silk+0.5% wt. GG via point filling. Traces were captured using a Taylor Hobson CCI HD optical profilometer.

FIG. 24 is a chart illustrating viscosity as a function of shear rate for two independent batches of silk-based coating formulations for leather (6% MID MW silk fibroin+0.5% w/v GG). Batch A (Triangle) and Batch B (Circle) refer to two separate manufacturing batches of purified silk fibroin solution—the curve illustrates the reproducibility of the silk formulations after the addition of Gellan gum in terms of their rheological properties.

FIG. 25 is a chart illustrating the fill score as a function of Gellan gum (GG) content. Higher GG concentration (higher viscosity) silk formulations demonstrated improved defect filling compared to lower GG concentration formulations. N=3 replicate coating samples per treatment group.

FIG. 26 is a chart illustrating viscosity as a function of shear rate for 6% Mid MW silk fibroin solutions containing different concentrations of GG.

FIGS. 27A to 27C are microscope images of lambskin leather sample coated with an SF-GG formulation variant. Leather sample before (FIG. 27A), after (FIG. 27B) coating with 6% MID MW Silk+0.5% w/v GG pH 9.75, and after finishing (FIG. 27C). The coating was applied using a wire bar coater (20 μm—TQC Industries). The defect site is in the center of the field of view all images, magnification is approximately 3×, scale bar approximately 1.0 mm.

FIG. 28 illustrates an example defect filling performance for one SF-GG formulation variant (6% MID MW silk fibroin+0.5% w/v GG) applied to lambskin leather containing 10 defect sites. The coating was applied over n=3 layers using a wire bar coater (10 μm TQC Industries). Data points shown are the average of N=20 sample coatings.

FIGS. 29A to 29D illustrate a Scoring System for Defect Fillings; FIG. 29A: score=0, uncoated defect site—coating has either not been applied or completely misses the defect area (score assigned after assessment of microscopy image); FIG. 29B: score=1, minor reduction of defect size around edges of cavity—no filling or aggregation of coating in defect cavity (score assigned after assessment of microscopy image); FIG. 29C: score=2, partial filling of defect cavity—noticeable build-up or partial build-up of coating material (score assigned after assessment of microscopy image); and FIG. 29D: score=3, defect appears filled, edges of coating formulation appear flush with grain surface around defect site (score assigned after assessment of microscopy image).

FIG. 30 illustrates an example Fill Score chart—Fill score as a function of applied wet coating thickness for various concentrations of silk fibroin-based formulations (3 applications at 10 μm using a wire bar coater—TQC Industries). Different silk concentrations for low MW (10-12.5% w/v) and mid MW (6% w/v) affect efficiency of filling as additional coating layers are applied. Higher silk concentrations and higher-GG content (12.5% w/v low mw+0.5% GG) formulations tend to demonstrate better filling characteristics than lower silk- and lower GG-content formulations.

FIGS. 31A and 31B are images of leather samples STI-18080701-T029 (not water annealed; FIG. 31A) and STI-18080701-T030 (water annealed; FIG. 31B). After the water drop has been wiped away, no water drop remains on STI-18080701-T030 (FIG. 31B).

FIGS. 32A to 32D are photographs leather samples T001-T004 (no spray coating); FIG. 32A: RSD-TXTL-287-T001, black bovine; FIG. 32B: RSD-TXTL-287-T002, brown lamb skin; FIG. 32C: RSD-TXTL-287-T003, magenta lamb skin; FIG. 32D: RSD-TXTL-287-T004, orange lamb skin.

FIGS. 33A to 33D are photographs of leather samples T005-T008 (6% Mid spray coating); FIG. 33A: RSD-TXTL-287-T005, black bovine, 6% Mid; FIG. 33B: RSD-TXTL-287-T006, brown lamb skin, 6% Mid; FIG. 33C: RSD-TXTL-287-T007, magenta lamb skin, 6% Mid; FIG. 33D: RSD-TXTL-287-T008, orange lamb skin, 6% Mid.

FIG. 34A to 34D are photographs of leather samples T009-T012 (6% Low spray coating); FIG. 34A: RSD-TXTL-287-T009, black bovine, 6% Low; FIG. 34B: RSD-TXTL-287-T010, brown lamb skin, 6% Low; FIG. 34C: RSD-TXTL-287-T011, magenta lamb skin, 6% Low; FIG. 34D: RSD-TXTL-287-T012, orange lamb skin 6% Low.

FIGS. 35A to 35E illustrate photographs of stenciled leather samples T013-T016 (6% Low with stencil coating), along with the stencil used to make the coatings;

FIG. 35A: sample RSD-TXTL-287-T013, black bovine, 6% Low with stencil; FIG. 35B: sample RSD-TXTL-287-T014, brown lambskin, 6% Low with stencil; FIG. 35C: sample RSD-TXTL-287-T015, magenta lambskin, 6% Low with stencil; FIG. 35D: sample RSD-TXTL-287-T016, orange lambskin, 6% Low with stencil; FIG. 35E: exemplary stencil.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION OF THE INVENTION

### Silk Fibroin-Based Protein Fragments and Solutions Thereof

Provided herein are methods for producing pure and highly scalable silk protein fragment (SPF) mixture solutions that may be used to process and/or coat at least a portion of leather and/or leather articles, or to repair at least one defect in a portion of leather and/or leather article. In some embodiments, SPF mixture solutions may also refer to silk fibroin solutions (SFS), and vice versa. The solutions are generated from raw pure intact silk protein material and processed in order to remove any sericin and achieve the desired average weight average molecular weight (MW) and polydispersity of the fragment mixture. Select method parameters may be altered to achieve distinct final silk protein fragment characteristics depending upon the intended use. The resulting final fragment solution is pure silk protein fragments and water with PPM to non-detectable levels of process contaminants. The concentration, size and polydispersity of silk protein fragments in the solution may further be altered depending upon the desired use and performance requirements. In an embodiment, the pure silk fibroin-based protein fragments in the solution are substantially devoid of sericin, have an average weight average molecular weight ranging from about 6 kDa to about 17 kDa, and have a polydispersity ranging from about 1.5 and about 3.0. In an embodiment, the pure silk fibroin-based protein fragments in the solution are substantially devoid of sericin, have an average weight average molecular weight ranging from about 17 kDa to about 39 kDa, and have a polydispersity ranging from about 1.5 and about 3.0. In an embodiment, the pure silk fibroin-based protein fragments in the solution are substantially devoid of sericin, have an average weight average molecular weight ranging from about 39 kDa to about 80 kDa, and have a polydispersity ranging from about 1.5 and about 3.0. As used herein, the term “silk solution” may refer to solutions of silk proteins, including solutions of silk fibroin-based protein fragments.

Without wishing to be bound by any particular theory, any and all solutions described herein can be further used or processed to obtain a variety of silk and/or SPF compositions, including, but not limited to, silk non-Newtonian fluids, silk materials that can sustain a shear stress network spanning the system, silk solutions containing water or another solvent trapped inside a loose silk polymer network, silk materials that transition from a liquid form via bond percolation transition such as gels, silk immobile network entrapping a mobile solvent, silk materials forming reversible or irreversible crosslinks, silk materials that exhibit a shear modulus, silk elastomers or silk materials exhibiting thermoplastic behavior, silk materials formed by the processes of either glass formation, gelation, or colloidal aggregation, silk crystals, and/or silk crystals polish, glues, gels, pastes, putties, and/or waxes.

As used herein when referring to a number or a numerical range, the term “about” means that the stated number or numerical range is included together with numbers or numerical ranges within experimental variability, or within statistical experimental error from the stated number or numerical range, wherein the variation or error is from 0% to 15%, or from 0% to 10%, or from 0% to 5% of the stated number or numerical range.

As used herein, “silk based proteins or fragments thereof” includes silk fibroin-based proteins or fragments thereof, natural silk based proteins or fragments thereof, recombinant silk based proteins or fragments thereof, and combinations thereof. Natural silk based proteins or fragments thereof include spider silk based proteins or fragments thereof, silkworm silk based proteins or fragments thereof, and combinations thereof. Silkworm based proteins or fragments thereof may include Bombyx mori silk based proteins or fragments thereof. The SPF mixture solutions described herein may include silk based proteins or fragments thereof. Moreover, SFS, as described herein, may be replaced with SPF mixture solutions. The silk based proteins or fragments thereof, silk solutions or mixtures (e.g., SPF or SFS solutions or mixture), and the like, may be prepared according to the methods described in U.S. Pat. Nos. 9,187,538, 9,522,107, 9,522,108, 9,511,012, 9,517,191, and 9,545,369, and U.S. Patent Publication Nos. 2016/0222579 and 2016/0281294, and International Patent Publication Nos. WO 2016/090055 and WO 2017/011679, the entirety of which are incorporated herein by reference. In some embodiments, the silk based proteins or fragments thereof may be provided as a silk composition, which may be an aqueous solution or mixture of silk, a silk gel, and/or a silk wax as described herein.

As used herein, “low molecular weight” silk fibroin solutions may include those SFS solutions that include silk fibroin-based protein fragments having a molecular weight in a range of about 5 kDa to 20 kDa. In some embodiments, a target low molecular weight for certain silk fibroin-based protein fragments may be about 11 kDa.

As used herein, “medium molecular weight” silk fibroin solutions may include those SFS solutions that include silk-fibroin based protein fragments having a molecular weight in a range of about 20 kDa to about 55 kDa. In some embodiments, a target medium molecular weight for certain silk fibroin-based protein fragments may be about 40 kDa.

As used herein, “high molecular weight” silk fibroin solutions may include those SFS solutions that include silk-fibroin based protein fragments having a molecular weight that is in a range of about 55 kDa to about 150 kDa. In some embodiments, a target high molecular weight for certain silk fibroin-based protein fragments may be about 100 kDa to about 145 kDa.

In some embodiments, the molecular weights described herein (e.g., low molecular weight silk, medium molecular weight silk, high molecular weight silk) may be converted to the approximate number of amino acids contained within the respective natural or recombinant proteins, such as natural or recombinant silk proteins, as would be understood by a person having ordinary skill in the art. For example, the average weight of an amino acid may be about 110 daltons (i.e., 110 g/mol). Therefore, in some embodiments, dividing the molecular weight of a linear protein by 110 daltons may be used to approximate the number of amino acid residues contained therein.

As used herein, the terms “substantially sericin free” or “substantially devoid of sericin” refer to silk fibers in which a majority of the sericin protein has been removed. In an embodiment, silk fibroin that is substantially devoid of sericin refers to silk fibroin having between about 0.01% (w/w) and about 10.0% (w/w) sericin. In an embodiment, silk fibroin that is substantially devoid of sericin refers to silk fibroin having between about 0.01% (w/w) and about 9.0% (w/w) sericin. In an embodiment, silk fibroin that is substantially devoid of sericin refers to silk fibroin having between about 0.01% (w/w) and about 8.0% (w/w) sericin. In an embodiment, silk fibroin that is substantially devoid of sericin refers to silk fibroin having between about 0.01% (w/w) and about 7.0% (w/w) sericin. In an embodiment, silk fibroin that is substantially devoid of sericin refers to silk fibroin having between about 0.01% (w/w) and about 6.0% (w/w) sericin. In an embodiment, silk fibroin that is substantially devoid of sericin refers to silk fibroin having between about 0.01% (w/w) and about 5.0% (w/w) sericin. In an embodiment, silk fibroin that is substantially devoid of sericin refers to silk fibroin having between about 0% (w/w) and about 4.0% (w/w) sericin. In an embodiment, silk fibroin that is substantially devoid of sericin refers to silk fibroin having between about 0.05% (w/w) and about 4.0% (w/w) sericin. In an embodiment, silk fibroin that is substantially devoid of sericin refers to silk fibroin having between about 0.1% (w/w) and about 4.0% (w/w) sericin. In an embodiment, silk fibroin that is substantially devoid of sericin refers to silk fibroin having between about 0.5% (w/w) and about 4.0% (w/w) sericin. In an embodiment, silk fibroin that is substantially devoid of sericin refers to silk fibroin having between about 1.0% (w/w) and about 4.0% (w/w) sericin. In an embodiment, silk fibroin that is substantially devoid of sericin refers to silk fibroin having between about 1.5% (w/w) and about 4.0% (w/w) sericin. In an embodiment, silk fibroin that is substantially devoid of sericin refers to silk fibroin having between about 2.0% (w/w) and about 4.0% (w/w) sericin. In an embodiment, silk fibroin that is substantially devoid of sericin refers to silk fibroin having between about 2.5% (w/w) and about 4.0% (w/w) sericin. In an embodiment, silk fibroin that is substantially devoid of sericin refers to silk fibroin having a sericin content between about 0.01% (w/w) and about 0.1% (w/w). In an embodiment, silk fibroin that is substantially devoid of sericin refers to silk fibroin having a sericin content below about 0.1% (w/w). In an embodiment, silk fibroin that is substantially devoid of sericin refers to silk fibroin having a sericin content below about 0.05% (w/w). In an embodiment, when a silk source is added to a boiling (100° C.) aqueous solution of sodium carbonate for a treatment time of between about 30 minutes to about 60 minutes, a degumming loss of about 26 wt. % to about 31 wt. % is obtained.

As used herein, the term “substantially homogeneous” may refer to pure silk fibroin-based protein fragments that are distributed in a normal distribution about an identified molecular weight. As used herein, the term “substantially homogeneous” may refer to an even distribution of an additive, for example a pigment, throughout a composition of the present disclosure.

As used herein, “residuals” refer to materials related to one or more process steps in the manufacturing of silk fibroin solutions, silk fibroin fragments solutions, or concentrates thereof.

As used herein, the term “substantially free of inorganic residuals” means that the composition exhibits residuals of 0.1% (w/w) or less. In an embodiment, substantially free of inorganic residuals refers to a composition that exhibits residuals of 0.05% (w/w) or less. In an embodiment, substantially free of inorganic residuals refers to a composition that exhibits residuals of 0.01% (w/w) or less. In an embodiment, the amount of inorganic residuals is between 0 ppm (“non-detectable” or “ND”) and 1000 ppm. In an embodiment, the amount of inorganic residuals is ND to about 500 ppm. In an embodiment, the amount of inorganic residuals is ND to about 400 ppm. In an embodiment, the amount of inorganic residuals is ND to about 300 ppm. In an embodiment, the amount of inorganic residuals is ND to about 200 ppm. In an embodiment, the amount of inorganic residuals is ND to about 100 ppm. In an embodiment, the amount of inorganic residuals is between 10 ppm and 1000 ppm.

As used herein, the term “substantially free of organic residuals” means that the composition exhibits residuals of 0.1% (w/w) or less. In an embodiment, substantially free of organic residuals refers to a composition that exhibits residuals of 0.05% (w/w) or less. In an embodiment, substantially free of organic residuals refers to a composition that exhibits residuals of 0.01% (w/w) or less. In an embodiment, the amount of organic residuals is between 0 ppm (“non-detectable” or “ND”) and 1000 ppm. In an embodiment, the amount of organic residuals is ND to about 500 ppm. In an embodiment, the amount of organic residuals is ND to about 400 ppm. In an embodiment, the amount of organic residuals is ND to about 300 ppm. In an embodiment, the amount of organic residuals is ND to about 200 ppm. In an embodiment, the amount of organic residuals is ND to about 100 ppm. In an embodiment, the amount of organic residuals is between 10 ppm and 1000 ppm.

In some embodiments, compositions of the present disclosure are “biocompatible” or otherwise exhibit “biocompatibility” meaning that the compositions are compatible with living tissue or a living system by not being toxic, injurious, or physiologically reactive and not causing immunological rejection or an inflammatory response. Such biocompatibility can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely. For example, in some embodiments, the coatings described herein are biocompatible coatings.

In some embodiments, compositions described herein, which in some embodiments may be biocompatible compositions (e.g., biocompatible coatings that include silk), may be evaluated and comply with International Standard ISO 10993-1, titled the “Biological evaluation of medical devices—Part 1: Evaluation and testing within a risk management process.” In some embodiments, compositions described herein, which may be biocompatible compositions, may be evaluated under ISO 106993-1 for one or more of cytotoxicity, sensitization, hemocompatibility, pyrogenicity, implantation, genotoxicity, carcinogenicity, reproductive and developmental toxicity, and degradation.

In some embodiments, compositions and articles described herein, and methods of preparing the same, include silk coated leather or leather article. The leather or leather article may be a polymeric material such as those described elsewhere herein. The terms “infused” and/or “partially dissolved” includes mixing to form a dispersion of, e.g., a portion of leather or leather article with a portion of the silk based coating. In some embodiments, the dispersion may be a solid suspension (i.e., a dispersion comprising domains on the order of 10 nm) or a solid solution (i.e., a molecular dispersion) of silk. In some embodiments, the dispersion may be localized at the surface interface between the silk coating and the leather or leather article, and may have a depth of 1 nm, 2 nm, 5 nm, 10 nm, 25 nm, 50 nm, 75 nm, 100 nm, or greater than 100 nm, depending on the method of preparation. In some embodiments, the dispersion may be a layer sandwiched between the leather or leather article and the silk coating. In some embodiments, the dispersion may be prepared by coating silk, including silk fibroin with the characteristics described herein, onto the leather or leather article, and then performing an additional process to form the dispersion, including heating at a temperature of 100° C., 125° C., 150° C., 175° C., 200° C., 225° C., or 250° C. for a time period selected from the group consisting of 1 minute, 2 minutes, 5 minutes, 10 minutes, 15 minutes, 20 minutes, 30 minutes, 1 hour, 2 hours, 4 hours, 8 hours, 16 hours, or 24 hours. In some embodiments, heating may be performed at or above the glass transition temperature (T_{g}) of silk and/or the polymeric fabric or textile, which may be assessed by methods known in the art. In some embodiments, the dispersion may be formed by coating silk, including silk fibroin with the characteristics described herein, onto the leather or leather article, and then performing an additional process to impregnate the silk coating into the leather or leather article, including treatment with an organic solvent. Methods for characterizing the properties of polymers dissolved in one another are well known in the art and include differential scanning calorimetry and surface analysis methods capable of depth profiling, including spectroscopic methods.

In some embodiments, compositions of the present disclosure are “hypoallergenic” meaning that they are relatively unlikely to cause an allergic reaction. Such hypoallergenicity can be evidenced by participants topically applying compositions of the present disclosure on their skin for an extended period of time. In an embodiment, the extended period of time is about 3 days. In an embodiment, the extended period of time is about 7 days. In an embodiment, the extended period of time is about 14 days. In an embodiment, the extended period of time is about 21 days. In an embodiment, the extended period of time is about 30 days. In an embodiment, the extended period of time is selected from the group consisting of about 1 month, about 2 months, about 3 months, about 4 months, about 5 months, about 6 months, about 7 months, about 8 months, about 9 months, about 10 months, about 11 months, about 12 months, and indefinitely.

In some embodiments, where aqueous solutions are used to prepare SPF compositions or SPF containing coatings, the aqueous solutions are prepared using any type of water. In some embodiments, water may be DI water, tap water, or naturally available water. As used herein, “tap water” refers to potable water provided by public utilities and water of comparable quality, regardless of the source, without further refinement such as by reverse osmosis, distillation, and/or deionization. Therefore, the use of “DI water,” “RODI water,” or “water,” as set forth herein, may be understood to be interchangeable with “tap water” according to the processes described herein without deleterious effects to such processes.

Leather and Leather Articles Processed, Coated, and/or Repaired with Silk Fibroin-Based Protein Fragments

The disclosure provides an article including a leather substrate and silk fibroin proteins or fragments thereof having an average weight average molecular weight in a range selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5. In some embodiments, the silk fibroin proteins or fragments thereof have any average weight average molecular weight described herein. In some embodiments, the silk fibroin proteins or fragments thereof have a polydispersity between 1 and about 1.5. In some embodiments, the silk fibroin proteins or fragments thereof have a polydispersity between about 1.5 and about 2. In some embodiments, the silk fibroin proteins or fragments thereof have a polydispersity between about 2 and about 2.5. In some embodiments, the silk fibroin proteins or fragments thereof have a polydispersity between about 2.5 and about 3. In some embodiments, the silk fibroin proteins or fragments thereof have a polydispersity between about 3 and about 3.5. In some embodiments, the silk fibroin proteins or fragments thereof have a polydispersity between about 3.5 and about 4. In some embodiments, of claim 1, wherein the silk fibroin proteins or fragments thereof have a polydispersity between about 4 and about 4.5. In some embodiments, the silk fibroin proteins or fragments thereof have a polydispersity between about 4.5 and about 5. Some methods for adding a protein to a substrate, including a leather substrate, are described in U.S. Pat. No. 8,993,065, incorporated herein by reference in its entirety.

The disclosure also provides an article including a leather substrate and silk fibroin proteins or fragments thereof having any average weight average molecular weight and polydispersity described herein, and optionally any other limitations described herein, and about 0.001% (w/w) to about 10% (w/w) sericin relative to the silk fibroin proteins or fragments thereof. In some embodiments, the w/w ratio between silk fibroin proteins or fragments thereof and sericin is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, or about 75:25. In some embodiments, the relative w/w amount of sericin to the silk fibroin proteins or fragments thereof is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%.

The disclosure also provides an article including a leather substrate and silk fibroin proteins or fragments thereof having any average weight average molecular weight and polydispersity described herein, and optionally any other limitations described herein, wherein the silk fibroin proteins or fragments thereof do not spontaneously or gradually gelate and do not visibly change in color or turbidity when in an aqueous solution for at least 10 days prior to being added to the leather substrate. In some embodiments, the silk fibroin proteins or fragments thereof do not spontaneously or gradually gelate and do not visibly change in color or turbidity when in an aqueous solution for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month prior to being added to the leather substrate.

The disclosure also provides an article including a leather substrate and silk fibroin proteins or fragments thereof having any average weight average molecular weight and polydispersity described herein, and optionally any other limitations described herein, wherein: 1) a portion of the silk fibroin proteins or fragments thereof is coated on a surface of the leather substrate; or 2) a portion of the silk fibroin proteins or fragments thereof is infused into a layer of the leather substrate, in some embodiments, such layers having a thickness as described herein; or 3) a portion of the silk fibroin proteins or fragments thereof is in a recessed portion of the leather substrate selected from an opening, a crevice, and a defect in the leather substrate; or 4) any combination of the above.

In some embodiments, a portion of the silk fibroin proteins or fragments thereof, which is coated on a surface of the leather substrate can have a thickness of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm. In some embodiments, a coating including silk fibroin proteins or fragments thereof, and optionally rheology modifiers and/or plasticizer, which is coated on a surface of the leather substrate, can have a thickness of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, or about 30 μm. In some embodiments, a coating including silk fibroin proteins or fragments thereof, and optionally rheology modifiers and/or plasticizer, which is coated on a surface of the leather substrate, can have a thickness of less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 11 μm, less than about 12 μm, less than about 13 μm, less than about 14 μm, less than about 15 μm, less than about 16 μm, less than about 17 μm, less than about 18 μm, less than about 19 μm, less than about 20 μm, less than about 21 μm, less than about 22 μm, less than about 23 μm, less than about 24 μm, less than about 25 μm, less than about 26 μm, less than about 27 μm, less than about 28 μm, less than about 29 μm, or less than about 30 μm. In some embodiments, a coating including silk fibroin proteins or fragments thereof, and optionally rheology modifiers and/or plasticizer, which is coated on a surface of the leather substrate, can have a thickness of greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 11 μm, greater than about 12 μm, greater than about 13 μm, greater than about 14 μm, greater than about 15 μm, greater than about 16 μm, greater than about 17 μm, greater than about 18 μm, greater than about 19 μm, greater than about 20 μm, greater than about 21 μm, greater than about 22 μm, greater than about 23 μm, greater than about 24 μm, greater than about 25 μm, greater than about 26 μm, greater than about 27 μm, greater than about 28 μm, greater than about 29 μm, or greater than about 30 μm.

As described herein, silk fibroin proteins or fragments thereof can be coated on any surface of the leather substrate, or included in a recessed portion of the leather substrate. A recessed portion of the leather substrate can have various depths, including, without limitation, between about 1 μm and about 15 μm, between about 5 μm and about 25 μm, between about 10 μm and about 50 μm, between about 25 μm and about 75 μm, between about 50 μm and about 150 μm, between about 75 μm and about 500 μm, and between about 100 μm and about 1000 μm. In some embodiments, a recessed portion of the leather substrate can have a depth of about 1 μm, about 2 μm, about 3 μm, about 4 μm, about 5 μm, about 6 μm, about 7 μm, about 8 μm, about 9 μm, about 10 μm, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, about 100 μm, about 101 μm, about 102 μm, about 103 μm, about 104 μm, about 105 μm, about 106 μm, about 107 μm, about 108 μm, about 109 μm, about 110 μm, about 111 μm, about 112 μm, about 113 μm, about 114 μm, about 115 μm, about 116 μm, about 117 μm, about 118 μm, about 119 μm, about 120 μm, about 121 μm, about 122 μm, about 123 μm, about 124 μm, about 125 μm, about 126 μm, about 127 μm, about 128 μm, about 129 μm, about 130 μm, about 131 μm, about 132 μm, about 133 μm, about 134 μm, about 135 μm, about 136 μm, about 137 μm, about 138 μm, about 139 μm, about 140 μm, about 141 μm, about 142 μm, about 143 μm, about 144 μm, about 145 μm, about 146 μm, about 147 μm, about 148 μm, about 149 μm, about 150 μm, about 151 μm, about 152 μm, about 153 μm, about 154 μm, about 155 μm, about 156 μm, about 157 μm, about 158 μm, about 159 μm, about 160 μm, about 161 μm, about 162 μm, about 163 μm, about 164 μm, about 165 μm, about 166 μm, about 167 μm, about 168 μm, about 169 μm, about 170 μm, about 171 μm, about 172 μm, about 173 μm, about 174 μm, about 175 μm, about 176 μm, about 177 μm, about 178 μm, about 179 μm, about 180 μm, about 181 μm, about 182 μm, about 183 μm, about 184 μm, about 185 μm, about 186 μm, about 187 μm, about 188 μm, about 189 μm, about 190 μm, about 191 μm, about 192 μm, about 193 μm, about 194 μm, about 195 μm, about 196 μm, about 197 μm, about 198 μm, about 199 μm, or about 200 μm. In some embodiments, a recessed portion of the leather substrate can have a depth of about 132 μm, about 151 μm, about 126 μm, about 132 μm, and/or about 63 μm.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least between about 50% and about 75% of the depth of the recessed portion, at least between about 45% and about 80% of the depth of the recessed portion, at least between about 65% and about 85% of the depth of the recessed portion, at least between about 75% and about 95% of the depth of the recessed portion. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least 99%, 98%, 97%, 96%, 95%, 94%, 93%, 92%, 91%, 90%, 89%, 88%, 87%, 86%, 85%, 84%, 83%, 82%, 81%, 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 53%, 52%, 51%, or 50% of the depth of the recessed portion. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill at least between about 5% and about 25% of the depth of the recessed portion, at least between about 10% and about 35% of the depth of the recessed portion, at least between about 15% and about 50% of the depth of the recessed portion, at least between about 25% and about 75% of the depth of the recessed portion.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 1 μm, less than about 2 μm, less than about 3 μm, less than about 4 μm, less than about 5 μm, less than about 6 μm, less than about 7 μm, less than about 8 μm, less than about 9 μm, less than about 10 μm, less than about 11 μm, less than about 12 μm, less than about 13 μm, less than about 14 μm, less than about 15 μm, less than about 16 μm, less than about 17 μm, less than about 18 μm, less than about 19 μm, less than about 20 μm, less than about 21 μm, less than about 22 μm, less than about 23 μm, less than about 24 μm, less than about 25 μm, less than about 26 μm, less than about 27 μm, less than about 28 μm, less than about 29 μm, less than about 30 μm, less than about 31 μm, less than about 32 μm, less than about 33 μm, less than about 34 μm, less than about 35 μm, less than about 36 μm, less than about 37 μm, less than about 38 μm, less than about 39 μm, less than about 40 μm, less than about 41 μm, less than about 42 μm, less than about 43 μm, less than about 44 μm, less than about 45 μm, less than about 46 μm, less than about 47 μm, less than about 48 μm, less than about 49 μm, less than about 50 μm, less than about 51 μm, less than about 52 μm, less than about 53 μm, less than about 54 μm, less than about 55 μm, less than about 56 μm, less than about 57 μm, less than about 58 μm, less than about 59 μm, less than about 60 μm, less than about 61 μm, less than about 62 μm, less than about 63 μm, less than about 64 μm, less than about 65 μm, less than about 66 μm, less than about 67 μm, less than about 68 μm, less than about 69 μm, less than about 70 μm, less than about 71 μm, less than about 72 μm, less than about 73 μm, less than about 74 μm, less than about 75 μm, less than about 76 μm, less than about 77 μm, less than about 78 μm, less than about 79 μm, less than about 80 μm, less than about 81 μm, less than about 82 μm, less than about 83 μm, less than about 84 μm, less than about 85 μm, less than about 86 μm, less than about 87 μm, less than about 88 μm, less than about 89 μm, less than about 90 μm, less than about 91 μm, less than about 92 μm, less than about 93 μm, less than about 94 μm, less than about 95 μm, less than about 96 μm, less than about 97 μm, less than about 98 μm, less than about 99 μm, less than about 100 μm, less than about 101 μm, less than about 102 μm, less than about 103 μm, less than about 104 μm, less than about 105 μm, less than about 106 μm, less than about 107 μm, less than about 108 μm, less than about 109 μm, less than about 110 μm, less than about 111 μm, less than about 112 μm, less than about 113 μm, less than about 114 μm, less than about 115 μm, less than about 116 μm, less than about 117 μm, less than about 118 μm, less than about 119 μm, less than about 120 μm, less than about 121 μm, less than about 122 μm, less than about 123 μm, less than about 124 μm, less than about 125 μm, less than about 126 μm, less than about 127 μm, less than about 128 μm, less than about 129 μm, less than about 130 μm, less than about 131 μm, less than about 132 μm, less than about 133 μm, less than about 134 μm, less than about 135 μm, less than about 136 μm, less than about 137 μm, less than about 138 μm, less than about 139 μm, less than about 140 μm, less than about 141 μm, less than about 142 μm, less than about 143 μm, less than about 144 μm, less than about 145 μm, less than about 146 μm, less than about 147 μm, less than about 148 μm, less than about 149 μm, less than about 150 μm, less than about 151 μm, less than about 152 μm, less than about 153 μm, less than about 154 μm, less than about 155 μm, less than about 156 μm, less than about 157 μm, less than about 158 μm, less than about 159 μm, less than about 160 μm, less than about 161 μm, less than about 162 μm, less than about 163 μm, less than about 164 μm, less than about 165 μm, less than about 166 μm, less than about 167 μm, less than about 168 μm, less than about 169 μm, less than about 170 μm, less than about 171 μm, less than about 172 μm, less than about 173 μm, less than about 174 μm, less than about 175 μm, less than about 176 μm, less than about 177 μm, less than about 178 μm, less than about 179 μm, less than about 180 μm, less than about 181 μm, less than about 182 μm, less than about 183 μm, less than about 184 μm, less than about 185 μm, less than about 186 μm, less than about 187 μm, less than about 188 μm, less than about 189 μm, less than about 190 μm, less than about 191 μm, less than about 192 μm, less than about 193 μm, less than about 194 μm, less than about 195 μm, less than about 196 μm, less than about 197 μm, less than about 198 μm, less than about 199 μm, or less than about 200 μm of the depth. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill less than about 132 μm, less than about 151 μm, less than about 126 μm, less than about 132 μm, and/or less than about 63 μm of the depth of the recessed portion.

In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 1 μm, greater than about 2 μm, greater than about 3 μm, greater than about 4 μm, greater than about 5 μm, greater than about 6 μm, greater than about 7 μm, greater than about 8 μm, greater than about 9 μm, greater than about 10 μm, greater than about 11 μm, greater than about 12 μm, greater than about 13 μm, greater than about 14 μm, greater than about 15 μm, greater than about 16 μm, greater than about 17 μm, greater than about 18 μm, greater than about 19 μm, greater than about 20 μm, greater than about 21 μm, greater than about 22 μm, greater than about 23 μm, greater than about 24 μm, greater than about 25 μm, greater than about 26 μm, greater than about 27 μm, greater than about 28 μm, greater than about 29 μm, greater than about 30 μm, greater than about 31 μm, greater than about 32 μm, greater than about 33 μm, greater than about 34 μm, greater than about 35 μm, greater than about 36 μm, greater than about 37 μm, greater than about 38 μm, greater than about 39 μm, greater than about 40 μm, greater than about 41 μm, greater than about 42 μm, greater than about 43 μm, greater than about 44 μm, greater than about 45 μm, greater than about 46 μm, greater than about 47 μm, greater than about 48 μm, greater than about 49 μm, greater than about 50 μm, greater than about 51 μm, greater than about 52 μm, greater than about 53 μm, greater than about 54 μm, greater than about 55 μm, greater than about 56 μm, greater than about 57 μm, greater than about 58 μm, greater than about 59 μm, greater than about 60 μm, greater than about 61 μm, greater than about 62 μm, greater than about 63 μm, greater than about 64 μm, greater than about 65 μm, greater than about 66 μm, greater than about 67 μm, greater than about 68 μm, greater than about 69 μm, greater than about 70 μm, greater than about 71 μm, greater than about 72 μm, greater than about 73 μm, greater than about 74 μm, greater than about 75 μm, greater than about 76 μm, greater than about 77 μm, greater than about 78 μm, greater than about 79 μm, greater than about 80 μm, greater than about 81 μm, greater than about 82 μm, greater than about 83 μm, greater than about 84 μm, greater than about 85 μm, greater than about 86 μm, greater than about 87 μm, greater than about 88 μm, greater than about 89 μm, greater than about 90 μm, greater than about 91 μm, greater than about 92 μm, greater than about 93 μm, greater than about 94 μm, greater than about 95 μm, greater than about 96 μm, greater than about 97 μm, greater than about 98 μm, greater than about 99 μm, greater than about 100 μm, greater than about 101 μm, greater than about 102 μm, greater than about 103 μm, greater than about 104 μm, greater than about 105 μm, greater than about 106 μm, greater than about 107 μm, greater than about 108 μm, greater than about 109 μm, greater than about 110 μm, greater than about 111 μm, greater than about 112 μm, greater than about 113 μm, greater than about 114 μm, greater than about 115 μm, greater than about 116 μm, greater than about 117 μm, greater than about 118 μm, greater than about 119 μm, greater than about 120 μm, greater than about 121 μm, greater than about 122 μm, greater than about 123 μm, greater than about 124 μm, greater than about 125 μm, greater than about 126 μm, greater than about 127 μm, greater than about 128 μm, greater than about 129 μm, greater than about 130 μm, greater than about 131 μm, greater than about 132 μm, greater than about 133 μm, greater than about 134 μm, greater than about 135 μm, greater than about 136 μm, greater than about 137 μm, greater than about 138 μm, greater than about 139 μm, greater than about 140 μm, greater than about 141 μm, greater than about 142 μm, greater than about 143 μm, greater than about 144 μm, greater than about 145 μm, greater than about 146 μm, greater than about 147 μm, greater than about 148 μm, greater than about 149 μm, greater than about 150 μm, greater than about 151 μm, greater than about 152 μm, greater than about 153 μm, greater than about 154 μm, greater than about 155 μm, greater than about 156 μm, greater than about 157 μm, greater than about 158 μm, greater than about 159 μm, greater than about 160 μm, greater than about 161 μm, greater than about 162 μm, greater than about 163 μm, greater than about 164 μm, greater than about 165 μm, greater than about 166 μm, greater than about 167 μm, greater than about 168 μm, greater than about 169 μm, greater than about 170 μm, greater than about 171 μm, greater than about 172 μm, greater than about 173 μm, greater than about 174 μm, greater than about 175 μm, greater than about 176 μm, greater than about 177 μm, greater than about 178 μm, greater than about 179 μm, greater than about 180 μm, greater than about 181 μm, greater than about 182 μm, greater than about 183 μm, greater than about 184 μm, greater than about 185 μm, greater than about 186 μm, greater than about 187 μm, greater than about 188 μm, greater than about 189 μm, greater than about 190 μm, greater than about 191 μm, greater than about 192 μm, greater than about 193 μm, greater than about 194 μm, greater than about 195 μm, greater than about 196 μm, greater than about 197 μm, greater than about 198 μm, greater than about 199 μm, or greater than about 200 μm of the depth. In some embodiments, a portion of the silk fibroin proteins or fragments thereof is in a recessed portion of the leather substrate selected from an opening, a crevice, and a defect in the leather substrate, the recessed portion having a depth as described herein, wherein the portion of the silk fibroin proteins or fragments thereof fill greater than about 132 μm, greater than about 151 μm, greater than about 126 μm, greater than about 132 μm, and/or greater than about 63 μm of the depth of the recessed portion.

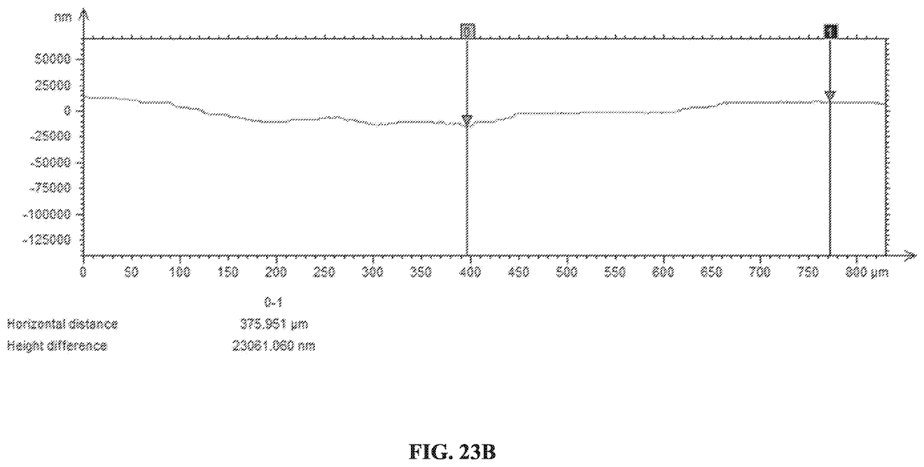

Referring to FIGS. 23A and 23B, the manner in which a portion of the silk fibroin proteins or fragments thereof is coated on a surface of the leather substrate, or the manner in which a portion of the silk fibroin proteins or fragments thereof is in a recessed portion of the leather substrate, can be described by way of a cross-section index, wherein a cross-section index is defined as the ratio between the area above the curve up to a baseline and the length of the cross section across which the area above the curve is determined. The cross-section index is reflected herein as a unitless value. The curve may reflect the leather surface (if uncoated or unfilled) along a cross-section, or a surface of a silk fibroin proteins or fragments thereof coating or filling along a cross-section. The baseline may reflect a horizontal plane approximating the surface of the leather substrate across the segment through which the cross-section index is determined.

As shown in FIG. 23A, a recessed portion is for example between the cross-section x₁=about 210 μm, and x₂=about 600 μm, and the cross-section index of this recessed portion can be calculated as described herein. In some embodiments, a recessed portion of the leather substrate has a cross-section index of about 6.50, about 6.75, about 7, about 7.25, about 7.50, about 7.75, about 8, about 8.25, about 8.50, about 8.75, about 9, about 9.25, about 9.50, about 9.75, or about 10. In some embodiments, a recessed portion of the leather substrate can have another cross-section index, for example about 5, about 5.1, about 5.2, about 5.3, about 5.4, about 5.5, about 5.6, about 5.7, about 5.8, about 5.9, about 6, about 6.1, about 6.2, bout 6.3, about 6.4, about 6.5, about 6.6, about 6.7, about 6.8, about 6.9, about 7, about 7.1, about 7.2, about 7.3, about 7.4, about 7.5, about 7.6, about 7.7, about 7.8, about 7.9, about 8, about 8.1, about 8.2, bout 8.3, about 8.4, about 8.5, about 8.6, about 8.7, about 8.8, about 8.9, about 9, about 9.1, about 9.2, about 9.3, about 9.4, about 9.5, about 9.6, about 9.7, about 9.8, about 9.9, or about 10. Also as shown in FIG. 23A, a substantially non-recessed portion of the leather substrate is for example between the cross-section x₁=0 μm, and x₂=about 210 μm, and the cross-section index of this substantially non-recessed portion can be calculated as described herein. In some embodiments, a substantially non-recessed portion of the leather substrate has a cross-section index of about 1.1, about 1.2, about 1.3, about 1.4, about 1.5, about 1.6, about 1.7, about 1.8, about 1.9, or about 2.0. In some embodiments, a substantially non-recessed portion of the leather substrate can have another cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3.

As shown in FIG. 23B, a recessed portion filled with silk fibroin proteins or fragments thereof is for example between the cross-section x₁=about 210 μm, and x₂=about 395 μm, and the cross-section index of this filled recessed portion can be calculated as described herein. In some embodiments, a filled recessed portion of the leather substrate can have a cross-section index of about 0.25, about 0.50, about 0.75, about 1, about 1.25, about 1.27, about 1.50, about 1.75, or about 2. In some embodiments, a filled recessed portion of the leather substrate can have any other cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3. Also as shown in FIG. 23B, a substantially non-recessed portion of the leather substrate coated with silk fibroin proteins or fragments thereof is for example between the cross-section x₁=0 μm, and x₂=about 210 μm, and the cross-section index of this recessed portion can be calculated as described herein. In some embodiments, a coated substantially non-recessed portion of the leather substrate has a cross-section index of about 0.05, about 0.1, about 0.15, about 0.2, about 0.25, about 0.50, about 0.75, about 1, about 1.25, about 1.27, about 1.50, about 1.75, or about 2. In some embodiments, a coated substantially non-recessed portion of the leather substrate can have any other cross-section index, for example about 0.1, about 0.2, about 0.3, about 0.4, about 0.5, about 0.6, about 0.7, about 0.8, about 0.9, about 1, about 1.1, about 1.2, bout 1.3, about 1.4, about 1.5, about 1.6, about 1.7, about 1.8, about 1.9, about 2, about 2.1, about 2.2, about 2.3, about 2.4, about 2.5, about 2.6, about 2.7, about 2.8, about 2.9, or about 3.

In some embodiments, a coated substantially non-recessed portion of the leather substrate may have a cross-section index lower than a substantially non-recessed portion of the leather substrate before coating. In some embodiments, a coated substantially non-recessed portion of the leather substrate has a cross-section index lower than a substantially non-recessed portion of the leather substrate before coating, wherein the cross-section index of the coated substantially non-recessed portion of the leather substrate is higher than 0. In some embodiments, a coated substantially non-recessed portion of the leather substrate has a cross-section index lower than a substantially non-recessed portion of the leather substrate before coating by a factor between 1% and 99%.

In some embodiments, a coated substantially non-recessed portion of the leather substrate may have a cross-section index lower than a substantially recessed portion of the leather substrate before filling. In some embodiments, a coated substantially non-recessed portion of the leather substrate has a cross-section index lower than a substantially recessed portion of the leather substrate before filling, wherein the cross-section index of the coated substantially non-recessed portion of the leather substrate is higher than 0. In some embodiments, a coated substantially non-recessed portion of the leather substrate has a cross-section index lower than a substantially recessed portion of the leather substrate before filling by a factor between 1% and 99%.

In some embodiments, a filled recessed portion of the leather substrate may have a cross-section index lower than a substantially non-recessed portion of the leather substrate before coating. In some embodiments, a filled recessed portion of the leather substrate may have a cross-section index lower than a substantially non-recessed portion of the leather substrate before coating, wherein the cross-section index of the filled recessed portion of the leather substrate is higher than 0. In some embodiments, a filled recessed portion of the leather substrate may have a cross-section index lower than a substantially non-recessed portion of the leather substrate before coating by a factor between 1% and 99%.

In some embodiments, a filled recessed portion of the leather substrate may have a cross-section index lower than a substantially non-recessed portion of the leather substrate before filling. In some embodiments, a filled recessed portion of the leather substrate may have a cross-section index lower than a substantially non-recessed portion of the leather substrate before filling, wherein the cross-section index of the filled recessed portion of the leather substrate is higher than 0. In some embodiments, a filled recessed portion of the leather substrate may have a cross-section index lower than a substantially non-recessed portion of the leather substrate before filling by a factor between 1% and 99%.

The disclosure also provides an article including a leather substrate and silk fibroin proteins or fragments thereof having any average weight average molecular weight and polydispersity described herein, and optionally any other limitations described herein, the article further including one or more polysaccharides selected from starch, cellulose, gum arabic, guar gum, xanthan gum, alginate, pectin, chitin, chitosan, carrageenan, inulin, and gellan gum. In some embodiments, the polysaccharide is gellan gum. In some embodiments, the gellan gum comprises low-acyl content gellan gum. In some embodiments, the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, or about 1:5. In some embodiments, the w/w ratio between the silk fibroin proteins or fragments thereof and the polysaccharide is about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, or about 0.1:1. In some embodiments, the w/w ratio between the silk fibroin proteins or fragments thereof and the polysaccharide is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. The ratio between the silk fibroin proteins or fragments thereof and the polysaccharide can be determined by any method known in the art, for example a mass spectrometry method, a spectroscopic method such as IR or NMR, a surface analysis method, or the like.

The disclosure provides an article including a leather substrate and silk fibroin proteins or fragments thereof having an average weight average molecular weight between about 1 kDa and about 5 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 5 kDa and about 10 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 6 kDa and about 17 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 10 kDa and about 15 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 15 kDa and about 20 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 17 kDa and about 39 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 20 kDa and about 25 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 25 kDa and about 30 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 30 kDa and about 35 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 35 kDa and about 40 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 39 kDa and about 80 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 40 kDa and about 45 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 45 kDa and about 50 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1.1.

The disclosure provides an article including a leather substrate and silk fibroin proteins or fragments thereof having an average weight average molecular weight between about 60 kDa and about 100 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1.

The disclosure provides an article including a leather substrate and silk fibroin proteins or fragments thereof having an average weight average molecular weight between about 80 kDa and about 144 kDa, and a polydispersity between 1 and about 5, or 1 and about 3, or any other range described herein; the article optionally including about 0.001% (w/w) to about 10% (w/w) sericin relative to the silk fibroin proteins or fragments thereof; wherein optionally the silk fibroin proteins or fragments thereof do not spontaneously or gradually gelate and do not visibly change in color or turbidity when in an aqueous solution for at least 10 days prior to being added to the leather substrate; wherein optionally a portion of the silk fibroin proteins or fragments thereof is a layer coated on a surface of the leather substrate, or a portion of the silk fibroin proteins or fragments thereof is infused into a layer of the leather substrate, in some embodiments, such layers having a thickness as described herein, or a portion of the silk fibroin proteins or fragments thereof is in a recessed portion of the leather substrate selected from an opening, a crevice, and a defect in the leather substrate; the article optionally including one or more polysaccharides selected from starch, cellulose, gum arabic, guar gum, xanthan gum, alginate, pectin, chitin, chitosan, carrageenan, inulin, and gellan gum, wherein the w/w ratio between the silk fibroin proteins or fragments thereof and the polysaccharide is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, or about 1:1. The disclosure also provides an article including a leather substrate and silk fibroin proteins or fragments thereof having any average weight average molecular weight and polydispersity described herein, and optionally any other limitations described herein, the article further including one or more polyols, and/or one or more polyethers. In some embodiments, the polyols include one or more of glycol, glycerol, sorbitol, glucose, sucrose, and dextrose. In some embodiments, the polyethers include one or more polyethyleneglycols (PEGs). In some embodiments, the w/w ratio between the silk fibroin proteins or fragments thereof and the one or more polyols and/or one or more polyethers is about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, or about 1:5. In some embodiments, the w/w ratio between the silk fibroin proteins or fragments thereof and the one or more polyols and/or one or more polyethers is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99

The disclosure also provides an article including a leather substrate and silk fibroin proteins or fragments thereof having any average weight average molecular weight and polydispersity described herein, and optionally any other limitations described herein, the article further including one or more of a silicone, a dye, a pigment, and a polyurethane as described herein.

In an embodiment, the invention described herein includes leather and leather articles processed with a silk composition described herein. In an embodiment, the invention described herein includes leather and leather articles coated with a silk composition described herein. In an embodiment, the invention described herein includes leather and leather articles repaired with a silk composition described herein, for example by filling, masking, or hiding a defect in the surface or structure of the leather.

As used herein, in some embodiments the term “leather” and/or “leather substrate” refers to natural leather and may be derived from bovine skin, sheep skin, lamb skin, horse skin, crocodile skin, alligator skin, avian skin, or another known animal skin as would be appreciated by the art, or processed leather. Unprocessed, processed, coated, and/or repaired leather may include, without limitation, Altered leather, Aniline leather, Bonded leather, Brushed leather, Buffed leather, Bycast leather, Chamois leather, Chrome-tanned leather, Combination tanned leather, Cordovan leather, Corrected grain leather, Crockproof leather, Drummed leather, Embossed leather, Enhanced grain leather, Grained leather, Metallized leather, Naked leather, Natural grain leather, Nubuck leather, Patent leather, Pearlized leather, Plated leather, Printed leather, Protected leather, Pure Aniline leather, Tanned/Retanned leather, Round Hand leather, Saddle leather, Semi-Aniline leather Shrunken grain leather, Side leather, Split leather, Suede leather, and Wet blue. In some embodiments, the term “leather” may refer to synthetic or reconstituted leather, including, but not limited to, leather partially/fully constituted with cellulose, mushroom-based material, synthetic materials such as vinyl, synthetic materials such as polyamide or polyester.

As used herein, the term “hand” refers to the feel of a material, which may be further described as the feeling of softness, crispness, dryness, silkiness, smoothness, and combinations thereof. Material hand is also referred to as “drape.” A material with a hard hand is coarse, rough, and generally less comfortable for the wearer. A material with a soft hand is fluid and smooth and generally more comfortable for the wearer. Material hand can be determined by comparison to collections of material samples, or by use of methods such as the Kawabata Evaluation System (KES) or the Fabric Assurance by Simple Testing (FAST) methods. Behera and Hari, Ind. J. Fibre & Textile Res., 1994, 19, 168-71. In some embodiments, and as described herein, silk can change the hand of leather, as may be evaluated by SynTouch Touch-Scale methodology or another methodology as described herein.

As used herein, a “coating” refers to a material, or combination of materials, that form a substantially continuous layer or film on an exterior surface of a substrate, such as leather or leather article. In some embodiments, a portion of the coating may penetrate at least partially into the substrate. In some embodiments, the coating may penetrate at least partially into the interstices of a substrate. In some embodiments, the coating may be infused into a surface of the substrate such that the application of the coating, or coating process, may include infusing (at the melting temperature of the substrate) at least one coating component at least partially into a surface of the substrate. A coating may be applied to a substrate by one or more of the processes described herein.

In embodiments described where the coating may be infused into a surface of the substrate, the coating may be codissolved in a surface of the substrate such that a component of the coating may be intermixed in the surface of the substrate to a depth of at least about 1 nm, or at least about 2 nm, or at least about 3 nm, or at least about 4 nm, or at least about 5 nm, or at least about 6 nm, or at least about 7 nm, or at least about 8 nm, or at least about 9 nm, or at least about 10 nm, or at least about 20 nm, or at least about 30 nm, or at least about 40 nm, or at least about 50 nm, or at least about 60 nm, or at least about 70 nm, or at least about 80 nm, or at least about 90 nm, or at least about 100 nm. In some embodiments, the coating may be infused into a surface of the substrate where the substrate includes leather or a leather article.

As used herein, the term “bath coating” encompasses coating a material in a bath, immersing a material in a bath, and submerging a material in a bath. Concepts of bath coating are set forth in U.S. Pat. No. 4,521,458, the entirety of which is incorporated by reference.

As used herein, and unless more specifically described, the term “drying” may refer to drying a coated material as described herein at a temperature greater than room temperature (i.e., 20° C.).

The disclosure provides generally to methods and articles related to filling a recessed portion of a leather, such as, without limitation, an opening, a crevice, or a defect in a leather substrate, with silk fibroin proteins and/or fragments thereof. As used herein, the term “defect” or “leather defect,” refers to any imperfection in or on the surface, and/or the underlying structure of the leather. For example, removal of a hair and/or hair follicle may leave a visible void or gap in the surface or structure of the leather or hide. This disclosure is not limited to repairing visible defects, and thus it is contemplated that any defects can be repaired as described herein. This disclosure is likewise not limited to repairing defects of a certain size, and defects of any size can be repaired and/or filled. For example, silk and/or SPFs, and any and all compositions described herein, can be used to fill in or mask the appearance of larger defects occurring over larger areas of a defective skin surface.

As used herein, “repaired” or “repairing” leather refers to filling a defect with a composition including silk and/or SPF, wherein as a result of such repairing the defect is substantially eliminated. For example, a void or gap which is fully or partially filled with a composition as described herein may be a repaired defect.

In an embodiment, the invention provides a leather or leather article processed, coated, and/or repaired with silk fibroin-based proteins or fragments thereof. In an embodiment, the invention provides a leather or leather article processed, coated, or repaired with silk fibroin-based proteins or fragments thereof, wherein the leather or leather article is a leather or leather article used for human apparel, including apparel. In an embodiment, the invention provides a leather or leather article processed, coated, or repaired with silk fibroin-based proteins or fragments thereof, wherein the leather or leather article is used for automobile upholstery. In an embodiment, the invention provides a leather or leather article processed, coated, or repaired with silk fibroin-based proteins or fragments thereof, wherein the leather or leather article is used for aircraft upholstery. In an embodiment, the invention provides a leather or leather article processed, coated, or repaired with silk fibroin-based proteins or fragments thereof, wherein the leather or leather article is used for upholstery in transportation vehicles for public, commercial, military, or other use, including buses and trains. In an embodiment, the invention provides a leather or leather article processed, coated, or repaired with silk fibroin-based proteins or fragments thereof, wherein the leather or leather article is used for upholstery of a product that requires a high degree of resistance to wear as compared to normal upholstery.

In an embodiment, a leather or leather article is treated with a polymer, such as polyglycolide (PGA), polyethylene glycols, copolymers of glycolide, glycolide/L-lactide copolymers (PGA/PLLA), glycolide/trimethylene carbonate copolymers (PGA/TMC), polylactides (PLA), stereocopolymers of PLA, poly-L-lactide (PLLA), poly-DL-lactide (PDLLA), L-lactide/DL-lactide copolymers, co-polymers of PLA, lactide/tetramethylglycolide copolymers, lactide/trimethylene carbonate copolymers, lactide/δ-valerolactone copolymers, lactide/ε-caprolactone copolymers, polydepsipeptides, PLA/polyethylene oxide copolymers, unsymmetrically 3,6-substituted poly-1,4-dioxane-2,5-diones, poly-β-hydroxybutyrate (PHBA), PHBA/β-hydroxyvalerate copolymers (PHBA/HVA), poly-β-hydroxypropionate (PHPA), poly-p-dioxanone (PDS), poly-δ-valerolactone, poly-ε-caprolactone, methylmethacrylate-N-vinyl pyrrolidine copolymers, polyesteramides, polyesters of oxalic acid, polydihydropyrans, polyalkyl-2-cyanoacrylates, polyurethanes (PU), polyvinylalcohols (PVA), polypeptides, poly-β-malic acid (PMLA), poly-β-alkanoic acids, polyvinylalcohol (PVA), polyethyleneoxide (PEO), chitine polymers, polyethylene, polypropylene, polyasetal, polyamides, polyesters, polysulphone, polyether ether ketone, polyethylene terephthalate, polycarbonate, polyaryl ether ketone, and polyether ketone ketone.

In an embodiment, an aqueous solution of pure silk fibroin-based protein fragments of the present disclosure is used to process and/or coat a leather or leather article. In an embodiment, the concentration of silk in the solution ranges from about 0.1% to about 20.0%. In an embodiment, the concentration of silk in the solution ranges from about 0.1% to about 15.0%. In an embodiment, the concentration of silk in the solution ranges from about 0.5% to about 10.0%. In an embodiment, the concentration of silk in the solution ranges from about 1.0% to about 5.0%. In an embodiment, an aqueous solution of pure silk fibroin-based protein fragments of the present disclosure is applied directly to a leather or leather article. Alternatively, silk microsphere and any additives may be used for processing and/or coating a leather or leather article. In an embodiment, additives can be added to an aqueous solution of pure silk fibroin-based protein fragments of the present disclosure before coating (e.g., alcohols) to further enhance material properties. In an embodiment, a silk coating of the present disclosure can have a pattern to optimize properties of the silk on the leather or leather article. In an embodiment, a coating is applied to a leather or leather article under tension and/or lax to vary penetration in to the leather or leather article.

In an embodiment, a composition of pure silk fibroin-based protein fragments of the present disclosure is used to repair a leather or leather article. In some embodiments, the composition is viscous. In some embodiments, the composition is thixotropic. In some embodiments, the composition is a gel, a putty, a wax, a paste, or the like. In some embodiments, the composition is shaped as a repairing bar, for example a repairing crayon. In some embodiments, the composition is delivered from a syringe, a delivery gun, a brush-type applicator, a roller-type applicator, a pen or marker-type applicator, or the like. In some embodiments, the composition is co-delivered from a multiple syringe, for example a double syringe, or a double delivery gun, along a different composition designed to harden, initiate curing of, or otherwise modify the SPF composition. In an embodiment, the concentration of silk in the composition ranges from about 0.1% to about 50.0%. In an embodiment, the concentration of silk in the solution ranges from about 0.1% to about 35.0%. In an embodiment, the concentration of silk in the solution ranges from about 0.5% to about 30.0%. In an embodiment, the concentration of silk in the solution ranges from about 1.0% to about 25.0%. In an embodiment, a composition of pure silk fibroin-based protein fragments of the present disclosure is applied directly to a leather or leather article, for example to a leather defect. Alternatively, silk microsphere and any additives may be used for repairing a leather or leather article. In an embodiment, additives can be added to the composition of pure silk fibroin-based protein fragments of the present disclosure before coating (e.g., alcohols) to further enhance material properties. In an embodiment, a composition is applied to a leather or leather article under tension and/or lax to vary penetration in to the leather, leather article, or leather defect.

Methods of Preparing Leathers Processed or Coated with Silk Compositions Described Herein

In an embodiment, the invention described herein includes methods of preparing leather and leather articles coated or repaired with silk compositions described herein.

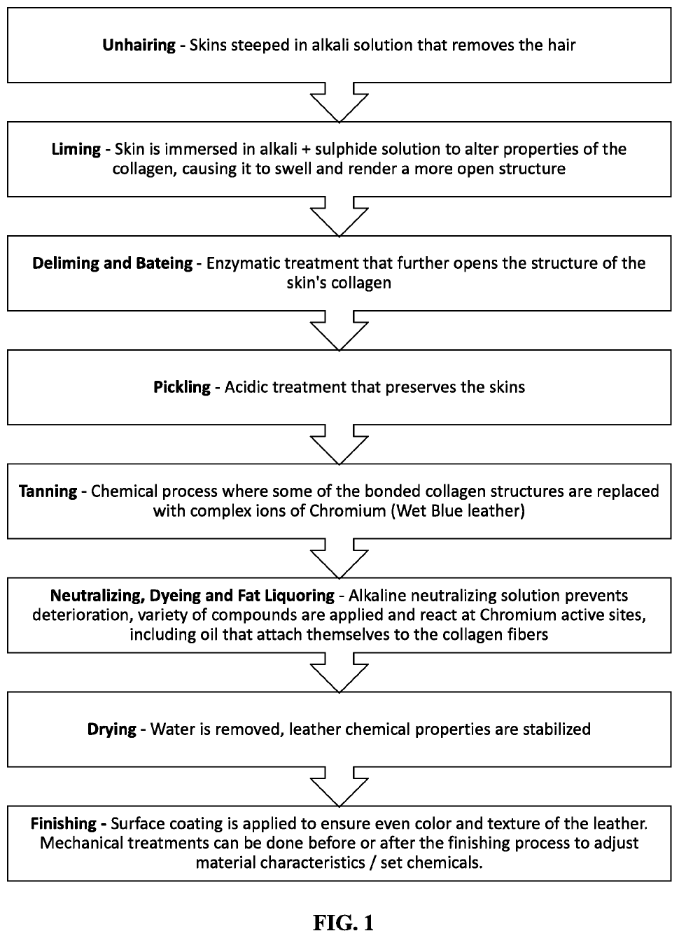

As shown in FIG. 1, the following steps may be used in a leather preparation process:
Unhairing—Skins steeped in alkali solution that removes hair;
Liming—Skin is immersed in alkali/sulphide solution to alter properties of the collagen, causing it to swell and render a more open structure;
Deliming and Bateing—Enzymatic treatment that further opens the structure of the skin's collagen;
Pickling—Acidic treatment that preserves the skins;
Tanning—Chemical process where some of the bonded collagen structures are replaced with complex ions of Chromium (wet blue leather);
Neutralizing, Dyeing and Fat Liquoring—Alkaline neutralizing solution prevents deterioration, variety of compounds are applied and react at Chromium active sites, including oil that attach themselves to the collagen fibers;
Drying—Water is removed, leather chemical properties are stabilized; and
Finishing—Surface coating is applied to ensure even color and texture of the leather. Mechanical treatments can be done before or after the finishing process to adjust material characteristics/set chemicals.

The disclosure provides a method of treating a leather substrate with a silk formulation, the method including applying on a surface of the leather a silk formulation including silk fibroin proteins or fragments thereof having an average weight average molecular weight in a range selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5. In some embodiments, any other average weight average molecular weights and polydispersities described herein can be used. In some embodiments, the silk fibroin proteins or fragments thereof have a polydispersity between 1 and about 1.5. In some embodiments, the silk fibroin proteins or fragments thereof have a polydispersity between about 1.5 and about 2. In some embodiments, the silk fibroin proteins or fragments thereof have a polydispersity between about 2 and about 2.5. In some embodiments, the silk fibroin proteins or fragments thereof have a polydispersity between about 2.5 and about 3. In some embodiments, the silk fibroin proteins or fragments thereof have a polydispersity between about 3 and about 3.5. In some embodiments, the silk fibroin proteins or fragments thereof have a polydispersity between about 3.5 and about 4. In some embodiments, the silk fibroin proteins or fragments thereof have a polydispersity between about 4 and about 4.5. In some embodiments, the silk fibroin proteins or fragments thereof have a polydispersity between about 4.5 and about 5.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk formulation further comprises about 0.001% (w/w) to about 10% (w/w) sericin relative to the silk fibroin proteins or fragments thereof. In some embodiments, the w/w ratio between silk fibroin proteins or fragments thereof and sericin is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, or about 75:25. In some embodiments, the relative w/w amount of sericin to the silk fibroin proteins or fragments thereof is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk formulation further includes about 0.001% (w/v) to about 10% (w/v) sericin. In some embodiments, the silk formulation further includes about 0.001% (w/v) sericin to about 0.01% (w/v) sericin, about 0.01% (w/v) sericin to about 0.1% (w/v) sericin, about 0.1% (w/v) sericin to about 1% (w/v) sericin, or about 1% (w/v) sericin to about 10% (w/v) sericin. In some embodiments, the silk formulation further includes about 1% (w/v) sericin, about 2% (w/v) sericin, about 3% (w/v) sericin, about 4% (w/v) sericin, about 5% (w/v) sericin, about 6% (w/v) sericin, about 7% (w/v) sericin, about 8% (w/v) sericin, about 9% (w/v) sericin, about 10% (w/v) sericin, about 11% (w/v) sericin, about 12% (w/v) sericin, about 12% (w/v) sericin, about 13% (w/v) sericin, about 14% (w/v) sericin, or about 15% (w/v) sericin.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk fibroin proteins or fragments thereof do not spontaneously or gradually gelate and do not visibly change in color or turbidity when in an aqueous solution for at least 10 days prior to being formulated and applied to the leather substrate. In some embodiments, the silk fibroin proteins or fragments thereof do not spontaneously or gradually gelate and do not visibly change in color or turbidity when in an aqueous solution for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments, the silk fibroin proteins or fragments thereof do not spontaneously or gradually gelate and do not visibly change in color or turbidity when in the formulation for at least 10 days prior to being applied to the leather substrate. In some embodiments, the silk fibroin proteins or fragments thereof do not spontaneously or gradually gelate and do not visibly change in color or turbidity when in the formulation for at least 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 4 weeks, or 1 month.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments: 1) a portion of the silk formulation is coated on a surface of the leather substrate; or 2) a portion of the silk formulation is infused into a layer of the leather substrate; or 3) a portion of the silk formulation enters a recessed portion of the leather substrate selected from an opening, a crevice, and a defect in the leather substrate; or 4) any combination of the above. The silk formulation can be coated in any desired thickness, for example, but not limited to, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, or about 100 μm. In some embodiments, coating thickness refers to wet coating. In some embodiments, coating thickness refers to after drying coating thickness. The silk formulation can be infused in a layer of the substrate having any thickness, for example, but not limited to, about 1 μm, about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 26 μm, about 27 μm, about 28 μm, about 29 μm, about 30 μm, about 31 μm, about 32 μm, about 33 μm, about 34 μm, about 35 μm, about 36 μm, about 37 μm, about 38 μm, about 39 μm, about 40 μm, about 41 μm, about 42 μm, about 43 μm, about 44 μm, about 45 μm, about 46 μm, about 47 μm, about 48 μm, about 49 μm, about 50 μm, about 51 μm, about 52 μm, about 53 μm, about 54 μm, about 55 μm, about 56 μm, about 57 μm, about 58 μm, about 59 μm, about 60 μm, about 61 μm, about 62 μm, about 63 μm, about 64 μm, about 65 μm, about 66 μm, about 67 μm, about 68 μm, about 69 μm, about 70 μm, about 71 μm, about 72 μm, about 73 μm, about 74 μm, about 75 μm, about 76 μm, about 77 μm, about 78 μm, about 79 μm, about 80 μm, about 81 μm, about 82 μm, about 83 μm, about 84 μm, about 85 μm, about 86 μm, about 87 μm, about 88 μm, about 89 μm, about 90 μm, about 91 μm, about 92 μm, about 93 μm, about 94 μm, about 95 μm, about 96 μm, about 97 μm, about 98 μm, about 99 μm, or about 100 μm. In some embodiments, infusion layer thickness refers to wet infusion. In some embodiments, infusion layer thickness refers to after drying infusion.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a rheology modifier. In some embodiments, the rheology modifier includes one or more polysaccharides, including one or more of starch, cellulose, gum arabic, guar gum, xanthan gum, alginate, pectin, chitin, chitosan, carrageenan gum, inulin, and/or gellan gum. In some embodiments, the polysaccharides include gellan gum, including, but not limited to, low-acyl content gellan gum. In some embodiments, the w/w ratio between the silk fibroin proteins or fragments thereof and the rheology modifier in the silk formulation is about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, or about 1:5. In some embodiments, the w/w ratio between the silk fibroin proteins or fragments thereof and the rheology modifier in the silk formulation is about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, or about 0.1:1. In some embodiments, the w/w ratio between the silk fibroin proteins or fragments thereof and the rheology modifier in the silk formulation is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. In some embodiments, the w/v concentration of the rheology modifier in the silk formulation is between about 0.01% and about 5%. In some embodiments, the w/v concentration of the rheology modifier in the silk formulation is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%. In some embodiments, the w/v concentration of the rheology modifier in the silk formulation is about 0.1%, about 0.2%, about 0.3%, about 0.4%, about 0.5%, about 0.6%, about 0.7%, about 0.8%, about 0.9%, or about 1%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a plasticizer. In some embodiments, the plasticizer includes one or more polyols, and/or one or more polyethers. In some embodiments, the polyols are selected from one or more of glycol, glycerol, sorbitol, glucose, sucrose, and dextrose. In some embodiments, the polyethers are one or more polyethyleneglycols (PEGs). In some embodiments, the w/w ratio between the silk fibroin proteins or fragments thereof and the plasticizer in the silk formulation is about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, or about 1:5. In some embodiments, the w/w ratio between the silk fibroin proteins or fragments thereof and the plasticizer in the silk formulation is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99. In some embodiments, the w/v concentration of the plasticizer in the silk formulation is between about 0.01% and about 10%. In some embodiments, the w/v concentration of the plasticizer in the silk formulation is about 10%, about 9%, about 8%, about 7%, about 6%, about 5%, about 4%, about 3%, about 2%, about 1%, about 0.9%, about 0.8%, about 0.7%, about 0.6%, about 0.5%, 0.4%, about 0.3%, about 0.2%, about 0.1%, about 0.01%, or about 0.001%. In some embodiments, the w/v concentration of the plasticizer in the silk formulation is about 0.1%, about 0.2%, about 0.3%, about 0.4%, about 0.5%, about 0.6%, about 0.7%, about 0.8%, about 0.9%, or about 1%.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a defoaming agent at a concentration between about 0.001% and about 1%, between about 0.01% and about 2.5%, between about 0.1% and about 3%, between about 0.5% and about 5%, or between about 0.75% and about 7.5%. In some embodiments, the defoaming agent comprises a silicone. The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further includes a deaeration agent at a concentration between about 0.001% and about 1%, between about 0.01% and about 2.5%, between about 0.1% and about 3%, between about 0.5% and about 5%, or between about 0.75% and about 7.5%. In some embodiments, the deaeration agent comprises a silicone.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation is a liquid, a gel, a paste, a wax, or a cream.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the concentration of silk fibroin proteins or fragments thereof in the silk formulation is between about 0.1% w/v and about 15% w/v. In some embodiments, the concentration of silk fibroin proteins or fragments thereof in the silk formulation is between about 0.5% w/v and about 12% w/v. In some embodiments, the concentration of silk fibroin proteins or fragments thereof in the silk formulation is about 1% w/v, about 1.5% w/v, about 2% w/v, about 2.5% w/v, about 3% w/v, about 3.5% w/v, about 4% w/v, about 4.5% w/v, about 5% w/v, about 5.5% w/v, about 6% w/v, about 6.5% w/v, about 7% w/v, about 7.5% w/v, about 8% w/v, about 8.5% w/v, about 9% w/v, about 9.5% w/v, or about 10% w/v. In some embodiments, the concentration of silk fibroin proteins or fragments thereof in the silk formulation is about 3% w/v, about 3.25% w/v, about 3.5% w/v, about 3.75%% w/v, about 4% w/v, about 4.25% w/v, about 4.5% w/v, about 4.75% w/v, about 5% w/v, about 5.25% w/v, about 5.5% w/v, about 5.75% w/v, about 6% w/v, about 6.25% w/v, about 6.5% w/v, about 6.75% w/v, about 7% w/v, about 7.25% w/v, about 7.5% w/v, about 7.75% w/v, about 8% w/v, about 8.25% w/v, about 8.5% w/v, about 8.75% w/v, about 9% w/v, about 9.25% w/v, about 9.5% w/v, about 9.75% w/v, or about 10% w/v. In some embodiments, the concentration of silk fibroin proteins or fragments thereof in the silk formulation is between about 5 mg/mL and about 125 mg/mL. In some embodiments, the concentration of silk fibroin proteins or fragments thereof in the silk formulation is about 10 mg/mL, about 11 mg/mL, about 12 mg/mL, about 13 mg/mL, about 14 mg/mL, about 15 mg/mL, about 16 mg/mL, about 17 mg/mL, about 18 mg/mL, about 19 mg/mL, about 20 mg/mL, about 21 mg/mL, about 22 mg/mL, about 23 mg/mL, about 24 mg/mL, about 25 mg/mL, about 26 mg/mL, about 27 mg/mL, about 28 mg/mL, about 29 mg/mL, about 30 mg/mL, about 31 mg/mL, about 32 mg/mL, about 33 mg/mL, about 34 mg/mL, about 35 mg/mL, about 36 mg/mL, about 37 mg/mL, about 38 mg/mL, about 39 mg/mL, about 40 mg/mL, about 41 mg/mL, about 42 mg/mL, about 43 mg/mL, about 44 mg/mL, about 45 mg/mL, about 46 mg/mL, about 47 mg/mL, about 48 mg/mL, about 49 mg/mL, about 50 mg/mL, about 51 mg/mL, about 52 mg/mL, about 53 mg/mL, about 54 mg/mL, about 55 mg/mL, about 56 mg/mL, about 57 mg/mL, about 58 mg/mL, about 59 mg/mL, about 60 mg/mL, about 61 mg/mL, about 62 mg/mL, about 63 mg/mL, about 64 mg/mL, about 65 mg/mL, about 66 mg/mL, about 67 mg/mL, about 68 mg/mL, about 69 mg/mL, about 70 mg/mL, about 71 mg/mL, about 72 mg/mL, about 73 mg/mL, about 74 mg/mL, about 75 mg/mL, about 76 mg/mL, about 77 mg/mL, about 78 mg/mL, about 79 mg/mL, about 80 mg/mL, about 81 mg/mL, about 82 mg/mL, about 83 mg/mL, about 84 mg/mL, about 85 mg/mL, about 86 mg/mL, about 87 mg/mL, about 88 mg/mL, about 89 mg/mL, about 90 mg/mL, about 91 mg/mL, about 92 mg/mL, about 93 mg/mL, about 94 mg/mL, about 95 mg/mL, about 96 mg/mL, about 97 mg/mL, about 98 mg/mL, about 99 mg/mL, about 100 mg/mL, about 101 mg/mL, about 102 mg/mL, about 103 mg/mL, about 104 mg/mL, about 105 mg/mL, about 106 mg/mL, about 107 mg/mL, about 108 mg/mL, about 109 mg/mL, or about 110 mg/mL.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the silk formulation further comprises a pH adjusting agent. In some embodiments, the pH adjusting agent includes one more of an acid and/or a base, including but not limited to, a weak acid and/or a weak base. In some embodiments, the pH adjusting agent includes one or more of ammonium hydroxide and citric acid. Any hydroxide, or weak carboxylic acid can be used interchangeably with any of the above. In some embodiments, the silk formulation has a pH of about 2, about 3, about 4, about 5, about 6, about 7, about 8, about 9, about 10, about 11, or about 12.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments treating the leather substrate with the silk formulation improves one or more of gloss, and/or color saturation, and/or smoothness.

The disclosure also provides a method of treating a leather substrate with a silk formulation, the method including applying on a surface of the leather a silk formulation including silk fibroin proteins or fragments thereof having any average weight average molecular weight and polydispersity described herein, and optionally any other steps described herein, wherein in some embodiments the method further includes one or more additional steps such as dyeing the leather, drying the leather, mechanically stretching the leather, trimming the leather, performing one or more polishing steps of the leather, applying a pigment to the leather, applying a colorant to the leather, applying an acrylic formulation to the leather, chemically fixing the leather, stamping the leather, applying a silicone finish to the leather, providing a Uniflex treatment to the leather, and/or providing a Finiflex treatment to the leather, wherein the step of applying the silk formulation on a surface of the leather is performed before, during, or after the one or more additional steps.

As described herein, a silk and/or SPF composition described herein can be used before, during, or after any of these steps. In some embodiments, the leather preparation process may include the treating of the leather with a silk composition described herein. In some embodiments, the leather preparation process may include the repairing of the leather with a silk composition described herein. In some embodiments, the silk composition may include one or more chemical agents as described hereinbelow (e.g., silicone, polyurethane, etc.).

In some embodiments, a silk composition described herein may be applied to leather or a leather article by any of the methods described herein, but also by hand-spraying, spraying using a mechanical spray setup, applying by brush, rubbing, wet-mixing, washing, drumming, soaking, injecting, plastering, smearing, or the like.

In some embodiments, a silk composition described herein may be applied alone, mixed with one or several chemicals (e.g., chemical agents), as one coat, multiple coats, or defect filling composition, at multiple times using varied application methods, to leathers that have or have not been: dyed, chrome-treated, sprayed with: pigment, acrylic, fixation agents, finishing agents, and/or colorants. In some embodiments, a silk composition described herein may be applied to a finished leather or leather article, a mechanically treated leather or leather article, or a drummed leather or leather article.

In some embodiments, a silk composition described herein (with or without one or more chemical agents) may be used to treat or repair leather before or after the liming step. In some embodiments, a silk composition described herein (with or without one or more chemical agents) may be used to treat or repair leather before or after the deliming and/or bateing steps. In some embodiments, a silk composition described herein (with or without one or more chemical agents) may be used to treat or repair leather before or after the pickling step. In some embodiments, a silk composition described herein (with or without one or more chemical agents) may be used to treat or repair leather before or after the tanning step. In some embodiments, a silk composition described herein (with or without one or more chemical agents) may be used to treat or repair leather before or after the neutralizing, dyeing, and/or fat liquoring steps. In some embodiments, a silk composition described herein (with or without one or more chemical agents) may be used to treat or repair leather before or after the drying step. In some embodiments, a silk composition described herein (with or without one or more chemical agents) may be used to treat or repair leather before or after any finishing step. In some embodiments, a silk composition described herein (with or without one or more chemical agents) may be used during the finishing step or as part of the finishing step.

In some embodiments, a silk composition described herein (with or without one or more chemical agents) may be used to treat or repair leather during the liming step. In some embodiments, a silk composition described herein (with or without one or more chemical agents) may be used to treat or repair leather during the deliming and/or bateing steps. In some embodiments, a silk composition described herein (with or without one or more chemical agents) may be used to treat or repair leather during the pickling step. In some embodiments, a silk composition described herein (with or without one or more chemical agents) may be used to treat or repair leather during the tanning step. In some embodiments, a silk composition described herein (with or without one or more chemical agents) may be used to treat or repair leather during the neutralizing, dyeing, and/or fat liquoring steps. In some embodiments, a silk composition described herein (with or without one or more chemical agents) may be used to treat or repair leather during the drying step. In some embodiments, a silk composition described herein (with or without one or more chemical agents) may be used to treat or repair leather during the finishing step. In some embodiments, a silk composition described herein (with or without one or more chemical agents) may be used during the finishing step or as part of the finishing step. In some embodiments, a silk composition described herein (with or without one or more chemical agents) may be used as a stand-alone step, for example a stand-alone coating and/or repairing step.

In some embodiments, the leather preparation process may include treating or repairing the leather with a chemical agent described herein below. In some embodiments, a chemical agent described herein below may be used to treat or repair leather before or after the drying step. In some embodiments, a chemical agent described herein below may be used to treat or repair leather before or after the finishing step. In some embodiments, a chemical agent described herein below may be used during the finishing step or as part of the finishing step.

In some embodiments, specific leather types may include a variety of other steps. In some embodiments, the invention described herein includes methods of making high-quality finished leather, for example high quality black leather, and plonge leather. With regard to the manufacturing of high-quality finished leather, for example high quality black leather, in some embodiments, a silk composition described herein (with or without one or more chemical agents) may be used to treat or repair leather before or after the dyeing process, or as part of the dyeing process. In some embodiments, a silk composition described herein (with or without one or more chemical agents) may be used to treat or repair leather before or after the drying process, or as part of the drying process. In some embodiments, a silk composition described herein (with or without one or more chemical agents) may be used to treat or repair leather before or after the mechanical stretching process, or as part of the mechanical stretching process. In some embodiments, a silk composition described herein (with or without one or more chemical agents) may be used to treat or repair leather before or after the trimming process. In some embodiments, a silk composition described herein (with or without one or more chemical agents) may be used to treat or repair leather before or after the polishing process, or as part of the polishing process. In some embodiments, a silk composition described herein (with or without one or more chemical agents) may be used to treat or repair leather before or after the pigment spray process, or as part of the pigment spray process. In some embodiments, a silk composition described herein (with or without one or more chemical agents) may be used to treat or repair leather before or after the chemical fixation process, or as part of the chemical fixation process. In some embodiments, a silk composition described herein (with or without one or more chemical agents) may be used to treat or repair leather before or after the stamping process, or as part of the stamping process. In some embodiments, a silk composition described herein (with or without one or more chemical agents) may be used to treat or repair leather before or after the silicone-coating step of the finishing process, or as part of the silicone finishing process. In some embodiments, a silk composition described herein (with or without one or more chemical agents) may be used to treat or repair leather before or after the Uniflex process, or as part of the Uniflex process.

With regard to the manufacturing of plonge leather, in some embodiments, a silk composition described herein (with or without one or more chemical agents) may be used to treat or repair leather before or after the dyeing process, or as part of the dyeing process. In some embodiments, a silk composition described herein (with or without one or more chemical agents) may be used to treat or repair leather before or after the drying process, or as part of the drying process. In some embodiments, a silk composition described herein (with or without one or more chemical agents) may be used to treat or repair leather before or after the mechanical stretching process, or as part of the mechanical stretching process. In some embodiments, a silk composition described herein (with or without one or more chemical agents) may be used to treat or repair leather before or after the trimming process. In some embodiments, a silk composition described herein (with or without one or more chemical agents) may be used to treat or repair leather before or after the first polishing process, or as part of the first polishing process. In some embodiments, a silk composition described herein (with or without one or more chemical agents) may be used to treat or repair leather before or after the color spray process, or as part of the color spray process. In some embodiments, a silk composition described herein (with or without one or more chemical agents) may be used to treat or repair leather before or after the second polish process, or as part of the second polish process. In some embodiments, a silk composition described herein (with or without one or more chemical agents) may be used to treat or repair leather before or after the Finiflex process, or as part of the Finiflex process.

In some embodiments, the silk compositions that may be used for coating or repairing leather and/or leather articles according to the processes described herein may include one or more silk compositions recited in Table 1.

In an embodiment, the invention described herein includes a method of treating or repairing leather with a silk composition described herein, wherein the method may include the steps of: dyeing the leather; mechanically stretching the leather; trimming the leather; polishing the leather; applying (optionally by spray application) a pigment, and/or an acrylic; chemically fixing the leather, stamping the leather, applying a silicone finish to the leather; and/or providing a Uniflex treatment to the leather; wherein one or more of the foregoing steps includes applying the silk composition to the leather before, during, or after the recited steps.

In an embodiment, the invention described herein includes a method of treating or repairing leather with a silk composition described herein, wherein the method may include the steps of: dyeing the leather, drying the leather; mechanically stretching the leather; trimming the leather; performing a first polish of the leather; applying (optionally by spray application) a colorant, and/or an acrylic; performing a second polish of the leather, and/or providing a Finiflex treatment to the leather; wherein one or more of the foregoing steps includes applying the silk composition to the leather before, during, or after the recited steps.

In some embodiments of the methods described herein, silk compositions described herein may be integrated into the leather treatment processes (e.g. during, before or after: pigment+acrylic, pigment+acrylic spray, colorant spray, dyeing, fixation spray, finishing spray). In some embodiments, silk compositions described herein may be applied at any part of the larger leathering process described in FIG. 1.

In some embodiments of the foregoing methods, drying may be of hand or autosprayed leather materials. In some embodiments, a drying step may be provided after each and/or before each spraying of the leather material. In some embodiments, the leather materials may be dried in an oven. In some embodiments, the drying processes may be at a temperature of less than about 70, 71, 72, 73, 74, or 75° C.; or greater than about 70, 71, 72, 73, 74, or 75° C.; or about 70, 71, 72, 73, 74, or 75° C. In some embodiments, each drying step of the leather materials may be for a period of less than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds; or greater than about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds; or about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 seconds.

In some embodiments of the foregoing methods, stamping may be used during a native production process by pressing the leather material between a top plate and a bottom plate. In some embodiments, the top plate may be at an operating temperature of less than about 50, 51, 52, 53, 54, 55, 56, 57, 58, 59, 60, 61, 62, 63, 64, or 65° C.; or greater than about 50, 51, 52, 53, 54, 55, 56, 57, 58, 59, 60, 61, 62, 63, 64, or 65° C.; or about 50, 51, 52, 53, 54, 55, 56, 57, 58, 59, 60, 61, 62, 63, 64, or 65° C. In some embodiments, the stamping step may include pressing the leather material between the first and the second plates at the top plate temperature for a period of less than about 1, 2, 3, 4, or 5 seconds; or greater than about 1, 2, 3, 4, or 5 seconds; or about 1, 2, 3, 4, or 5 seconds. In some embodiments, the stamping step may include pressing the leather material between the first and the second plates at the top plate temperature at a pressure of about 75 to about 125 kg/cm², or about 90 to about 110 kg/cm², or about 100 kg/cm².

In some embodiments of the foregoing methods, the Finiflex treatment may include compressing the leather material between two heated rotating metallic wheels at a temperature of about 75 to about 125° C., or about 93° C., at a pressure of about 5 to about 30 kg/m², or about 20 kg/m², and for a period of about 1 to about 10 seconds, or about 4 seconds.

In some embodiments of the foregoing methods, the Uniflex treatment includes pressing the leather material through two pressing cylinders, where the top cylinder is heated to a temperature of about 50 to about 100° C., or about 60° C., while the bottom cylinder may be unheated, and the two cylinders compress the leather material at about 10 to about 50 bar, or about 30 bar, for a period of about 1 to about 10 seconds, or about 3 to about 5 seconds.

In some embodiments, coated leather materials prepared by the foregoing methods may undergo mechanical quality testing according to one or more of a Veslic Process, a Martindale Process, a Water Drop Process, a Hydration Test, and a UV Test.

Veslic Process—Dry (n=50) and wet (n=10) cycles performed at f=1.0 Hz, 1 cm² abrasion cube applied at 1 kg/cm². Visually scored 0-5 (leather and abrasion cube) based on how much color rubs off the leather and onto cube. In some embodiments, dry cycles may from 0-100; wet cycles may be from 0-30; frequency may be from 0.1-2 Hz; and pressure may be from 0-5 kg/cm².

Martindale Process—11 cm² circular cuts of leather samples are rubbed against an abrasive in a lissajous figure pattern (Bowditch curve shape) for n=1500 cycles at a frequency of 0.66-1.0 Hz at 9 kPa. Visually scored 0-5 based on how much color rubs off the leather and onto cube. In some embodiments, the cycles may be from 0-5000; frequency may b from 0.1-2 Hz; and pressure may be from 0-50 kPa.

Water Drop Process—2-4 droplets are allowed to run the length of a vertically-oriented leather sample; after 1 minute the sample is judged negatively if water streaks remain on the surface. Visually scored 0-5 based on appearance of water streaks on the leather.

Hydration Test—Two circular replicants of the same leather sample are pressed surface-to-surface by a 300 g weight in a humidity chamber (90% Residual Humidity; 50° C.) for 72 hr. Scored based on how easily samples separate from one another after testing and if any color rubs off. In some embodiments, the weight may be from 0-1 kg; the residual humidity may be from 70-95%; the temperature may be from 40-80° C.; and time may be from 24-100 hr.

UV Test—Samples are placed under UV light for 25 hr and observed for color loss. Xe lamp: 42 W/m², 50° C., λ_{incident}=300-400 nm. Visually scored 0-5 based on how much color fades out of the leather over the testing period. In some embodiments, the time may be from 20-40 hr; lamp intensity may be from 20-60 W/m²; temperature may be from 40-80° C.; and the λ_{incident} may be about 250-450 nm.

In some embodiments, applying silk at the finishing stage (high-quality finished process) may allow for the creation of a new leather article with a shiny look and a natural touch by mixing silk with casein (e.g., casein phosphoprotein). Silk may be used to replace one of several finishing chemicals normally blended with casein at this stage.

In some embodiments, silk may be used to finish or repair a leather variant requiring lighter coloring treatment. The lighter volumes of colorant and pigment used may render silk more effective at locking in color.

In some embodiments, silk may be used at the wet stages of high-quality finished leather processing (e.g., in the small volume mixing drum) to replace another chemical during the colorant mixing stage.

In some embodiments, a silk wax may be used (or other silk composition described herein) to remove defects/holes in the raw leather (stemming from a follicle or a feed-stock related defect) through application of the silk material onto the skin along any point in the treatment process. If done early in the process, it may be used to change the quality classification of the pre-treated leather to be selected to make a high-quality end product. This effectively provides increased yield (amount of usable leather for a given quality of end product).

Chemical Agents for Use with Leather and Leather Articles Coated with Silk Fibroin-Based Protein Fragments

In certain embodiments, chemical agents may be used to pretreat, treat, and/or post-treat a leather or leather article described herein. In some embodiments, the silk and/or SPF solutions (e.g., SFS), or compositions, described herein, may include one or more of the chemical agents described herein. In some embodiments, the silk and/or SPF solutions or compositions described herein, may replace one or more of the chemical agents described herein. In some embodiments, the chemical agents may be selected from the group consisting of silicone, casein, an acidic agent, a dyeing agent, a pigment dye, a traditional finishing agent, and a technical finishing agent. In some embodiments, chemical agents may include one or more agents recited in Table 2. In some embodiments, the chemical agent may be selected from the group consisting of aqueous lacquers, waxes, oils, binders (protein or other), fillers, hand-modifiers, levelling agents, solvent lacquers, water-based lacquers, penetrators, acrylic resins, butadiene resins, compact resins, hybrid resins, impregnation resins, rheology modifiers, solvent dullers, solvent urethanes, water-based dullers, water-based topcoats, chromes, acidic dyes, basic dyes, dyes (chromium-based or other), colorants, and combinations thereof.

In an embodiment, the invention provides a leather or leather article processed with a composition comprising silk based proteins or fragments thereof having an average weight average molecular weight range of about 5 kDa to about 144 kDa, wherein the leather or leather article is pretreated with a wetting agent. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with a wetting agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with a wetting agent. In an embodiment, the wetting agent improves one or more coating properties. Suitable wetting agents are known to those of skill in the art. Exemplary, non-limiting examples of wetting agents from a representative supplier, Lamberti SPA, are given in the following table.

| | |
|---|---|
| Imbitex NDT | Non silicone low foaming with high wetting in both hot |
| | or cold conditions, with good detergency and good |
| | stability to alkalis. |
| Imbitex TBL | Wetting and de-aerating agent. |
| Imbitex MRC | Wetting and penetrating agent for mercerizing of cotton. |
| Tensolam Na | Low foam, special wetting and dispersing agent for non- |
| liq. | woven wet treatments. |
| Imbitex | Wetting agent for water-and oil repellent finishing. |
| NRW3 | |

In an embodiment, the invention provides a leather or leather article processed with a composition comprising silk based proteins or fragments thereof having an average weight average molecular weight range of about 5 kDa to about 144 kDa, wherein the leather or leather article is pretreated with a detergent. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with a detergent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with a detergent. In an embodiment, the detergent improves one or more coating properties. Suitable detergents are known to those of skill in the art. Exemplary, non-limiting examples of detergents from a representative supplier, Lamberti SPA, are given in the following table.

| | |
|---|---|
| Biorol | Wetting and detergent agent with alkaline stability in |
| CPNN | NaOH up to 10° C. Recommended for continuous |
| | scouring, bleaching, and Jigger applications. |
| Biorol | Wetting and detergent agent with extremely low foam |
| JK new | properties, recommended for high bath turbulence machine |
| | (e.g., jet, overflow, etc.). |
| Biorol | General-purpose wetting and detergent agent suitable for |
| OW 60 | desizing, scouring, and bleaching processes. |
| Biorol | Detergent/wetting agent, low foaming, high concentration, |
| OWK | recommended for over-flow. Useful for removal of silicone |
| | oil on Lycra blends. |
| Cesapon Silk | Specific scouring, de-gumming agent for silk. |
| liq. | |
| Cesapon | High detergent power product containing solvent. |
| Extra | |

In an embodiment, the invention provides a leather or leather article processed with a composition comprising silk based proteins or fragments thereof having an average weight average molecular weight range of about 5 kDa to about 144 kDa, wherein the leather or leather article is pretreated with a sequestering or dispersing agent. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with a sequestering or dispersing agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with a sequestering or dispersing agent. Suitable sequestering or dispersing agents are known to those of skill in the art. Exemplary, non-limiting examples of sequestering or dispersing agents from a representative supplier, Lamberti SPA, are given in the following table.

| | |
|---|---|
| Lamegal | Dispersing and anti-redepositing agent useful for preparation |
| DSP | dyeing and after soaping of dyed and printed materials with |
| | reactive and vat dyes. This product is also useful as an anti- |
| | oligomer agent in reduction clearing of polyester, dyed or |
| | printed with disperse dyes. |
| Chelam | Multi-purpose sequestering and dispersing agent for a wide |
| TLW/T | variety of textile processes. No shade variation on dyestuff |
| | containing metals. |
| Lamegal | Multi-purpose sequestring and dispersing agent for a wide |
| TL5 | variety of textile processes. |

In an embodiment, the invention provides a leather or leather article processed with a composition comprising silk based proteins or fragments thereof having an average weight average molecular weight range of about 5 kDa to about 144 kDa, wherein the leather or leather article is pretreated with an enzyme. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with an enzyme. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with an enzyme. Suitable enzymes are known to those of skill in the art. Exemplary, non-limiting examples of enzymes from a representative supplier, Lamberti SPA, are given in the following table.

| | |
|---|---|
| Lazim | Thermo-stable amylase for rapid high temperature desizing. |
| HT | |
| Lazim | Specific enzyme for bioscouring; provides optimal |
| PE | wettability, it improves dyeing and color fastness without |
| | causing depolymerization and fabric strength loss. |

In an embodiment, the invention provides a leather or leather article processed with a composition comprising silk based proteins or fragments thereof having an average weight average molecular weight range of about 5 kDa to about 144 kDa, wherein the leather or leather article is pretreated with a bleaching agent. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with a bleaching agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with a bleaching agent. Suitable bleaching agents are known to those of skill in the art. Exemplary, non-limiting examples of bleaching agents from a representative supplier, Lamberti SPA, are given in the following table.

| | |
|---|---|
| Stabilox | Highly concentrated stabilizer for alkaline bleaching with |
| OTN conc. | hydrogen peroxide. Suitable for a wide variety of processes. |

In an embodiment, the invention provides a leather or leather article processed with a composition comprising silk based proteins or fragments thereof having an average weight average molecular weight range of about 5 kDa to about 144 kDa, wherein the leather or leather article is pretreated with an antifoaming agent. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with an antifoaming agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with an antifoaming agent. Suitable antifoaming agents are known to those of skill in the art. Exemplary, non-limiting examples of antifoaming agents from a representative supplier, Lamberti SPA, are given in the following table.

| | |
|---|---|
| Antifoam SE 47 | General purpose defoaming agent. |
| Defomex JET | Silicone defoamer effective up to 130° C. |
| | Recommended for HT and JET dyeing systems. |
| Defomex 2033 | Non-silicone defoamer. |

In an embodiment, the invention provides a leather or leather article processed with a composition comprising silk based proteins or fragments thereof having an average weight average molecular weight range of about 5 kDa to about 144 kDa, wherein the leather or leather article is pretreated with an anti-creasing agent. In an embodiment, the invention provides a leather or leather article having a coating, wherein the coating comprises silk based proteins or fragments thereof having an average weight average molecular weight range of about 5 kDa to about 144 kDa, wherein the leather or leather article is pretreated with an anti-creasing agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is pretreated with an anti-creasing agent. Suitable anti-creasing agents are known to those of skill in the art. Exemplary, non-limiting examples of anti-creasing agents from a representative supplier, Lamberti SPA, are given in the following table.

| | |
|---|---|
| Lubisol AM | Lubricating and anti-creasing agent for rope wet operation |
| | on all kind of fibers and machines. |

In an embodiment, the invention provides a leather or leather article processed with a composition comprising silk based proteins or fragments thereof having an average weight average molecular weight range of about 5 kDa to about 144 kDa, wherein the leather or leather article is treated with a dye dispersing agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a dye dispersing agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a dye dispersing agent. Suitable dye dispersing agents are known to those of skill in the art. Exemplary, non-limiting examples of dye dispersing agents from a representative supplier, Lamberti SPA, are given in the following table.

| | |
|---|---|
| Lamegal BO | Liquid dispersing agent (non-ionic), suitable for |
| | direct, reactive, disperse dyeing and PES stripping. |
| Lamegal DSP | Dispersing and anti back-staining agent in |
| | preparation, dyeing and soaping of dyed and |
| | printed materials. Antioligomer agent. |
| Lamegal 619 | Effective low foam dispersing leveling agent for |
| | dyeing of PES. |
| Lamegal TL5 | Multi-purpose sequestering and dispersing agent |
| | for a variety of textile processes. |

In an embodiment, the invention provides a leather or leather article processed with a composition comprising silk based proteins or fragments thereof having an average weight average molecular weight range of about 5 kDa to about 144 kDa, wherein the leather or leather article is treated with a dye leveling agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a dye leveling agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a dye leveling agent. Suitable dye leveling agents are known to those of skill in the art. Exemplary, non-limiting examples of dye leveling agents from a representative supplier, Lamberti SPA, are given in the following table.

| | |
|---|---|
| Lamegal A 12 | Leveling agent for dyeing on wool, polyamide |
| | and its blends with acid or metal complex dyes. |

In an embodiment, the invention provides a leather or leather article processed with a composition comprising silk based proteins or fragments thereof having an average weight average molecular weight range of about 5 kDa to about 144 kDa, wherein the leather or leather article is treated with a dye fixing agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a dye fixing agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a dye fixing agent. Suitable dye fixing agents are known to those of skill in the art. Exemplary, non-limiting examples of dye fixing agents from a representative supplier, Lamberti SPA, are given in the following table.

| | |
|---|---|
| Lamfix L | Fixing agent for direct and reactive dyestuffs, |
| | containing formaldehyde. |
| Lamfix LU conc. | Formaldehyde free cationic fixing agent for |
| | direct and reactive dyes. It does not affect the |
| | shade and light fastness. |
| Lamfix PA/TR | Fixing agent to improve the wet fastness of acid |
| | dyes on polyamide fabrics, dyed or printed and |
| | polyamide yarns. Retarding agent in dyeing of |
| | Polyamide/cellulosic blends with direct dyes. |

In an embodiment, the invention provides a leather or leather article processed with a composition comprising silk based proteins or fragments thereof having an average weight average molecular weight range of about 5 kDa to about 144 kDa, wherein the leather or leather article is treated with a dye special resin agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a dye special resin agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a dye special resin agent. Suitable dye special resin agents are known to those of skill in the art. Exemplary, non-limiting examples of dye special resin agents from a representative supplier, Lamberti SPA, are given in the following table.

| | |
|---|---|
| Denifast TC | Special resin for cationization of cellulose fibers |
| | to obtain special effects (“DENIFAST system” |
| | and “DENISOL system”). |
| Cobral DD/50 | Special resin for cationization of cellulose fibers |
| | to obtain special effect (“DENIFAST system” |
| | and “DENISOL system”). |

In an embodiment, the invention provides a leather or leather article processed with a composition comprising silk based proteins or fragments thereof having an average weight average molecular weight range of about 5 kDa to about 144 kDa, wherein the leather or leather article is treated with a dye anti-reducing agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a dye anti-reducing agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a dye anti-reducing agent. Suitable dye anti-reducing agents are known to those of skill in the art. Exemplary, non-limiting examples of dye anti-reducing agents from a representative supplier, Lamberti SPA, are given in the following table.

| | |
|---|---|
| Lamberti Redox | Anti-reducing agent in grain form. 100% active |
| L2S gra | content. |
| Lamberti Redox | Anti-reducing agent in liquid form for automatic |
| L2S liq. | dosage. |

In an embodiment, the invention provides a leather or leather article processed with a composition comprising silk based proteins or fragments thereof having an average weight average molecular weight range of about 5 kDa to about 144 kDa, wherein the leather or leather article is treated with a pigment dye system anti-migrating agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a pigment dye system anti-migrating agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a pigment dye system anti-migrating agent. Suitable pigment dye system anti-migrating agents are known to those of skill in the art. Exemplary, non-limiting examples of pigment dye system anti-migrating agents from a representative supplier, Lamberti SPA, are given in the following table.

| | |
|---|---|
| Neopat Compound | Compound, developed as migration inhibitor for |
| 96/m conc. | continuous dyeing process with pigments (pad- |
| | dry process). |

In an embodiment, the invention provides a leather or leather article processed with a composition comprising silk based proteins or fragments thereof having an average weight average molecular weight range of about 5 kDa to about 144 kDa, wherein the leather or leather article is treated with a pigment dye system binder. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a pigment dye system binder. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a pigment dye system binder. Suitable pigment dye system binders are known to those of skill in the art. Exemplary, non-limiting examples of pigment dye system binders from a representative supplier, Lamberti SPA, are given in the following table.

| | |
|---|---|
| Neopat Binder PM/S | Concentrated version of a specific binder used to |
| conc. | prepare pad-liquor for dyeing with pigments |
| | (pad-dry process). |

In an embodiment, the invention provides a leather or leather article processed with a composition comprising silk based proteins or fragments thereof having an average weight average molecular weight range of about 5 kDa to about 144 kDa, wherein the leather or leather article is treated with a pigment dye system binder and anti-migrating agent combination. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a pigment dye system binder and anti-migrating agent combination. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with pigment dye system binder and anti-migrating agent combination. Suitable pigment dye system binder and anti-migrating agent combinations are known to those of skill in the art. Exemplary, non-limiting examples of pigment dye system binder and anti-migrating agent combinations from a representative supplier, Lamberti SPA, are given in the following table.

| | |
|---|---|
| Neopat Compound | Highly concentrated all-in-one product |
| PK1 | specifically developed as migration inhibitor |
| | with specific binder for continuous dyeing |
| | process with pigments (pad-dry process). |

In an embodiment, the invention provides a leather or leather article processed with a composition comprising silk based proteins or fragments thereof having an average weight average molecular weight range of about 5 kDa to about 144 kDa, wherein the leather or leather article is treated with a delave agent. In an embodiment, the invention provides a leather or leather article having a coating, wherein the coating comprises silk based proteins or fragments thereof having an average weight average molecular weight range of about 5 kDa to about 144 kDa, wherein the leather or leather article is treated with a delave agent. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is treated with a delave agent. Suitable delave agents are known to those of skill in the art. Exemplary, non-limiting examples of delave agents from a representative supplier, Lamberti SPA, are given in the following table.

| | |
|---|---|
| Neopat compound | Highly concentrated compound of surfactants |
| FTN | and polymers specifically developed for pigment |
| | dyeing and pigment-reactive dyeing process; |
| | especially for medium/dark shades for wash off |
| | effect. |

In an embodiment, the invention provides a leather or leather article processed with a composition comprising silk based proteins or fragments thereof having an average weight average molecular weight range of about 5 kDa to about 144 kDa, wherein the leather or leather article is traditionally finished with a wrinkle free treatment. In an embodiment, the invention provides a leather or leather article having a coating, wherein the coating comprises silk based proteins or fragments thereof having an average weight average molecular weight range of about 5 kDa to about 144 kDa, wherein the leather or leather article is traditionally finished with a wrinkle free treatment. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is traditionally finished with a wrinkle free treatment. Suitable wrinkle free treatments are known to those of skill in the art. Exemplary, non-limiting examples of wrinkle free treatments from a representative supplier, Lamberti SPA, are given in the following table.

| | |
|---|---|
| Cellofix | Anti-crease modified glyoxalic resin for finishing of |
| ULF conc. | cottons, cellulosics and blends with synthetics fibers. |
| Poliflex | Polyethilenic resin for waxy, full and slippy handle by |
| PO 40 | foulard applications. |
| Rolflex WF | Aliphatic waterborne Nano-PU dispersion used as extender |
| | for wrinkle free treatments. |

In an embodiment, the invention provides a leather or leather article processed with a composition comprising silk based proteins or fragments thereof having an average weight average molecular weight range of about 5 kDa to about 144 kDa, wherein the leather or leather article is traditionally finished with a softener. In an embodiment, the invention provides a leather or leather article having a coating, wherein the coating comprises silk based proteins or fragments thereof having an average weight average molecular weight range of about 5 kDa to about 144 kDa, wherein the leather or leather article is traditionally finished with a softener. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is traditionally finished with a softener. Suitable softeners are known to those of skill in the art. Exemplary, non-limiting examples of softeners from a representative supplier, Lamberti SPA, are given in the following table.

| | |
|---|---|
| Texamina | Cationic softening agent with a very soft handle particularly |
| C/FPN | recommended for application by exhaustion for all kind of |
| | fabrics. Suitable also for cone application. |
| Texamina | 100% cationic softening agent in flakes form for all type of |
| C SAL | fabrics. Dispersible at room temperature. |
| flakes | |
| Texamina | Anphoteric softening agent for all types of fabrics. Not |
| CL LIQ. | yellowing. |
| Texamina | Anphoteric softening agent for woven and knitted fabrics of |
| HVO | cotton, other cellulosics and blends. Provides a soft, smooth |
| | and dry handle. Applied by padding. |
| Texamina | Nonionic silicon dispersion in water. Excellent softening, |
| SIL | lubricating and anti-static properties for all fibre types by |
| | padding. |
| Texamina | Special cationic softener with silk protein inside. Provides a |
| SILK | “swollen touch” particularly suitable for cellulosic, wool, |
| | silk. |
| Lamfinish | All-in compound based on special polymeric hydrophilic |
| LW | softeners; by coating, foulard, and exhaustion. |
| Elastolam | General purpose mono-component silicone elastomeric |
| E50 | softener for textile finishing. |
| Elastolam | Modified polysiloxane micro-emulsion which gives a |
| EC 100 | permanent finishing, with extremely soft and silky handle. |

In an embodiment, the invention provides a leather or leather article processed with a composition comprising silk based proteins or fragments thereof having an average weight average molecular weight range of about 5 kDa to about 144 kDa, wherein the leather or leather article is traditionally finished with a handle modifier. In an embodiment, the invention provides a leather or leather article having a coating, wherein the coating comprises silk based proteins or fragments thereof having an average weight average molecular weight range of about 5 kDa to about 144 kDa, wherein the leather or leather article is traditionally finished with a handle modifier. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is traditionally finished with a handle modifier. Suitable handle modifiers are known to those of skill in the art. Exemplary, non-limiting examples of handle modifiers from a representative supplier, Lamberti SPA, are given in the following table.

| | |
|---|---|
| Poliflex CSW | Cationic anti-slipping agent. |
| Poliflex R 75 | Parafine finishing agent to give waxy handle. |
| Poliflex s | Compound specifically developed for special writing |
| | effects. |
| Poliflex m | Compound for special dry-waxy handle. |
| Lamsoft | Compound for special slippy handle specifically |
| SW 24 | developed for coating application. |
| Lamfinish | All-in-one compound to get a slippy touch; by coating. |
| SLIPPY | |
| Lamfinish | All-in-one compound to get a gummy touch; by coating. |
| GUMMY | |
| Lamfinish | All-in-one compound to get dry-sandy touch especially |
| OLDRY | suitable for vintage effects; by coating. |

In an embodiment, the invention provides a leather or leather article processed with a composition comprising silk based proteins or fragments thereof having an average weight average molecular weight range of about 5 kDa to about 144 kDa, wherein the leather or leather article is traditionally finished with a waterborne polyurethane (PU) dispersion. In an embodiment, the invention provides a leather or leather article having a coating, wherein the coating comprises silk based proteins or fragments thereof having an average weight average molecular weight range of about 5 kDa to about 144 kDa, wherein the leather or leather article is traditionally finished with a waterborne polyurethane (PU) dispersion. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is traditionally finished with a waterborne polyurethane (PU) dispersion. Suitable waterborne polyurethane dispersions for traditional finishing are known to those of skill in the art. Exemplary, non-limiting examples of waterborne polyurethane dispersions for traditional finishing from a representative supplier, Lamberti SPA, are given in the following table.

| | |
|---|---|
| Rolflex | Aliphatic waterborne PU dispersion particularly suggested for |
| LB 2 | the formulation of textile coatings where bright and rigid top |
| | finish is required. It is particularly suitable as a finishing |
| | agent for organza touch on silk fabrics. Transparent and |
| | shiny. |
| Rolflex | Aliphatic waterborne PU dispersion particularly suggested for |
| HP 51 | the formulation of textile coatings for outwear, luggage, |
| | technical articles especially where hard and flexible touch is |
| | required. Transparent and shiny. |
| Rolflex | Aliphatic waterborne PU dispersion particularly suggested for |
| PU 879 | the formulation of textile coatings for outwear, luggage, |
| | technical articles where a medium-hard and flexible touch is |
| | required. |
| Rolflex | Aliphatic waterborne PU dispersion particularly suggested for |
| ALM | the formulation of textile coatings for outwear, luggage, |
| | technical articles where a soft and flexible touch is required. |
| | Can be also suitable for printing application. |
| Rolflex | Aliphatic waterborne PU dispersion particularly suggested for |
| AP | the formulation of textile coatings for outwear, fashion where |
| | a soft and gummy touch is required. |
| Rolflex | Aliphatic waterborne PU dispersion particularly suggested for |
| W4 | the formulation of textile coatings for clothing, outwear where |
| | a full, soft and non sticky touch is required. |
| Rolflex | Aliphatic waterborne PU dispersion particularly suggested for |
| ZB7 | the formulation of textile coatings for clothing, outwear, |
| | sportswear, fashion and technical articles for industrial |
| | applications. The product has a very high charge digestion |
| | properties, electrolytes stability and excellent mechanical and |
| | tear resistance. Can be also suitable for foam coating and |
| | printing application. |
| Rolflex | Aliphatic waterborne PU dispersion particularly suggested for |
| BZ 78 | the formulation of textile coatings for clothing, outwear, |
| | sportswear, fashion and technical articles for industrial |
| | applications. The product has an excellent hydrolysis |
| | resistance, a very high charge digestion and electrolytes |
| | stability and an excellent mechanical and tear resistance. Can |
| | be also suitable for foam coating and printing application. |
| Rolflex | Gives to the coated fabric a full, soft, and slightly sticky |
| K 110 | handle with excellent fastness on all types of fabrics. |
| Rolflex | Aliphatic waterborne PU dispersion particularly suggested for |
| OP 80 | the formulation of textile coatings for outwear, luggage and |
| | fashion finishes where an opaque non writing effect is |
| | desired. |
| Rolflex | Aliphatic waterborne PU dispersion generally used by |
| NBC | padding application as a filling and zero formaldehyde sizing |
| | agent. Can be used for outwear and fashion finishing where a |
| | full, elastic and non-sticky touch is required. |
| Rolflex | Aliphatic waterborne PU dispersion specifically designed for |
| PAD | padding application for outwear, sportswear and fashion |
| | applications where a full, elastic and non sticky touch is |
| | required. Excellent washing and dry cleaning fastness as well |
| | as good bath stability. |
| Rolflex | Aliphatic waterborne PU dispersion generally applied by |
| PN | padding application for outerwear and fashion high quality |
| | applications where strong, elastic non sticky finishes are |
| | required. |
| Elafix | Aliphatic blocked isocyanate nano-dispersion used in order to |
| PV 4 | give anti-felting and anti-pilling properties to pure wool |
| | fabrics and his blend. |
| Rolflex | Aliphatic waterborne PU dispersion particularly suggested to |
| SW3 | be used by padding application for the finishing of outwear, |
| | sportswear and fashion where a slippery and elastic touch is |
| | required. It is also a good anti-pilling agent. Excellent in wool |
| | application. |
| Rolflex | Aliphatic cationic waterborne PU dispersion particularly |
| C 86 | suggested for the formulation of textile coatings for clothing, |
| | outwear, fashion where medium-soft and pleasant full touch is |
| | required. Fabrics treated with the product can be dyed with a |
| | selection of dyes, to get double-color effects of different |
| | intensity. |
| Rolflex | Aliphatic cationic waterborne PU dispersion particularly |
| CN 29 | suggested for the formulation of textile coatings for clothing, |
| | outwear, fashion where soft and pleasant full touch is |
| | required. Fabrics treated with the product can be dyed with a |
| | selection of dyes, to get double-color effects of different |
| | intensity. |

In an embodiment, the invention provides a leather or leather article processed with a composition comprising silk based proteins or fragments thereof having an average weight average molecular weight range of about 5 kDa to about 144 kDa, wherein the leather or leather article is traditionally finished with a finishing resin. In an embodiment, the invention provides a leather or leather article having a coating, wherein the coating comprises silk based proteins or fragments thereof having an average weight average molecular weight range of about 5 kDa to about 144 kDa, wherein the leather or leather article is traditionally finished with a finishing resin. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is traditionally finished with a finishing resin. Suitable finishing resins are known to those of skill in the art. Exemplary, non-limiting examples of finishing resins from a representative supplier, Lamberti SPA, are given in the following table.

| | |
|---|---|
| Textol | Handle modifier with very soft handle for coating finishes |
| 110 | |
| Textol | Water emulsion of acrylic copolymer for textile coating, |
| RGD | with very rigid handle. |
| Textol | Butadienic resin for finishing and binder for textile printing |
| SB 21 | |
| Appretto | Vinylacetate water dispersion for rigid stiffening |
| PV/CC | |
| Amisolo B | CMS water dispersion for textile finishing as stiffening |
| | agent |
| Lamovil RP | PVOH stabilized solution as stiffening agent |

In an embodiment, the invention provides a leather or leather article processed with a composition comprising silk based proteins or fragments thereof having an average weight average molecular weight range of about 5 kDa to about 144 kDa, wherein the leather or leather article is technically finished with a waterborne polyurethane dispersion. In an embodiment, the invention provides a leather or leather article having a coating, wherein the coating comprises silk based proteins or fragments thereof having an average weight average molecular weight range of about 5 kDa to about 144 kDa, wherein the leather or leather article is technically finished with a waterborne polyurethane dispersion. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is technically finished with a waterborne polyurethane dispersion. Suitable waterborne polyurethane dispersions for technical finishing are known to those of skill in the art. Exemplary, non-limiting examples of waterborne polyurethane dispersions for technical finishing from a representative supplier, Lamberti SPA, are given in the following table.

| | |
|---|---|
| Rolflex | Aliphatic polyether polyurethane dispersion in water. The |
| AFP | product has high hydrolysis resistance, good breaking load |
| | resistance and excellent tear resistance. |
| Rolflex | Aliphatic polycarbonate polyurethane dispersion in water. The |
| ACF | product shows good PU and PVC bonding properties, |
| | excellent abrasion resistance as well as chemical resistance, |
| | included alcohol. |
| Rolflex | Aliphatic polyether/acrylic copolymer polyurethane dispersion |
| V 13 | in water. The product has good thermoadhesive properties and |
| | good adhesion properties on PVC. |
| Rolflex | Aliphatic polyether/acrylic copolymer polyurethane dispersion |
| K 80 | in water. ROLFLEX K 80 is specifically designed as a high |
| | performing adhesive for textile lamination. The product has |
| | excellent perchloroethylene and water fastness. |
| Rolflex | Aliphatic polyether polyurethane dispersion in water. |
| ABC | Particularly, the product presents very high water column, |
| | excellent electrolyte resistance, high LOI index, high |
| | resistance to multiple bending. |
| Rolflex | Aliphatic polyether polyurethane dispersion in water. The |
| ADH | product has a very high water column resistance. |
| Rolflex | Aliphatic waterborne PU dispersion particularly suggested for |
| W4 | the formulation of textile coatings for clothing, outwear where |
| | a full, soft and non-sticky touch is required. |
| Rolflex | Aliphatic waterborne PU dispersion particularly suggested for |
| ZB7 | the formulation of textile coatings for clothing, outwear, |
| | sportswear, fashion and technical articles for industrial |
| | applications. The product has a very high charge digestion |
| | properties, electrolytes stability and excellent mechanical and |
| | tear resistance. Can be also suitable for foam coating and |
| | printing application. |
| Rolflex | Aliphatic waterborned PU dispersion particularly suggested |
| BZ 78 | for the formulation of textile coatings for clothing, outwear, |
| | sportswear, fashion and technical articles for industrial |
| | applications. The product has an excellent hydrolysis |
| | resistance, a very high charge digestion and electrolites |
| | stability and an excellent mechanical and tear resistance. Can |
| | be also suitable for foam coating and printing application. |
| Rolflex | Aliphatic polyether polyurethane dispersion in water. This |
| PU 147 | product shows good film forming properties at room |
| | temperature. It has high fastness to light and ultraviolet |
| | radiation and good resistance to water, solvent and chemical |
| | agents, as well as mechanical resistance. |
| Rolflex | Aliphatic polyether polyurethane dispersion in water. Due to |
| SG | its thermoplastic properties it is suggested to formulate heat |
| | activated adhesives at low temperatures. |
| Elafix | Aliphatic blocked isocyanate nano-dispersion used in order to |
| PV 4 | give antifelting and antipilling properties to pure wool fabrics |
| | and his blend. |
| Rolflex | Aliphatic cationic waterborne PU dispersion particularly |
| C 86 | suggested for the formulation of textile coatings for clothing, |
| | outwear, fashion where medium-soft and pleasant full touch is |
| | required. Fabrics treated with the product can be dyed with a |
| | selection of dyes, to get double-color effects of different |
| | intensity. |
| Rolflex | Aliphatic cationic waterborne PU dispersion particularly |
| CN 29 | suggested for the formulation of textile coatings for clothing, |
| | outwear, fashion where soft and pleasant full touch is |
| | required. Fabrics treated with the product can be dyed with a |
| | selection of dyes, to get double-color effects of different |
| | intensity. |

In an embodiment, the invention provides a leather or leather article processed with a composition comprising silk based proteins or fragments thereof having an average weight average molecular weight range of about 5 kDa to about 144 kDa, wherein the leather or leather article is technically finished with an oil or water repellant. In an embodiment, the invention provides a leather or leather article having a coating, wherein the coating comprises silk based proteins or fragments thereof having an average weight average molecular weight range of about 5 kDa to about 144 kDa, wherein the leather or leather article is technically finished with an oil or water repellant. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is technically finished with an oil or water repellant. Suitable oil or water repellants for technical finishing are known to those of skill in the art. Exemplary, non-limiting examples of oil or water repellants for technical finishing from a representative supplier, Lamberti SPA, are given in the following table.

| | |
|---|---|
| Lamgard | General purpose fluorocarbon resin for water and oil |
| FT 60 | repellency; by padding application. |
| Lamgard | High performance fluorocarbon resin for water and oil |
| 48 | repellency; by padding application. High rubbing fastness. |
| Imbitex | Wetting agent for water-and oil repellent finishing. |
| NRW3 | |
| Lamgard | Crosslinker for fluorocarbon resins to improve washing |
| EXT | fastness. |

In an embodiment, the invention provides a leather or leather article processed with a composition comprising silk based proteins or fragments thereof having an average weight average molecular weight range of about 5 kDa to about 144 kDa, wherein the leather or leather article is technically finished with a flame retardant. In an embodiment, the invention provides a leather or leather article having a coating, wherein the coating comprises silk based proteins or fragments thereof having an average weight average molecular weight range of about 5 kDa to about 144 kDa, wherein the leather or leather article is technically finished with a flame retardant. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is technically finished with a flame retardant. Suitable flame retardants for technical finishing are known to those of skill in the art. Exemplary, non-limiting examples of flame retardants for technical finishing from a representative supplier, Lamberti SPA, are given in the following table.

| | |
|---|---|
| Piroflam | Non-permanent flame retardant compound for padding and |
| 712 | spray application. |
| Piroflam | Alogen free flame retardant compound for back coating |
| ECO | application for all kind of fibers. |
| Piroflam | Flame retardant compound for back coating application for all |
| UBC | kind of fibers. |

In an embodiment, the invention provides a leather or leather article processed with a composition comprising silk based proteins or fragments thereof having an average weight average molecular weight range of about 5 kDa to about 144 kDa, wherein the leather or leather article is technically finished with a crosslinker. In an embodiment, the invention provides a leather or leather article having a coating, wherein the coating comprises silk based proteins or fragments thereof having an average weight average molecular weight range of about 5 kDa to about 144 kDa, wherein the leather or leather article is technically finished with a crosslinker. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is technically finished with a crosslinker. Suitable crosslinkers for technical finishing are known to those of skill in the art. Exemplary, non-limiting examples of crosslinkers for technical finishing from a representative supplier, Lamberti SPA, are given in the following table.

| | |
|---|---|
| Rolflex | Aromatic blocked polyisocyanate in water dispersion. It is |
| BK8 | suggested as a cross-linking agent in coating pastes based of |
| | polyurethane resins to improve washing fastness. |
| Fissativo | Water dispersible aliphatic polyisocyanate suitable as |
| 05 | crosslinking agent for acrylic and polyurethane dispersions to |
| | improve adhesion and wet and dry scrub resistance. |
| Resina | Melammine-formaldheyde resin. |
| MEL | |
| Cellofix | Low formaldheyde malammine resin. |
| VLF | |

In an embodiment, the invention provides a leather or leather article processed with a composition comprising silk based proteins or fragments thereof having an average weight average molecular weight range of about 5 kDa to about 144 kDa, wherein the leather or leather article is technically finished with a thickener for technical finishing. In an embodiment, the invention provides a leather or leather article having a coating, wherein the coating comprises silk based proteins or fragments thereof having an average weight average molecular weight range of about 5 kDa to about 144 kDa, wherein the leather or leather article is technically finished with a thickener for technical finishing. In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is technically finished with a thickener for technical finishing. Suitable thickeners for technical finishing are known to those of skill in the art. Exemplary, non-limiting examples of thickeners for technical finishing from a representative supplier, Lamberti SPA, are given in the following table.

| Lambicol | Fully neutralized synthetic thickener for pigment |
|---|---|
| CL 60 | printing in oil/water emulsion; medium viscosity type |
| Viscolam | Nonionic polyurethane based thickener with pseudoplastic |
| PU conc. | behavior. |
| Viscolam | Acrylic thickener; not neutralized. |
| 115 new | |
| Viscolam | Nonionic polyurethane based thickener with newtonian |
| PS 202 | behavior. |
| Viscolam | Nonionic polyurethane based thickener with moderate |
| 1022 | pseudoplastic behavior. |

In an embodiment, the invention provides a leather or leather article processed with a composition comprising silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). In an embodiment, the invention provides a leather or leather article having a coating, wherein the coating comprises silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). In an embodiment, the invention provides a leather or leather article including a defect repairing filling, wherein the filling comprises silk based proteins or fragments thereof having an average weight average molecular weight range of about 5 kDa to about 144 kDa, wherein the leather or leather article is finished with one or more of Silky Top 7425 NF, Uniseal 9049, Unithane 351 NF, and Unithane 2132 NF (Union Specialties, Inc.). Other suitable Union Specialties products such as finishes, additive, and/or oils and waxes are known to those of skill in the art. Exemplary, non-limiting examples of Union Specialties products are given in the following table:

| | |
|---|---|
| Silky Top | NMP-free water-based spray wax top; can be used on any |
| 7425 NF | leather, e.g., sheepskin for garment and nappa; can be sprayed |
| | and then iron on a Finiflex to give desired gloss and feel; can |
| | be sprayed undiluted (for maximum effect) or diluted with |
| | water 1:1 or 1:2. |
| Uniseal | Slightly cationic pre-bottom for corrected grain leathers to |
| 9049 | give uniformity and filling properties; pigment can be added |
| | to UNISEAL 9049 up to 10% for added coverage; can be |
| | sprayed and then plate the leather prior to finishing; can be |
| | diluted and applied by spray method as follows; can be mixed |
| | for 30 minutes under medium shear before using. |
| Unithane | Medium/soft, lightfast, NMP-free waterborne polyurethane, |
| 351 NF | designed for use as a resin binder for basecoats where it has |
| | superior elasticity and recovery adhesion, water resistance and |
| | abrasion resistance; has good filling properties on porous |
| | substrates and very good compatibility with waterborne |
| | pigments and other additives that are commonly used in |
| | waterborne applications. |
| Unithane | NMP-free diamond clear, bright medium-hard topcoat that |
| 2132 NF | gives a feel similar to a nitrocellulose lacquer; when a light |
| | coat is sprayed at a ratio of 1:1 with water onto full grain |
| | leather, the UNITHANE 2132 NF has abrasion resistance and |
| | creates a clear film on leather. |

In any of the foregoing leather or leather article embodiments, the processing composition comprises silk based proteins or fragments thereof having an average weight average molecular weight range of about 5 kDa to about 144 kDa. In any of the foregoing leather or leather article embodiments, the processing composition comprises silk based proteins or fragments thereof having an average weight average molecular weight range of about 6 kDa to about 17 kDa. In any of the foregoing leather or leather article embodiments, the processing composition comprises silk based proteins or fragments thereof having an average weight average molecular weight range of about 17 kDa to about 39 kDa. In any of the foregoing leather or leather article embodiments, the processing composition comprises silk based proteins or fragments thereof having an average weight average molecular weight range of about 39 kDa to about 80 kDa.

In any of the foregoing leather or leather article embodiments, the coating comprises silk based proteins or fragments thereof having an average weight average molecular weight range of about 5 kDa to about 144 kDa. In any of the foregoing leather or leather article embodiments, the coating comprises silk based proteins or fragments thereof having an average weight average molecular weight range of about 6 kDa to about 17 kDa. In any of the foregoing leather or leather article embodiments, the coating comprises silk based proteins or fragments thereof having an average weight average molecular weight range of about 17 kDa to about 39 kDa. In any of the foregoing leather or leather article embodiments, the coating comprises silk based proteins or fragments thereof having an average weight average molecular weight range of about 39 kDa to about 80 kDa.

In any of the foregoing leather or leather article embodiments, the defect repairing filling comprises silk based proteins or fragments thereof having an average weight average molecular weight range of about 5 kDa to about 144 kDa. In any of the foregoing leather or leather article embodiments, the defect repairing filling comprises silk based proteins or fragments thereof having an average weight average molecular weight range of about 6 kDa to about 17 kDa. In any of the foregoing leather or leather article embodiments, the defect repairing filling comprises silk based proteins or fragments thereof having an average weight average molecular weight range of about 17 kDa to about 39 kDa. In any of the foregoing leather or leather article embodiments, the defect repairing filling comprises silk based proteins or fragments thereof having an average weight average molecular weight range of about 39 kDa to about 80 kDa.

In any of the foregoing leather or leather article embodiments, the processing composition comprises silk based proteins or fragments thereof a low molecular weight silk. In any of the foregoing leather or leather article embodiments, the processing composition comprises a medium molecular weight silk. In any of the foregoing leather or leather article embodiments, the processing composition comprises a heavy molecular weight silk. In any of the foregoing leather or leather article embodiments, the processing composition comprises silk based proteins or fragments thereof that comprise one or more of low, medium, and high molecular weight silk.

In any of the foregoing leather or leather article embodiments, the coating comprises silk based proteins or fragments thereof a low molecular weight silk. In any of the foregoing leather or leather article embodiments, the coating comprises a medium molecular weight silk. In any of the foregoing leather or leather article embodiments, the coating comprises a heavy molecular weight silk. In any of the foregoing leather or leather article embodiments, the coating comprises silk based proteins or fragments thereof that comprise one or more of low, medium, and high molecular weight silk.

In any of the foregoing leather or leather article embodiments, the defect repairing filling comprises silk based proteins or fragments thereof a low molecular weight silk. In any of the foregoing leather or leather article embodiments, the defect repairing filling comprises a medium molecular weight silk. In any of the foregoing leather or leather article embodiments, the defect repairing filling comprises a heavy molecular weight silk. In any of the foregoing leather or leather article embodiments, the defect repairing filling comprises silk based proteins or fragments thereof that comprise one or more of low, medium, and high molecular weight silk.

In any of the foregoing leather or leather article embodiments, the silk based proteins or protein fragments thereof have an average weight average molecular weight range selected from the group consisting of about 5 to about 10 kDa, about 6 kDa to about 17 kDa, about 17 kDa to about 39 kDa, about 39 kDa to about 80 kDa, about 60 to about 100 kDa, and about 80 kDa to about 144 kDa, wherein the silk based proteins or fragments thereof have a polydispersity of between about 1.5 and about 3.0, and optionally wherein the proteins or protein fragments, prior to processing, coating, and/or repairing the leather or leather article, do not spontaneously or gradually gelate and do not visibly change in color or turbidity when in a solution for at least 10 days.

### Processes for Production of Silk Fibroin-Based Protein Fragments and Solutions Thereof

As used herein, the term “fibroin” includes silkworm fibroin and insect or spider silk protein. In an embodiment, fibroin is obtained from Bombyx mori. In an embodiment, the spider silk protein is selected from the group consisting of swathing silk (Achniform gland silk), egg sac silk (Cylindriform gland silk), egg case silk (Tubuliform silk), non-sticky dragline silk (Ampullate gland silk), attaching thread silk (Pyriform gland silk), sticky silk core fibers (Flagelliform gland silk), and sticky silk outer fibers (Aggregate gland silk).

The silk based proteins or fragments thereof, silk solutions or mixtures (e.g., SPF or SFS solutions or mixture), and the like, may be prepared according to the methods described in U.S. Pat. Nos. 9,187,538, 9,522,107, 9,522,108, 9,511,012, 9,517,191, 9,545,369, and 10,166,177, and U.S. Patent Publication Nos. 2016/0222579 and 2016/0281294, and International Patent Publication Nos. WO 2016/090055 and WO 2017/011679, the entirety of which are incorporated herein by reference. In some embodiments, the silk based proteins or fragments thereof may be provided as a silk composition, which may be an aqueous solution or mixture of silk, a silk gel, and/or a silk wax as described herein. Methods of using silk fibroin or silk fibroin fragments in coating applications are known and are described for example in U.S. Pat. Nos. 10,287,728 and 10,301,768.

Following are non-limiting examples of suitable ranges for various parameters in and for preparation of the silk solutions and/or compositions of the present disclosure. The silk solutions of the present disclosure may include one or more, but not necessarily all, of these parameters and may be prepared using various combinations of ranges of such parameters.

In an embodiment, the percent silk in the solution or composition is less than 50%. In an embodiment, the percent silk in the solution or composition is less than 45%. In an embodiment, the percent silk in the solution or composition is less than 40%. In an embodiment, the percent silk in the solution or composition is less than 35%. In an embodiment, the percent silk in the solution or composition is less than 30%. In an embodiment, the percent silk in the solution or composition is less than 25%. In an embodiment, the percent silk in the solution or composition is less than 20%. In an embodiment, the percent silk in the solution or composition is less than 19%. In an embodiment, the percent silk in the solution or composition is less than 18%. In an embodiment, the percent silk in the solution or composition is less than 17%. In an embodiment, the percent silk in the solution or composition is less than 16%. In an embodiment, the percent silk in the solution or composition is less than 15%. In an embodiment, the percent silk in the solution or composition is less than 14%. In an embodiment, the percent silk in the solution or composition is less than 13%. In an embodiment, the percent silk in the solution or composition is less than 12%. In an embodiment, the percent silk in the solution or composition is less than 11%. In an embodiment, the percent silk in the solution or composition is less than 10%. In an embodiment, the percent silk in the solution or composition is less than 9%. In an embodiment, the percent silk in the solution or composition is less than 8%. In an embodiment, the percent silk in the solution or composition is less than 7%. In an embodiment, the percent silk in the solution or composition is less than 6%. In an embodiment, the percent silk in the solution or composition is less than 5%. In an embodiment, the percent silk in the solution or composition is less than 4%. In an embodiment, the percent silk in the solution or composition is less than 3%. In an embodiment, the percent silk in the solution or composition is less than 2%. In an embodiment, the percent silk in the solution or composition is less than 1%. In an embodiment, the percent silk in the solution or composition is less than 0.9%. In an embodiment, the percent silk in the solution or composition is less than 0.8%. In an embodiment, the percent silk in the solution or composition is less than 0.7%. In an embodiment, the percent silk in the solution or composition is less than 0.6%. In an embodiment, the percent silk in the solution or composition is less than 0.5%. In an embodiment, the percent silk in the solution or composition is less than 0.4%. In an embodiment, the percent silk in the solution or composition is less than 0.3%. In an embodiment, the percent silk in the solution or composition is less than 0.2%. In an embodiment, the percent silk in the solution or composition is less than 0.1%. In an embodiment, the percent silk in the solution or composition is less than 0.01%. In an embodiment, the percent silk in the solution or composition is less than 0.001%.

In an embodiment, the percent silk in the solution or composition is greater than 0.001%. In an embodiment, the percent silk in the solution or composition is greater than 0.01%. In an embodiment, the percent silk in the solution or composition is greater than 0.1%. In an embodiment, the percent silk in the solution or composition is greater than 0.2%. In an embodiment, the percent silk in the solution or composition is greater than 0.3%. In an embodiment, the percent silk in the solution or composition is greater than 0.4%. In an embodiment, the percent silk in the solution or composition is greater than 0.5%. In an embodiment, the percent silk in the solution or composition is greater than 0.6%. In an embodiment, the percent silk in the solution or composition is greater than 0.7%. In an embodiment, the percent silk in the solution or composition is greater than 0.8%. In an embodiment, the percent silk in the solution or composition is greater than 0.9%. In an embodiment, the percent silk in the solution or composition is greater than 1%. In an embodiment, the percent silk in the solution or composition is greater than 2%. In an embodiment, the percent silk in the solution or composition is greater than 3%. In an embodiment, the percent silk in the solution or composition is greater than 4%. In an embodiment, the percent silk in the solution or composition is greater than 5%. In an embodiment, the percent silk in the solution or composition is greater than 6%. In an embodiment, the percent silk in the solution or composition is greater than 7%. In an embodiment, the percent silk in the solution or composition is greater than 8%. In an embodiment, the percent silk in the solution or composition is greater than 9%. In an embodiment, the percent silk in the solution or composition is greater than 10%. In an embodiment, the percent silk in the solution or composition is greater than 11%. In an embodiment, the percent silk in the solution or composition is greater than 12%. In an embodiment, the percent silk in the solution or composition is greater than 13%. In an embodiment, the percent silk in the solution or composition is greater than 14%. In an embodiment, the percent silk in the solution or composition is greater than 15%. In an embodiment, the percent silk in the solution or composition is greater than 16%. In an embodiment, the percent silk in the solution or composition is greater than 17%. In an embodiment, the percent silk in the solution or composition is greater than 18%. In an embodiment, the percent silk in the solution or composition is greater than 19%. In an embodiment, the percent silk in the solution or composition is greater than 20%. In an embodiment, the percent silk in the solution or composition is greater than 25%. In an embodiment, the percent silk in the solution or composition is greater than 30%. In an embodiment, the percent silk in the solution or composition is greater than 35%. In an embodiment, the percent silk in the solution or composition is greater than 40%. In an embodiment, the percent silk in the solution or composition is greater than 45%. In an embodiment, the percent silk in the solution or composition is greater than 50%.

In an embodiment, the percent silk in the solution or composition is between 0.1% and 50%. In an embodiment, the percent silk in the solution or composition is between 0.1% and 45%. In an embodiment, the percent silk in the solution or composition is between 0.1% and 40%. In an embodiment, the percent silk in the solution or composition is between 0.1% and 35%. In an embodiment, the percent silk in the solution or composition is between 0.1% and 30%. In an embodiment, the percent silk in the solution or composition is between 0.1% and 25%. In an embodiment, the percent silk in the solution or composition is between 0.1% and 20%. In an embodiment, the percent silk in the solution or composition is between 0.1% and 15%. In an embodiment, the percent silk in the solution or composition is between 0.1% and 10%. In an embodiment, the percent silk in the solution or composition is between 0.1% and 9%. In an embodiment, the percent silk in the solution or composition is between 0.1% and 8%. In an embodiment, the percent silk in the solution or composition is between 0.1% and 7%. In an embodiment, the percent silk in the solution or composition is between 0.1% and 6.5%. In an embodiment, the percent silk in the solution or composition is between 0.1% and 6%. In an embodiment, the percent silk in the solution or composition is between 0.1% and 5.5%. In an embodiment, the percent silk in the solution or composition is between 0.1% and 5%. In an embodiment, the percent silk in the solution or composition is between 0.1% and 4.5%. In an embodiment, the percent silk in the solution or composition is between 0.1% and 4%. In an embodiment, the percent silk in the solution or composition is between 0.1% and 3.5%. In an embodiment, the percent silk in the solution or composition is between 0.1% and 3%. In an embodiment, the percent silk in the solution or composition is between 0.1% and 2.5%. In an embodiment, the percent silk in the solution or composition is between 0.1% and 2.0%. In an embodiment, the percent silk in the solution or composition is between 0.1% and 2.4%. In an embodiment, the percent silk in the solution or composition is between 0.5% and 5%. In an embodiment, the percent silk in the solution or composition is between 0.5% and 4.5%. In an embodiment, the percent silk in the solution or composition is between 0.5% and 4%. In an embodiment, the percent silk in the solution or composition is between 0.5% and 3.5%. In an embodiment, the percent silk in the solution or composition is between 0.5% and 3%. In an embodiment, the percent silk in the solution or composition is between 0.5% and 2.5%. In an embodiment, the percent silk in the solution or composition is between 1 and 4%. In an embodiment, the percent silk in the solution or composition is between 1 and 3.5%. In an embodiment, the percent silk in the solution or composition is between 1 and 3%. In an embodiment, the percent silk in the solution or composition is between 1 and 2.5%. In an embodiment, the percent silk in the solution or composition is between 1 and 2.4%. In an embodiment, the percent silk in the solution or composition is between 1 and 2%. In an embodiment, the percent silk in the solution or composition is between 20% and 30%. In an embodiment, the percent silk in the solution or composition is between 0.1% and 6%. In an embodiment, the percent silk in the solution or composition is between 6% and 10%. In an embodiment, the percent silk in the solution or composition is between 6% and 8%. In an embodiment, the percent silk in the solution or composition is between 6% and 9%. In an embodiment, the percent silk in the solution or composition is between 10% and 20%. In an embodiment, the percent silk in the solution or composition is between 11% and 19%. In an embodiment, the percent silk in the solution or composition is between 12% and 18%. In an embodiment, the percent silk in the solution or composition is between 13% and 17%. In an embodiment, the percent silk in the solution or composition is between 14% and 16%. In an embodiment, the percent silk in the solution or composition is 2.4%. In an embodiment, the percent silk in the solution or composition is 2.0%.

In an embodiment, the percent sericin in the solution or composition is non-detectable to 30%. In an embodiment, the percent sericin in the solution or composition is non-detectable to 5%. In an embodiment, the percent sericin in the solution or composition is 1%. In an embodiment, the percent sericin in the solution or composition is 2%. In an embodiment, the percent sericin in the solution or composition is 3%. In an embodiment, the percent sericin in the solution or composition is 4%. In an embodiment, the percent sericin in the solution or composition is 5%. In an embodiment, the percent sericin in the solution or composition is 10%. In an embodiment, the percent sericin in the solution or composition is 30%.

In an embodiment, a solution or composition of the present disclosure includes pure silk fibroin-based protein fragments having an average weight average molecular weight ranging from 6 kDa to 17 kDa. In an embodiment, a solution or composition of the present disclosure includes pure silk fibroin-based protein fragments having an average weight average molecular weight ranging from 17 kDa to 39 kDa. In an embodiment, a solution or composition of the present disclosure includes pure silk fibroin-based protein fragments having an average weight average molecular weight ranging from 39 kDa to 80 kDa.

In an embodiment, a composition of the present disclosure includes pure silk fibroin-based protein fragments having an average weight average molecular weight ranging from 1 to 5 kDa. In an embodiment, a composition of the present disclosure includes pure silk fibroin-based protein fragments having an average weight average molecular weight ranging from 5 to 10 kDa. In an embodiment, a composition of the present disclosure includes pure silk fibroin-based protein fragments having an average weight average molecular weight ranging from 10 to 15 kDa. In an embodiment, a composition of the present disclosure includes pure silk fibroin-based protein fragments having an average weight average molecular weight ranging from 15 to 20 kDa. In an embodiment, a composition of the present disclosure includes pure silk fibroin-based protein fragments having an average weight average molecular weight ranging from 20 to 25 kDa. In an embodiment, a composition of the present disclosure includes pure silk fibroin-based protein fragments having an average weight average molecular weight ranging from 25 to 30 kDa. In an embodiment, a composition of the present disclosure includes pure silk fibroin-based protein fragments having an average weight average molecular weight ranging from 30 to 35 kDa. In an embodiment, a composition of the present disclosure includes pure silk fibroin-based protein fragments having an average weight average molecular weight ranging from 35 to 40 kDa. In an embodiment, a composition of the present disclosure includes pure silk fibroin-based protein fragments having an average weight average molecular weight ranging from 40 to 45 kDa. In an embodiment, a composition of the present disclosure includes pure silk fibroin-based protein fragments having an average weight average molecular weight ranging from 45 to 50 kDa. In an embodiment, a composition of the present disclosure includes pure silk fibroin-based protein fragments having an average weight average molecular weight ranging from 50 to 55 kDa. In an embodiment, a composition of the present disclosure includes pure silk fibroin-based protein fragments having an average weight average molecular weight ranging from 55 to 60 kDa. In an embodiment, a composition of the present disclosure includes pure silk fibroin-based protein fragments having an average weight average molecular weight ranging from 60 to 65 kDa. In an embodiment, a composition of the present disclosure includes pure silk fibroin-based protein fragments having an average weight average molecular weight ranging from 65 to 70 kDa. In an embodiment, a composition of the present disclosure includes pure silk fibroin-based protein fragments having an average weight average molecular weight ranging from 70 to 75 kDa. In an embodiment, a composition of the present disclosure includes pure silk fibroin-based protein fragments having an average weight average molecular weight ranging from 75 to 80 kDa. In an embodiment, a composition of the present disclosure includes pure silk fibroin-based protein fragments having an average weight average molecular weight ranging from 80 to 85 kDa. In an embodiment, a composition of the present disclosure includes pure silk fibroin-based protein fragments having an average weight average molecular weight ranging from 85 to 90 kDa. In an embodiment, a composition of the present disclosure includes pure silk fibroin-based protein fragments having an average weight average molecular weight ranging from 90 to 95 kDa. In an embodiment, a composition of the present disclosure includes pure silk fibroin-based protein fragments having an average weight average molecular weight ranging from 95 to 100 kDa. In an embodiment, a composition of the present disclosure includes pure silk fibroin-based protein fragments having an average weight average molecular weight ranging from 100 to 105 kDa. In an embodiment, a composition of the present disclosure includes pure silk fibroin-based protein fragments having an average weight average molecular weight ranging from 105 to 110 kDa. In an embodiment, a composition of the present disclosure includes pure silk fibroin-based protein fragments having an average weight average molecular weight ranging from 110 to 115 kDa. In an embodiment, a composition of the present disclosure includes pure silk fibroin-based protein fragments having an average weight average molecular weight ranging from 115 to 120 kDa. In an embodiment, a composition of the present disclosure includes pure silk fibroin-based protein fragments having an average weight average molecular weight ranging from 120 to 125 kDa. In an embodiment, a composition of the present disclosure includes pure silk fibroin-based protein fragments having an average weight average molecular weight ranging from 125 to 130 kDa. In an embodiment, a composition of the present disclosure includes pure silk fibroin-based protein fragments having an average weight average molecular weight ranging from 130 to 135 kDa. In an embodiment, a composition of the present disclosure includes pure silk fibroin-based protein fragments having an average weight average molecular weight ranging from 135 to 140 kDa. In an embodiment, a composition of the present disclosure includes pure silk fibroin-based protein fragments having an average weight average molecular weight ranging from 140 to 145 kDa. In an embodiment, a composition of the present disclosure includes pure silk fibroin-based protein fragments having an average weight average molecular weight ranging from 145 to 150 kDa. In an embodiment, a composition of the present disclosure includes pure silk fibroin-based protein fragments having an average weight average molecular weight ranging from 150 to 155 kDa. In an embodiment, a composition of the present disclosure includes pure silk fibroin-based protein fragments having an average weight average molecular weight ranging from 155 to 160 kDa. In an embodiment, a composition of the present disclosure includes pure silk fibroin-based protein fragments having an average weight average molecular weight ranging from 160 to 165 kDa. I In an embodiment, a composition of the present disclosure includes pure silk fibroin-based protein fragments having an average weight average molecular weight ranging from 165 to 170 kDa. In an embodiment, a composition of the present disclosure includes pure silk fibroin-based protein fragments having an average weight average molecular weight ranging from 170 to 175 kDa. In an embodiment, a composition of the present disclosure includes pure silk fibroin-based protein fragments having an average weight average molecular weight ranging from 175 to 180 kDa. In an embodiment, a composition of the present disclosure includes pure silk fibroin-based protein fragments having an average weight average molecular weight ranging from 180 to 185 kDa. In an embodiment, a composition of the present disclosure includes pure silk fibroin-based protein fragments having an average weight average molecular weight ranging from 185 to 190 kDa. In an embodiment, a composition of the present disclosure includes pure silk fibroin-based protein fragments having an average weight average molecular weight ranging from 190 to 195 kDa. In an embodiment, a composition of the present disclosure includes pure silk fibroin-based protein fragments having an average weight average molecular weight ranging from 195 to 200 kDa. In an embodiment, a composition of the present disclosure includes pure silk fibroin-based protein fragments having an average weight average molecular weight ranging from 200 to 205 kDa. In an embodiment, a composition of the present disclosure includes pure silk fibroin-based protein fragments having an average weight average molecular weight ranging from 205 to 210 kDa. In an embodiment, a composition of the present disclosure includes pure silk fibroin-based protein fragments having an average weight average molecular weight ranging from 210 to 215 kDa. In an embodiment, a composition of the present disclosure includes pure silk fibroin-based protein fragments having an average weight average molecular weight ranging from 215 to 220 kDa. In an embodiment, a composition of the present disclosure includes pure silk fibroin-based protein fragments having an average weight average molecular weight ranging from 220 to 225 kDa. In an embodiment, a composition of the present disclosure includes pure silk fibroin-based protein fragments having an average weight average molecular weight ranging from 225 to 230 kDa. In an embodiment, a composition of the present disclosure includes pure silk fibroin-based protein fragments having an average weight average molecular weight ranging from 230 to 235 kDa. In an embodiment, a composition of the present disclosure includes pure silk fibroin-based protein fragments having an average weight average molecular weight ranging from 235 to 240 kDa. In an embodiment, a composition of the present disclosure includes pure silk fibroin-based protein fragments having an average weight average molecular weight ranging from 240 to 245 kDa. In an embodiment, a composition of the present disclosure includes pure silk fibroin-based protein fragments having an average weight average molecular weight ranging from 245 to 250 kDa. In an embodiment, a composition of the present disclosure includes pure silk fibroin-based protein fragments having an average weight average molecular weight ranging from 250 to 255 kDa. In an embodiment, a composition of the present disclosure includes pure silk fibroin-based protein fragments having an average weight average molecular weight ranging from 255 to 260 kDa. In an embodiment, a composition of the present disclosure includes pure silk fibroin-based protein fragments having an average weight average molecular weight ranging from 260 to 265 kDa. In an embodiment, a composition of the present disclosure includes pure silk fibroin-based protein fragments having an average weight average molecular weight ranging from 265 to 270 kDa. In an embodiment, a composition of the present disclosure includes pure silk fibroin-based protein fragments having an average weight average molecular weight ranging from 270 to 275 kDa. In an embodiment, a composition of the present disclosure includes pure silk fibroin-based protein fragments having an average weight average molecular weight ranging from 275 to 280 kDa. In an embodiment, a composition of the present disclosure includes pure silk fibroin-based protein fragments having an average weight average molecular weight ranging from 280 to 285 kDa. In an embodiment, a composition of the present disclosure includes pure silk fibroin-based protein fragments having an average weight average molecular weight ranging from 285 to 290 kDa. In an embodiment, a composition of the present disclosure includes pure silk fibroin-based protein fragments having an average weight average molecular weight ranging from 290 to 295 kDa. In an embodiment, a composition of the present disclosure includes pure silk fibroin-based protein fragments having an average weight average molecular weight ranging from 295 to 300 kDa. In an embodiment, a composition of the present disclosure includes pure silk fibroin-based protein fragments having an average weight average molecular weight ranging from 300 to 305 kDa. In an embodiment, a composition of the present disclosure includes pure silk fibroin-based protein fragments having an average weight average molecular weight ranging from 305 to 310 kDa. In an embodiment, a composition of the present disclosure includes pure silk fibroin-based protein fragments having an average weight average molecular weight ranging from 310 to 315 kDa. In an embodiment, a composition of the present disclosure includes pure silk fibroin-based protein fragments having an average weight average molecular weight ranging from 315 to 320 kDa. In an embodiment, a composition of the present disclosure includes pure silk fibroin-based protein fragments having an average weight average molecular weight ranging from 320 to 325 kDa. In an embodiment, a composition of the present disclosure includes pure silk fibroin-based protein fragments having an average weight average molecular weight ranging from 325 to 330 kDa. In an embodiment, a composition of the present disclosure includes pure silk fibroin-based protein fragments having an average weight average molecular weight ranging from 330 to 335 kDa. In an embodiment, a composition of the present disclosure includes pure silk fibroin-based protein fragments having an average weight average molecular weight ranging from 35 to 340 kDa. In an embodiment, a composition of the present disclosure includes pure silk fibroin-based protein fragments having an average weight average molecular weight ranging from 340 to 345 kDa. In an embodiment, a composition of the present disclosure includes pure silk fibroin-based protein fragments having an average weight average molecular weight ranging from 345 to 350 kDa.

In an embodiment, a composition of the present disclosure includes silk protein fragments having an average weight average molecular weight ranging from 6 kDa to 17 kDa. In an embodiment, a composition of the present disclosure includes silk protein fragments having an average weight average molecular weight ranging from 17 kDa to 39 kDa. In an embodiment, a composition of the present disclosure includes silk protein fragments having an average weight average molecular weight ranging from 39 kDa to 80 kDa.

In an embodiment, a composition of the present disclosure includes silk protein fragments having an average weight average molecular weight of about 1 kDa to about 350 kDa, or about 1 kDa to about 300 kDa, or about 1 kDa to about 250 kDa, or about 1 kDa to about 200 kDa, or about 1 kDa to about 150 kDa, or about 1 kDa to about 100 kDa, or about 1 kDa to about 50 kDa, or about 1 kDa to about 25 kDa.

In an embodiment, silk fibroin-based protein fragments incorporated into the silk compositions described herein have having an average weight average molecular weight ranging from 1 kDa to 6 kDa. In an embodiment, silk fibroin-based protein fragments incorporated into the silk compositions described herein have an average weight average molecular weight ranging from 6 kDa to 16 kDa. In an embodiment, silk fibroin-based protein fragments incorporated into the silk compositions described herein have an average weight average molecular weight ranging from 16 kDa to 38 kDa. In an embodiment, silk fibroin-based protein fragments incorporated into the silk compositions described herein have an average weight average molecular weight ranging from 38 kDa to 80 kDa. In an embodiment, silk fibroin-based protein fragments incorporated into the silk compositions described herein have an average weight average molecular weight ranging from 80 kDa to 150 kDa.

In an embodiment, silk fibroin-based protein fragments incorporated into the silk compositions described herein have an average weight average molecular weight ranging from 1 kDa to 250 kDa. In an embodiment, silk fibroin-based protein fragments incorporated into the silk compositions described herein have an average weight average molecular weight ranging from 1 kDa to 240 kDa. In an embodiment, silk fibroin-based protein fragments incorporated into the silk compositions described herein have an average weight average molecular weight ranging from 1 kDa to 230 kDa. In an embodiment, silk fibroin-based protein fragments incorporated into the silk compositions described herein have an average weight average molecular weight ranging from 1 kDa to 220 kDa. In an embodiment, silk fibroin-based protein fragments incorporated into the silk compositions described herein have an average weight average molecular weight ranging from 1 kDa to 210 kDa. In an embodiment, silk fibroin-based protein fragments incorporated into the silk compositions described herein have an average weight average molecular weight ranging from 1 kDa to 200 kDa. In an embodiment, silk fibroin-based protein fragments incorporated into the silk compositions described herein have an average weight average molecular weight ranging from 1 kDa to 190 kDa. In an embodiment, silk fibroin-based protein fragments incorporated into the silk compositions described herein have an average weight average molecular weight ranging from 1 kDa to 180 kDa. In an embodiment, silk fibroin-based protein fragments incorporated into the silk compositions described herein have an average weight average molecular weight ranging from 1 kDa to 170 kDa. In an embodiment, silk fibroin-based protein fragments incorporated into the silk compositions described herein have an average weight average molecular weight ranging from 1 kDa to 160 kDa. In an embodiment, silk fibroin-based protein fragments incorporated into the silk compositions described herein have an average weight average molecular weight ranging from 1 kDa to 150 kDa. In an embodiment, silk fibroin-based protein fragments incorporated into the silk compositions described herein have an average weight average molecular weight ranging from 1 kDa to 140 kDa. In an embodiment, silk fibroin-based protein fragments incorporated into the silk compositions described herein have an average weight average molecular weight ranging from 1 kDa to 130 kDa. In an embodiment, silk fibroin-based protein fragments incorporated into the silk compositions described herein have an average weight average molecular weight ranging from 1 kDa to 120 kDa. In an embodiment, silk fibroin-based protein fragments incorporated into the silk compositions described herein have an average weight average molecular weight ranging from 1 kDa to 110 kDa. In an embodiment, silk fibroin-based protein fragments incorporated into the silk compositions described herein have an average weight average molecular weight ranging from 1 kDa to 100 kDa. In an embodiment, silk fibroin-based protein fragments incorporated into the silk compositions described herein have an average weight average molecular weight ranging from 1 kDa to 90 kDa. In an embodiment, silk fibroin-based protein fragments incorporated into the silk compositions described herein have an average weight average molecular weight ranging from 1 kDa to 80 kDa. In an embodiment, silk fibroin-based protein fragments incorporated into the silk compositions described herein have an average weight average molecular weight ranging from 1 kDa to 70 kDa. In an embodiment, silk fibroin-based protein fragments incorporated into the silk compositions described herein have an average weight average molecular weight ranging from 1 kDa to 60 kDa. In an embodiment, silk fibroin-based protein fragments incorporated into the silk compositions described herein have an average weight average molecular weight ranging from 1 kDa to 50 kDa. In an embodiment, silk fibroin-based protein fragments incorporated into the silk compositions described herein have an average weight average molecular weight ranging from 1 kDa to 40 kDa. In an embodiment, silk fibroin-based protein fragments incorporated into the silk compositions described herein have an average weight average molecular weight ranging from 1 kDa to 30 kDa. In an embodiment, silk fibroin-based protein fragments incorporated into the silk compositions described herein have an average weight average molecular weight ranging from 1 kDa to 20 kDa. In an embodiment, silk fibroin-based protein fragments incorporated into the silk compositions described herein have an average weight average molecular weight ranging from 1 kDa to 10 kDa.

In an embodiment, a composition of the present disclosure includes silk protein fragments having an average weight average molecular weight ranging from 1 to 5 kDa. In an embodiment, a composition of the present disclosure includes silk protein fragments having an average weight average molecular weight ranging from 5 to 10 kDa. In an embodiment, a composition of the present disclosure includes silk protein fragments having an average weight average molecular weight ranging from 10 to 15 kDa. In an embodiment, a composition of the present disclosure includes silk protein fragments having an average weight average molecular weight ranging from 15 to 20 kDa. In an embodiment, a composition of the present disclosure includes silk protein fragments having an average weight average molecular weight ranging from 20 to 25 kDa. In an embodiment, a composition of the present disclosure includes silk protein fragments having an average weight average molecular weight ranging from 25 to 30 kDa. In an embodiment, a composition of the present disclosure includes silk protein fragments having an average weight average molecular weight ranging from 30 to 35 kDa. In an embodiment, a composition of the present disclosure includes silk protein fragments having an average weight average molecular weight ranging from 35 to 40 kDa. In an embodiment, a composition of the present disclosure includes silk protein fragments having an average weight average molecular weight ranging from 40 to 45 kDa. In an embodiment, a composition of the present disclosure includes silk protein fragments having an average weight average molecular weight ranging from 45 to 50 kDa. In an embodiment, a composition of the present disclosure includes silk protein fragments having an average weight average molecular weight ranging from 50 to 55 kDa. In an embodiment, a composition of the present disclosure includes silk protein fragments having an average weight average molecular weight ranging from 55 to 60 kDa. In an embodiment, a composition of the present disclosure includes silk protein fragments having an average weight average molecular weight ranging from 60 to 65 kDa. In an embodiment, a composition of the present disclosure includes silk protein fragments having an average weight average molecular weight ranging from 65 to 70 kDa. In an embodiment, a composition of the present disclosure includes silk protein fragments having an average weight average molecular weight ranging from 70 to 75 kDa. In an embodiment, a composition of the present disclosure includes silk protein fragments having an average weight average molecular weight ranging from 75 to 80 kDa. In an embodiment, a composition of the present disclosure includes silk protein fragments having an average weight average molecular weight ranging from 80 to 85 kDa. In an embodiment, a composition of the present disclosure includes silk protein fragments having an average weight average molecular weight ranging from 85 to 90 kDa. In an embodiment, a composition of the present disclosure includes silk protein fragments having an average weight average molecular weight ranging from 90 to 95 kDa. In an embodiment, a composition of the present disclosure includes silk protein fragments having an average weight average molecular weight ranging from 95 to 100 kDa. In an embodiment, a composition of the present disclosure includes silk protein fragments having an average weight average molecular weight ranging from 100 to 105 kDa. In an embodiment, a composition of the present disclosure includes silk protein fragments having an average weight average molecular weight ranging from 105 to 110 kDa. In an embodiment, a composition of the present disclosure includes silk protein fragments having an average weight average molecular weight ranging from 110 to 115 kDa. In an embodiment, a composition of the present disclosure includes silk protein fragments having an average weight average molecular weight ranging from 115 to 120 kDa. In an embodiment, a composition of the present disclosure includes silk protein fragments having an average weight average molecular weight ranging from 120 to 125 kDa. In an embodiment, a composition of the present disclosure includes silk protein fragments having an average weight average molecular weight ranging from 125 to 130 kDa. In an embodiment, a composition of the present disclosure includes silk protein fragments having an average weight average molecular weight ranging from 130 to 135 kDa. In an embodiment, a composition of the present disclosure includes silk protein fragments having an average weight average molecular weight ranging from 135 to 140 kDa. In an embodiment, a composition of the present disclosure includes silk protein fragments having an average weight average molecular weight ranging from 140 to 145 kDa. In an embodiment, a composition of the present disclosure includes silk protein fragments having an average weight average molecular weight ranging from 145 to 150 kDa. In an embodiment, a composition of the present disclosure includes silk protein fragments having an average weight average molecular weight ranging from 150 to 155 kDa. In an embodiment, a composition of the present disclosure includes silk protein fragments having an average weight average molecular weight ranging from 155 to 160 kDa. In an embodiment, a composition of the present disclosure includes silk protein fragments having an average weight average molecular weight ranging from 160 to 165 kDa. I In an embodiment, a composition of the present disclosure includes silk protein fragments having an average weight average molecular weight ranging from 165 to 170 kDa. In an embodiment, a composition of the present disclosure includes silk protein fragments having an average weight average molecular weight ranging from 170 to 175 kDa. In an embodiment, a composition of the present disclosure includes silk protein fragments having an average weight average molecular weight ranging from 175 to 180 kDa. In an embodiment, a composition of the present disclosure includes silk protein fragments having an average weight average molecular weight ranging from 180 to 185 kDa. In an embodiment, a composition of the present disclosure includes silk protein fragments having an average weight average molecular weight ranging from 185 to 190 kDa. In an embodiment, a composition of the present disclosure includes silk protein fragments having an average weight average molecular weight ranging from 190 to 195 kDa. In an embodiment, a composition of the present disclosure includes silk protein fragments having an average weight average molecular weight ranging from 195 to 200 kDa. In an embodiment, a composition of the present disclosure includes silk protein fragments having an average weight average molecular weight ranging from 200 to 205 kDa. In an embodiment, a composition of the present disclosure includes silk protein fragments having an average weight average molecular weight ranging from 205 to 210 kDa. In an embodiment, a composition of the present disclosure includes silk protein fragments having an average weight average molecular weight ranging from 210 to 215 kDa. In an embodiment, a composition of the present disclosure includes silk protein fragments having an average weight average molecular weight ranging from 215 to 220 kDa. In an embodiment, a composition of the present disclosure includes silk protein fragments having an average weight average molecular weight ranging from 220 to 225 kDa. In an embodiment, a composition of the present disclosure includes silk protein fragments having an average weight average molecular weight ranging from 225 to 230 kDa. In an embodiment, a composition of the present disclosure includes silk protein fragments having an average weight average molecular weight ranging from 230 to 235 kDa. In an embodiment, a composition of the present disclosure includes silk protein fragments having an average weight average molecular weight ranging from 235 to 240 kDa. In an embodiment, a composition of the present disclosure includes silk protein fragments having an average weight average molecular weight ranging from 240 to 245 kDa. In an embodiment, a composition of the present disclosure includes silk protein fragments having an average weight average molecular weight ranging from 245 to 250 kDa. In an embodiment, a composition of the present disclosure includes silk protein fragments having an average weight average molecular weight ranging from 250 to 255 kDa. In an embodiment, a composition of the present disclosure includes silk protein fragments having an average weight average molecular weight ranging from 255 to 260 kDa. In an embodiment, a composition of the present disclosure includes silk protein fragments having an average weight average molecular weight ranging from 260 to 265 kDa. In an embodiment, a composition of the present disclosure includes silk protein fragments having an average weight average molecular weight ranging from 265 to 270 kDa. In an embodiment, a composition of the present disclosure includes silk protein fragments having an average weight average molecular weight ranging from 270 to 275 kDa. In an embodiment, a composition of the present disclosure includes silk protein fragments having an average weight average molecular weight ranging from 275 to 280 kDa. In an embodiment, a composition of the present disclosure includes silk protein fragments having an average weight average molecular weight ranging from 280 to 285 kDa. In an embodiment, a composition of the present disclosure includes silk protein fragments having an average weight average molecular weight ranging from 285 to 290 kDa. In an embodiment, a composition of the present disclosure includes silk protein fragments having an average weight average molecular weight ranging from 290 to 295 kDa. In an embodiment, a composition of the present disclosure includes silk protein fragments having an average weight average molecular weight ranging from 295 to 300 kDa. In an embodiment, a composition of the present disclosure includes silk protein fragments having an average weight average molecular weight ranging from 300 to 305 kDa. In an embodiment, a composition of the present disclosure includes silk protein fragments having an average weight average molecular weight ranging from 305 to 310 kDa. In an embodiment, a composition of the present disclosure includes silk protein fragments having an average weight average molecular weight ranging from 310 to 315 kDa. In an embodiment, a composition of the present disclosure includes silk protein fragments having an average weight average molecular weight ranging from 315 to 320 kDa. In an embodiment, a composition of the present disclosure includes silk protein fragments having an average weight average molecular weight ranging from 320 to 325 kDa. In an embodiment, a composition of the present disclosure includes silk protein fragments having an average weight average molecular weight ranging from 325 to 330 kDa. In an embodiment, a composition of the present disclosure includes silk protein fragments having an average weight average molecular weight ranging from 330 to 335 kDa. In an embodiment, a composition of the present disclosure includes silk protein fragments having an average weight average molecular weight ranging from 35 to 340 kDa. In an embodiment, a composition of the present disclosure includes silk protein fragments having an average weight average molecular weight ranging from 340 to 345 kDa. In an embodiment, a composition of the present disclosure includes silk protein fragments having an average weight average molecular weight ranging from 345 to 350 kDa.

In an embodiment, a composition of the present disclosure includes silk protein fragments having an average weight average molecular weight of about 5 kDa. In an embodiment, a composition of the present disclosure includes silk protein fragments having an average weight average molecular weight of about 6 kDa. In an embodiment, a composition of the present disclosure includes silk protein fragments having an average weight average molecular weight of about 7 kDa. In an embodiment, a composition of the present disclosure includes silk protein fragments having an average weight average molecular weight of about 8 kDa. In an embodiment, a composition of the present disclosure includes silk protein fragments having an average weight average molecular weight of about 9 kDa. In an embodiment, a composition of the present disclosure includes silk protein fragments having an average weight average molecular weight of about 10 kDa.

In an embodiment, a composition of the present disclosure includes silk protein fragments having an average weight average molecular weight of about 11 kDa. In an embodiment, a composition of the present disclosure includes silk protein fragments having an average weight average molecular weight of about 12 kDa. In an embodiment, a composition of the present disclosure includes silk protein fragments having an average weight average molecular weight of about 13 kDa. In an embodiment, a composition of the present disclosure includes silk protein fragments having an average weight average molecular weight of about 14 kDa. In an embodiment, a composition of the present disclosure includes silk protein fragments having an average weight average molecular weight of about 15 kDa. In an embodiment, a composition of the present disclosure includes silk protein fragments having an average weight average molecular weight of about 16 kDa. In an embodiment, a composition of the present disclosure includes silk protein fragments having an average weight average molecular weight of about 17 kDa. In an embodiment, a composition of the present disclosure includes silk protein fragments having an average weight average molecular weight of about 18 kDa. In an embodiment, a composition of the present disclosure includes silk protein fragments having an average weight average molecular weight of about 19 kDa. In an embodiment, a composition of the present disclosure includes silk protein fragments having an average weight average molecular weight of about 20 kDa.

In an embodiment, a composition of the present disclosure includes silk protein fragments having an average weight average molecular weight of about 21 kDa. In an embodiment, a composition of the present disclosure includes silk protein fragments having an average weight average molecular weight of about 22 kDa. In an embodiment, a composition of the present disclosure includes silk protein fragments having an average weight average molecular weight of about 23 kDa. In an embodiment, a composition of the present disclosure includes silk protein fragments having an average weight average molecular weight of about 24 kDa. In an embodiment, a composition of the present disclosure includes silk protein fragments having an average weight average molecular weight of about 25 kDa. In an embodiment, a composition of the present disclosure includes silk protein fragments having an average weight average molecular weight of about 26 kDa. In an embodiment, a composition of the present disclosure includes silk protein fragments having an average weight average molecular weight of about 27 kDa. In an embodiment, a composition of the present disclosure includes silk protein fragments having an average weight average molecular weight of about 28 kDa. In an embodiment, a composition of the present disclosure includes silk protein fragments having an average weight average molecular weight of about 29 kDa. In an embodiment, a composition of the present disclosure includes silk protein fragments having an average weight average molecular weight of about 30 kDa.

In an embodiment, a composition of the present disclosure includes silk protein fragments having an average weight average molecular weight of about 31 kDa. In an embodiment, a composition of the present disclosure includes silk protein fragments having an average weight average molecular weight of about 32 kDa. In an embodiment, a composition of the present disclosure includes silk protein fragments having an average weight average molecular weight of about 33 kDa. In an embodiment, a composition of the present disclosure includes silk protein fragments having an average weight average molecular weight of about 34 kDa. In an embodiment, a composition of the present disclosure includes silk protein fragments having an average weight average molecular weight of about 35 kDa. In an embodiment, a composition of the present disclosure includes silk protein fragments having an average weight average molecular weight of about 36 kDa. In an embodiment, a composition of the present disclosure includes silk protein fragments having an average weight average molecular weight of about 37 kDa. In an embodiment, a composition of the present disclosure includes silk protein fragments having an average weight average molecular weight of about 38 kDa. In an embodiment, a composition of the present disclosure includes silk protein fragments having an average weight average molecular weight of about 39 kDa. In an embodiment, a composition of the present disclosure includes silk protein fragments having an average weight average molecular weight of about 40 kDa.

In an embodiment, a composition of the present disclosure includes silk protein fragments having an average weight average molecular weight of about 41 kDa. In an embodiment, a composition of the present disclosure includes silk protein fragments having an average weight average molecular weight of about 42 kDa. In an embodiment, a composition of the present disclosure includes silk protein fragments having an average weight average molecular weight of about 43 kDa. In an embodiment, a composition of the present disclosure includes silk protein fragments having an average weight average molecular weight of about 44 kDa. In an embodiment, a composition of the present disclosure includes silk protein fragments having an average weight average molecular weight of about 45 kDa. In an embodiment, a composition of the present disclosure includes silk protein fragments having an average weight average molecular weight of about 46 kDa. In an embodiment, a composition of the present disclosure includes silk protein fragments having an average weight average molecular weight of about 47 kDa. In an embodiment, a composition of the present disclosure includes silk protein fragments having an average weight average molecular weight of about 48 kDa. In an embodiment, a composition of the present disclosure includes silk protein fragments having an average weight average molecular weight of about 49 kDa. In an embodiment, a composition of the present disclosure includes silk protein fragments having an average weight average molecular weight of about 50 kDa.

In an embodiment, a composition of the present disclosure includes silk protein fragments having an average weight average molecular weight of about 51 kDa. In an embodiment, a composition of the present disclosure includes silk protein fragments having an average weight average molecular weight of about 52 kDa. In an embodiment, a composition of the present disclosure includes silk protein fragments having an average weight average molecular weight of about 53 kDa. In an embodiment, a composition of the present disclosure includes silk protein fragments having an average weight average molecular weight of about 54 kDa. In an embodiment, a composition of the present disclosure includes silk protein fragments having an average weight average molecular weight of about 55 kDa. In an embodiment, a composition of the present disclosure includes silk protein fragments having an average weight average molecular weight of about 56 kDa. In an embodiment, a composition of the present disclosure includes silk protein fragments having an average weight average molecular weight of about 57 kDa. In an embodiment, a composition of the present disclosure includes silk protein fragments having an average weight average molecular weight of about 58 kDa. In an embodiment, a composition of the present disclosure includes silk protein fragments having an average weight average molecular weight of about 59 kDa. In an embodiment, a composition of the present disclosure includes silk protein fragments having an average weight average molecular weight of about 60 kDa.

In an embodiment, a composition of the present disclosure includes silk protein fragments having an average weight average molecular weight of about 61 kDa. In an embodiment, a composition of the present disclosure includes silk protein fragments having an average weight average molecular weight of about 62 kDa. In an embodiment, a composition of the present disclosure includes silk protein fragments having an average weight average molecular weight of about 63 kDa. In an embodiment, a composition of the present disclosure includes silk protein fragments having an average weight average molecular weight of about 64 kDa. In an embodiment, a composition of the present disclosure includes silk protein fragments having an average weight average molecular weight of about 65 kDa. In an embodiment, a composition of the present disclosure includes silk protein fragments having an average weight average molecular weight of about 66 kDa. In an embodiment, a composition of the present disclosure includes silk protein fragments having an average weight average molecular weight of about 67 kDa. In an embodiment, a composition of the present disclosure includes silk protein fragments having an average weight average molecular weight of about 68 kDa. In an embodiment, a composition of the present disclosure includes silk protein fragments having an average weight average molecular weight of about 69 kDa. In an embodiment, a composition of the present disclosure includes silk protein fragments having an average weight average molecular weight of about 70 kDa.

In an embodiment, a composition of the present disclosure includes silk protein fragments having an average weight average molecular weight of about 71 kDa. In an embodiment, a composition of the present disclosure includes silk protein fragments having an average weight average molecular weight of about 72 kDa. In an embodiment, a composition of the present disclosure includes silk protein fragments having an average weight average molecular weight of about 73 kDa. In an embodiment, a composition of the present disclosure includes silk protein fragments having an average weight average molecular weight of about 74 kDa. In an embodiment, a composition of the present disclosure includes silk protein fragments having an average weight average molecular weight of about 75 kDa. In an embodiment, a composition of the present disclosure includes silk protein fragments having an average weight average molecular weight of about 76 kDa. In an embodiment, a composition of the present disclosure includes silk protein fragments having an average weight average molecular weight of about 77 kDa. In an embodiment, a composition of the present disclosure includes silk protein fragments having an average weight average molecular weight of about 78 kDa. In an embodiment, a composition of the present disclosure includes silk protein fragments having an average weight average molecular weight of about 79 kDa. In an embodiment, a composition of the present disclosure includes silk protein fragments having an average weight average molecular weight of about 80 kDa.

In an embodiment, a composition of the present disclosure includes silk protein fragments having an average weight average molecular weight of about 81 kDa. In an embodiment, a composition of the present disclosure includes silk protein fragments having an average weight average molecular weight of about 82 kDa. In an embodiment, a composition of the present disclosure includes silk protein fragments having an average weight average molecular weight of about 83 kDa. In an embodiment, a composition of the present disclosure includes silk protein fragments having an average weight average molecular weight of about 84 kDa. In an embodiment, a composition of the present disclosure includes silk protein fragments having an average weight average molecular weight of about 85 kDa. In an embodiment, a composition of the present disclosure includes silk protein fragments having an average weight average molecular weight of about 86 kDa. In an embodiment, a composition of the present disclosure includes silk protein fragments having an average weight average molecular weight of about 87 kDa. In an embodiment, a composition of the present disclosure includes silk protein fragments having an average weight average molecular weight of about 88 kDa. In an embodiment, a composition of the present disclosure includes silk protein fragments having an average weight average molecular weight of about 89 kDa. In an embodiment, a composition of the present disclosure includes silk protein fragments having an average weight average molecular weight of about 90 kDa.

In an embodiment, a composition of the present disclosure includes silk protein fragments having an average weight average molecular weight of about 91 kDa. In an embodiment, a composition of the present disclosure includes silk protein fragments having an average weight average molecular weight of about 92 kDa. In an embodiment, a composition of the present disclosure includes silk protein fragments having an average weight average molecular weight of about 93 kDa. In an embodiment, a composition of the present disclosure includes silk protein fragments having an average weight average molecular weight of about 94 kDa. In an embodiment, a composition of the present disclosure includes silk protein fragments having an average weight average molecular weight of about 95 kDa. In an embodiment, a composition of the present disclosure includes silk protein fragments having an average weight average molecular weight of about 96 kDa. In an embodiment, a composition of the present disclosure includes silk protein fragments having an average weight average molecular weight of about 97 kDa. In an embodiment, a composition of the present disclosure includes silk protein fragments having an average weight average molecular weight of about 98 kDa. In an embodiment, a composition of the present disclosure includes silk protein fragments having an average weight average molecular weight of about 99 kDa. In an embodiment, a composition of the present disclosure includes silk protein fragments having an average weight average molecular weight of about 100 kDa.

In an embodiment, a composition of the present disclosure includes silk protein fragments having an average weight average molecular weight of about 101 kDa. In an embodiment, a composition of the present disclosure includes silk protein fragments having an average weight average molecular weight of about 102 kDa. In an embodiment, a composition of the present disclosure includes silk protein fragments having an average weight average molecular weight of about 103 kDa. In an embodiment, a composition of the present disclosure includes silk protein fragments having an average weight average molecular weight of about 104 kDa. In an embodiment, a composition of the present disclosure includes silk protein fragments having an average weight average molecular weight of about 105 kDa. In an embodiment, a composition of the present disclosure includes silk protein fragments having an average weight average molecular weight of about 106 kDa. In an embodiment, a composition of the present disclosure includes silk protein fragments having an average weight average molecular weight of about 107 kDa. In an embodiment, a composition of the present disclosure includes silk protein fragments having an average weight average molecular weight of about 108 kDa. In an embodiment, a composition of the present disclosure includes silk protein fragments having an average weight average molecular weight of about 109 kDa. In an embodiment, a composition of the present disclosure includes silk protein fragments having an average weight average molecular weight of about 110 kDa.

In an embodiment, a composition of the present disclosure includes silk protein fragments having an average weight average molecular weight of about 111 kDa. In an embodiment, a composition of the present disclosure includes silk protein fragments having an average weight average molecular weight of about 112 kDa. In an embodiment, a composition of the present disclosure includes silk protein fragments having an average weight average molecular weight of about 113 kDa. In an embodiment, a composition of the present disclosure includes silk protein fragments having an average weight average molecular weight of about 114 kDa. In an embodiment, a composition of the present disclosure includes silk protein fragments having an average weight average molecular weight of about 115 kDa. In an embodiment, a composition of the present disclosure includes silk protein fragments having an average weight average molecular weight of about 116 kDa. In an embodiment, a composition of the present disclosure includes silk protein fragments having an average weight average molecular weight of about 117 kDa. In an embodiment, a composition of the present disclosure includes silk protein fragments having an average weight average molecular weight of about 118 kDa. In an embodiment, a composition of the present disclosure includes silk protein fragments having an average weight average molecular weight of about 119 kDa. In an embodiment, a composition of the present disclosure includes silk protein fragments having an average weight average molecular weight of about 120 kDa.

In an embodiment, a composition of the present disclosure includes silk protein fragments having an average weight average molecular weight of about 121 kDa. In an embodiment, a composition of the present disclosure includes silk protein fragments having an average weight average molecular weight of about 122 kDa. In an embodiment, a composition of the present disclosure includes silk protein fragments having an average weight average molecular weight of about 123 kDa. In an embodiment, a composition of the present disclosure includes silk protein fragments having an average weight average molecular weight of about 124 kDa. In an embodiment, a composition of the present disclosure includes silk protein fragments having an average weight average molecular weight of about 125 kDa. In an embodiment, a composition of the present disclosure includes silk protein fragments having an average weight average molecular weight of about 126 kDa. In an embodiment, a composition of the present disclosure includes silk protein fragments having an average weight average molecular weight of about 127 kDa. In an embodiment, a composition of the present disclosure includes silk protein fragments having an average weight average molecular weight of about 128 kDa. In an embodiment, a composition of the present disclosure includes silk protein fragments having an average weight average molecular weight of about 129 kDa. In an embodiment, a composition of the present disclosure includes silk protein fragments having an average weight average molecular weight of about 130 kDa.

In an embodiment, a composition of the present disclosure includes silk protein fragments having an average weight average molecular weight of about 131 kDa. In an embodiment, a composition of the present disclosure includes silk protein fragments having an average weight average molecular weight of about 132 kDa. In an embodiment, a composition of the present disclosure includes silk protein fragments having an average weight average molecular weight of about 133 kDa. In an embodiment, a composition of the present disclosure includes silk protein fragments having an average weight average molecular weight of about 134 kDa. In an embodiment, a composition of the present disclosure includes silk protein fragments having an average weight average molecular weight of about 135 kDa. In an embodiment, a composition of the present disclosure includes silk protein fragments having an average weight average molecular weight of about 136 kDa. In an embodiment, a composition of the present disclosure includes silk protein fragments having an average weight average molecular weight of about 137 kDa. In an embodiment, a composition of the present disclosure includes silk protein fragments having an average weight average molecular weight of about 138 kDa. In an embodiment, a composition of the present disclosure includes silk protein fragments having an average weight average molecular weight of about 139 kDa. In an embodiment, a composition of the present disclosure includes silk protein fragments having an average weight average molecular weight of about 140 kDa.

In an embodiment, a composition of the present disclosure includes silk protein fragments having an average weight average molecular weight of about 141 kDa. In an embodiment, a composition of the present disclosure includes silk protein fragments having an average weight average molecular weight of about 142 kDa. In an embodiment, a composition of the present disclosure includes silk protein fragments having an average weight average molecular weight of about 143 kDa. In an embodiment, a composition of the present disclosure includes silk protein fragments having an average weight average molecular weight of about 144 kDa.

In an embodiment, a composition of the present disclosure includes silk fibroin-based protein fragments having one or more of low molecular weight, medium molecular weight, and high molecular weight. In an embodiment, a composition of the present disclosure includes silk fibroin-based protein fragments having low molecular weight and silk fibroin-based protein fragments having medium molecular weight. In an embodiment, a composition of the present disclosure includes silk fibroin-based protein fragments having low molecular weight and silk fibroin-based protein fragments having high molecular weight. In an embodiment, a composition of the present disclosure includes silk fibroin-based protein fragments having medium molecular weight and silk fibroin-based protein fragments having high molecular weight. In an embodiment, a composition of the present disclosure includes silk fibroin-based protein fragments having low molecular weight, silk fibroin-based protein fragments having medium molecular weight, and silk fibroin-based protein fragments having high molecular weight.

In an embodiment, a composition of the present disclosure includes silk fibroin-based protein fragments having low molecular weight and silk fibroin-based protein fragments having medium molecular weight. In some embodiments, the w/w ratio between low molecular weight silk fibroin-based protein fragments and medium molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk fibroin-based protein fragments and medium molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk fibroin-based protein fragments and medium molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having low molecular weight and silk fibroin-based protein fragments having high molecular weight. In some embodiments, the w/w ratio between low molecular weight silk fibroin-based protein fragments and high molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between low molecular weight silk fibroin-based protein fragments and high molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between low molecular weight silk fibroin-based protein fragments and high molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having medium molecular weight and silk fibroin-based protein fragments having high molecular weight. In some embodiments, the w/w ratio between medium molecular weight silk fibroin-based protein fragments and high molecular weight silk fibroin-based protein fragments is between about 99:1 to about 1:99, between about 95:5 to about 5:95, between about 90:10 to about 10:90, between about 75:25 to about 25:75, between about 65:35 to about 35:65, or between about 55:45 to about 45:55. In some embodiments, the w/w ratio between medium molecular weight silk fibroin-based protein fragments and high molecular weight silk fibroin-based protein fragments is between about 99:1 to about 55:45, between about 95:5 to about 45:55, between about 90:10 to about 35:65, between about 75:25 to about 15:85, between about 65:35 to about 10:90, or between about 55:45 to about 1:99. In an embodiment, the w/w ratio between medium molecular weight silk fibroin-based protein fragments and high molecular weight silk fibroin-based protein fragments is about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99.

In an embodiment, a composition of the present disclosure includes silk fibroin-based protein fragments having low molecular weight, silk fibroin-based protein fragments having medium molecular weight, and silk fibroin-based protein fragments having high molecular weight. In an embodiment, the w/w ratio between low molecular weight silk fibroin-based protein fragments, medium molecular weight silk fibroin-based protein fragments, and high molecular weight silk fibroin-based protein fragments is about 1:1:8, about 1:2:7, about 1:3:6, about 1:4:5, about 1:5:4, about 1:6:3, about 1:7:2, about 1:8:1, about 2:1:7, about 2:2:6, about 2:3:5, about 2:4:4, about 2:5:3, about 2:6:2, about 2:7:1, about 3:1:6, about 3:2:5, about 3:3:4, about 3:4:3, about 3:5:2, about 3:6:1, about 4:1:5, about 4:2:4, about 4:3:3, about 4:4:2, about 4:5:1, about 5:1:4, about 5:2:3, about 5:3:2, about 5:4:1, about 6:1:3, about 6:2:2, about 6:3:1, about 7:1:2, about 7:2:1, or about 8:1:1.

In some embodiments, the silk compositions provided herein may be applied as mixtures to an article to be processed or in stepwise processes to the article. For example, a silk composition that includes low molecular weight silk and medium molecular weight silk may be applied to an article to be processed. Alternatively, a low molecular weight silk composition may be applied to an article to be processed, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, the silk compositions provided herein may be applied as mixtures to an article to be coated or in stepwise processes to form coating layers on the article. For example, a silk composition that includes low molecular weight silk and medium molecular weight silk may be applied to an article to be coated. Alternatively, a low molecular weight silk composition may be applied to an article to be coated, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, the silk compositions provided herein may be applied as mixtures to an article to be repaired or in stepwise processes to form fillings in or on the article. For example, a silk composition that includes low molecular weight silk and medium molecular weight silk may be applied to an article to be repaired. Alternatively, a low molecular weight silk composition may be applied to an article to be repaired, as provided by the processes described herein, and then a medium or high molecular weight silk may then be applied to the article. The low, medium, and high molecular weight silk compositions may be added in any order or any combination (e.g., low/med, low/high, med/high, low/med/high).

In some embodiments, where multiple layers of silk compositions are applied to an article to be coated, they may have at least one layer, or 1 layer to 1 million layers, or 1 layer to 100,000 layers, or 1 layer to 10,000 layers, or 1 layer to 1,000 layers of such silk compositions, wherein the layers may have the same or different thicknesses. For example, in some embodiments, the layers may have a thickness of from about 1 nm to about 1 mm, or about 1 nm to about 1 μm, or about 1 nm to about 500 nm, or about 1 nm to about 400 nm, or about 1 nm to about 300 nm, or about 1 nm to about 200 nm, or about 1 nm to about 100 nm, or about 1 nm to about 75 nm, or about 1 nm to about 50 nm, or about 1 nm to about 25 nm, or about 1 nm to about 20 nm, or about 1 nm to about 15 nm, or about 1 nm to about 10 nm, or about 1 nm to about 5 nm.

In an embodiment, a composition of the present disclosure having pure silk fibroin-based protein fragments has a polydispersity ranging from about 1 to about 5.0. In an embodiment, a composition of the present disclosure having pure silk fibroin-based protein fragments has a polydispersity ranging from about 1.5 to about 3.0. In an embodiment, a composition of the present disclosure having pure silk fibroin-based protein fragments has a polydispersity ranging from about 1 to about 1.5. In an embodiment, a composition of the present disclosure having pure silk fibroin-based protein fragments has a polydispersity ranging from about 1.5 to about 2.0. In an embodiment, a composition of the present disclosure having pure silk fibroin-based protein fragments has a polydispersity ranging from about 2.0 to about 2.5. In an embodiment, a composition of the present disclosure having pure silk fibroin-based protein fragments, has a polydispersity ranging from about is 2.0 to about 3.0. In an embodiment, a composition of the present disclosure having pure silk fibroin-based protein fragments, has a polydispersity ranging from about is 2.5 to about 3.0.

In an embodiment, a composition of the present disclosure having silk protein fragments has a polydispersity ranging from about 1 to about 5.0. In an embodiment, a composition of the present disclosure having silk protein fragments has a polydispersity ranging from about 1.5 to about 3.0. In an embodiment, a composition of the present disclosure having silk protein fragments has a polydispersity ranging from about 1 to about 1.5. In an embodiment, a composition of the present disclosure having silk protein fragments has a polydispersity ranging from about 1.5 to about 2.0. In an embodiment, a composition of the present disclosure having silk protein fragments has a polydispersity ranging from about 2.0 to about 2.5. In an embodiment, a composition of the present disclosure having silk protein fragments, has a polydispersity ranging from about is 2.0 to about 3.0. In an embodiment, a composition of the present disclosure having silk protein fragments, has a polydispersity ranging from about is 2.5 to about 3.0.

In some embodiments the polydispersity of low molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments the polydispersity of medium molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments the polydispersity of high molecular weight silk protein fragments may be about 1 to about 5.0, or about 1.5 to about 3.0, or about 1 to about 1.5, or about 1.5 to about 2.0, or about 2.0 to about 2.5, or about 2.5 to about 3.0.

In some embodiments, in compositions described herein having combinations of low, medium, and/or high molecular weight silk protein fragments, such low, medium, and/or high molecular weight silk proteins may have the same or different polydispersities.

### Compositions and Processes Including Silk Fibroin-Based Processing Compositions, Coatings, or Fillings

In an embodiment, the invention may include leather or leather articles that may be processed, coated, or repaired with an SPF mixture solution (i.e., silk fibroin solution (SFS)), and/or composition, as described herein to produce a processed, coated, or repaired article. In an embodiment, the processed, coated, or repaired articles described herein may be treated with additional chemical agents that may enhance the properties of the coated article. In an embodiment, the SFS may enhance the properties of the coated or repaired article, or the SFS may include one or more chemical agents that may enhance the properties of the coated or repaired article.

In some embodiments, chemical finishes may be applied to leather or leather articles before or after such leather or leather articles are processed, coated, or repaired with SFS. In an embodiment, chemical finishing may be intended as the application of chemical agents and/or SFS to leather or leather articles to modify the original leather's or leather articles' properties and achieve properties in the leather or leather articles that would be otherwise absent. With chemical finishes, leather or leather articles treated with such chemical finishes may act as surface treatments and/or the treatments may modify the elemental analysis of treated leather or leather article base polymers.

In an embodiment, a type of chemical finishing may include the application of certain silk-fibroin based solutions to leather or leather articles. For example, SFS may be applied to a leather or leather article after it is dyed, but there are also scenarios that may require the application of SFS during processing, during dyeing, or after a garment is assembled from a selected leather or leather article. In some embodiments, after its application, SFS may be dried with the use of heat. In some embodiments, SFS may then be fixed to the surface of the leather or leather article in a processing step called curing.

In some embodiments, SFS may be supplied in a concentrated form suspended in water. In some embodiments, SFS may have a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 5%, or less than about 4%, or less than about 3%, or less than about 2%, or less than about 1%, or less than about 0.1%, or less than about 0.01%, or less than about 0.001%, or less than about 0.0001%, or less than about 0.00001%. In some embodiments, SFS may have a concentration by weight (% w/w or % w/v) or by volume (v/v) of greater than about 50%, or greater than about 45%, or greater than about 40%, or greater than about 35%, or greater than about 30%, or greater than about 25%, or greater than about 20%, or greater than about 15%, or greater than about 10%, or greater than about 5%, or greater than about 4%, or greater than about 3%, or greater than about 2%, or greater than about 1%, or greater than about 0.1%, or greater than about 0.01%, or greater than about 0.001%, or greater than about 0.0001%, or greater than about 0.00001%.

In some embodiments, the solution concentration and the wet pick of the material determines the amount of silk fibroin solution (SFS), which may include silk-based proteins or fragments thereof, that may be fixed or otherwise adhered to the leather or leather article being coated. The wet pick up may be expressed by the following formula:

$$wet pick up ( \% ) = \frac{weight of SFS applied \times 100}{weight of dry textile material} .$$

The total amount of SFS added to the leather or leather article may be expressed by the following formula:

$$SFS added ( \% ) = \frac{weight of dry SFS coated material \times 100}{weight of dry material before coating} .$$

Regarding methods for applying SFS to leather or leather articles more broadly, SFS may be applied to leather or leather articles through a pad or roller application on process, a saturation and removal process, and/or a topical application process. Moreover, the methods of silk application (i.e., SFS application or coating) may include bath coating, kiss rolling, spray coating, and/or two-sided rolling. In some embodiments, the coating processes (e.g., bath coating, kiss rolling, spray coating, two-sided rolling, roller application, saturation and removal application, and/or topical application), drying processes, and curing processes may be varied as described herein to modify one or more selected leather or leather article properties of the resulting coated leather or leather article wherein such properties.

In an embodiment, the drying and/or curing temperature for the processes of the invention may be less than about 70° C., or less than about 75° C., or less than about 80° C., or less than about 85° C., or less than about 90° C., or less than about 95° C., or less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C., or less than about 230° C.

In an embodiment, the drying and/or curing temperature for the processes of the invention may be greater than about 70° C., or greater than about 75° C., or greater than about 80° C., or greater than about 85° C., or greater than about 90° C., or greater than about 95° C., or greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C., or greater than about 230° C.

In an embodiment, the drying time for the processes of the invention may be less than about 10 seconds, or less than about 20 seconds, or less than about 30 seconds, or less than about 40 seconds, or less than about 50 seconds, or less than about 60 seconds, or less than about 2 minutes, or less than about, 3 minutes, or less than about 4 minutes, or less than about 5 minutes, or less than about 6 minutes, or less than about 7 minutes, or less than about 8 minutes, or less than about 9 minutes, or less than about 10 minutes, or less than about 20 minutes, or less than about 30 minutes, or less than about 40 minutes, or less than about 50 minutes, or less than about 60 minutes.

In an embodiment, the drying time for the processes of the invention may be greater than about 10 seconds, or greater than about 20 seconds, or greater than about 30 seconds, or greater than about 40 seconds, or greater than about 50 seconds, or greater than about 60 seconds, or greater than about 2 minutes, or greater than about, 3 minutes, or greater than about 4 minutes, or greater than about 5 minutes, or greater than about 6 minutes, or greater than about 7 minutes, or greater than about 8 minutes, or greater than about 9 minutes, or greater than about 10 minutes, or greater than about 20 minutes, or greater than about 30 minutes, or greater than about 40 minutes, or greater than about 50 minutes, or greater than about 60 minutes.

In an embodiment, the curing time for the processes of the invention may be less than about 1 second, or less than about 2 seconds, or less than about 3 seconds, or less than about 4 seconds, or less than about 5 seconds, or less than about 6 seconds, or less than about 7 seconds, or less than about 8 seconds, or less than about 9 seconds, or less than about 10 seconds, or less than about 20 seconds, or less than about 30 seconds, or less than about 40 seconds, or less than about 50 seconds, or less than about 60 seconds, or less than about 2 minutes, or less than about 3 minutes, or less than about 4 minutes, or less than about 5 minutes, or less than about 6 minutes, or less than about 7 minutes, or less than about 8 minutes, or less than about 9 minutes, or less than about 10 minutes, or less than about 20 minutes, or less than about 30 minutes, or less than about 40 minutes, or less than about 50 minutes, or less than about 60 minutes.

In an embodiment, the curing time for the processes of the invention may be greater than about 1 second, or greater than about 2 seconds, or greater than about 3 seconds, or greater than about 4 seconds, or greater than about 5 seconds, or greater than about 6 seconds, or greater than about 7 seconds, or greater than about 8 seconds, or greater than about 9 seconds, or greater than about 10 seconds, or greater than about 20 seconds, or greater than about 30 seconds, or greater than about 40 seconds, or greater than about 50 seconds, or greater than about 60 seconds, or greater than about 2 minutes, or greater than about 3 minutes, or greater than about 4 minutes, or greater than about 5 minutes, or greater than about 6 minutes, or greater than about 7 minutes, or greater than about 8 minutes, or greater than about 9 minutes, or greater than about 10 minutes, or greater than about 20 minutes, or greater than about 30 minutes, or greater than about 40 minutes, or greater than about 50 minutes, or greater than about 60 minutes.

In some embodiments, a silk fibroin processed or coated material may be heat resistant to a selected temperature where the selected temperature is chosen for drying, curing, and/or heat setting a dye that may be applied to the material (e.g., a coated leather or leather article). As used herein, a “heat resistant” may refer to a property of the silk fibroin coating deposited on the material where the silk fibroin coating and/or silk fibroin protein does not exhibit a substantial modification (i.e., “substantially modifying”) in silk fibroin coating performance as compared to a control material having a comparable silk fibroin coating that was not subjected to the selected temperature for drying, curing, wash cycling, and/or heat setting purposes. In some embodiments, the selected temperature is the glass transition temperature (Tg) for the material upon which the silk fibroin coating is applied. In some embodiments, the selected temperature is greater than about 65° C., or greater than about 70° C., or greater than about 80° C., or greater than about 90° C., or greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C. In some embodiments, the selected temperature is less than about 65° C., or less than about 70° C., or less than about 80° C., or less than about 90° C., or less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C.

In some embodiments, the SFS processed, coated, or repaired article may be subjected to heat setting in order to set one or more dyes that may be applied to the SFS coated article in order to permanently set the one or more dyes on the SFS coated or repaired article. In some embodiments, the SFS processed, coated, or repaired article may be heat setting resistant, wherein the SFS coating on the SFS coated article may resist a heat setting temperature of greater than about 100° C., or greater than about 110° C., or greater than about 120° C., or greater than about 130° C., or greater than about 140° C., or greater than about 150° C., or greater than about 160° C., or greater than about 170° C., or greater than about 180° C., or greater than about 190° C., or greater than about 200° C., or greater than about 210° C., or greater than about 220° C. In some embodiments, the selected temperature is less than about 100° C., or less than about 110° C., or less than about 120° C., or less than about 130° C., or less than about 140° C., or less than about 150° C., or less than about 160° C., or less than about 170° C., or less than about 180° C., or less than about 190° C., or less than about 200° C., or less than about 210° C., or less than about 220° C.

In an embodiment, a material processed, coated, or repaired by the silk fibroin coating or filling composition as described herein may partially dissolved or otherwise partially incorporated within a portion of the material after the silk fibroin coated or repaired material is subjected to heating and/or curing as described herein. Without being limited to any one theory of the invention, where the silk fibroin processed, coated, or repaired material is heated to greater than about the glass transition temperature (Tg) for the material that is processed, coated, or repaired, the silk fibroin coating may become partially dissolved or otherwise partially incorporated within a portion of the material.

In some embodiments, a material processed, coated, or repaired by the silk fibroin coating as described herein may be sterile or may be sterilized to provide a sterilized silk fibroin coated material. Alternatively, or in addition thereto, the methods described herein may include a sterile SFS prepared from sterile silk fibroin.

In some embodiments, SFS may be used in an SFS processing composition, coating, or repairing composition, where such composition or coating includes one or more chemical agents (e.g., a silicone). SFS may be provided in such an SFS coating at a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, or less than about 1%, or less than about 0.9%, or less than about 0.8%, or less than about 0.7%, or less than about 0.6%, or less than about 0.5%, or less than about 0.4%, or less than about 0.3%, or less than about 0.2%, or less than about 0.1%, or less than about 0.01%, or less than about 0.001%. In some embodiments, SFS may be provided in such an SFS coating at a concentration by weight (% w/w or % w/v) or by volume (v/v) of greater than about 25%, or greater than about 20%, or greater than about 15%, or greater than about 10%, or greater than about 9%, or greater than about 8%, or greater than about 7%, or greater than about 6%, or greater than about 5%, or greater than about 4%, or greater than about 3%, or greater than about 2%, or greater than about 1%, or greater than about 0.9%, or greater than about 0.8%, or greater than about 0.7%, or greater than about 0.6%, or greater than about 0.5%, or greater than about 0.4%, or greater than about 0.3%, or greater than about 0.2%, or greater than about 0.1%, or greater than about 0.01%, or greater than about 0.001%.

In some embodiments, chemical fabric softeners may include silicones as described herein.

In some embodiments, the chemical agents may include the following, which are supplied by CHT Bezema and are associated with certain selected leather's or leather article's properties, which may be used to strengthen SFS binding on coated or repaired surfaces and/or SFS may be used for enhancing the following chemical agents' properties:

ALPAPRINT CLEAR
Silicone printing and coating
Component B is mentioned in the technical leaflet
Dry handle
Good rubbing fastness
Good washfastness

ALPAPRINT ELASTIC ADD
Silicone printing and coating
Component B is mentioned in the technical leaflet
Good rubbing fastness
Good washfastness
Suited for yardage printing

ALPAPRINT WHITE
Silicone printing and coating
Component B is mentioned in the technical leaflet
Dry handle
Good rubbing fastness
Good washfastness

ALPATEC 30142 A
Textile finishing
Coating
Silicone printing and coating
Component B is mentioned in the technical leaflet
Suitable for narrow ribbon coating
Good rubbing fastness
Good washfastness

ALPATEC 30143 A
Silicone printing and coating
Component B is mentioned in the technical leaflet
Good rubbing fastness
Good washfastness
Suited for yardage printing

ALPATEC 30191 A
Silicone printing and coating
Component B is mentioned in the technical leaflet
Suitable for narrow ribbon coating
High transparency
Coating

ALPATEC 30203 A
Silicone printing and coating
Component B is mentioned in the technical leaflet
Suitable for narrow ribbon coating
High transparency
Coating

ALPATEC 3040 LSR KOMP. A
Functional coatings, Silicone printing and coating
Component B is mentioned in the technical leaflet
High abrasion resistance
High transparency
Coating

ALPATEC 3060 LSR KOMP. A
Functional coatings, Silicone printing and coating
Component B is mentioned in the technical leaflet
High abrasion resistance
High transparency
Coating

ALPATEC 530
Silicone printing and coating
Suitable for narrow ribbon coating
High transparency
Coating
One component system

ALPATEC 540
Silicone printing and coating
Suitable for narrow ribbon coating
High transparency
Coating
One component system

ALPATEC 545
Silicone printing and coating
Suitable for narrow ribbon coating
High transparency
Coating
One component system

ALPATEC 550
Silicone printing and coating
Suitable for narrow ribbon coating
High transparency
Coating
One component system

ALPATEC 730
Silicone printing and coating
Suitable for narrow ribbon coating
Good washfastness
High abrasion resistance
High transparency

ALPATEC 740
Silicone printing and coating
Suitable for narrow ribbon coating
Good washfastness
High abrasion resistance
High transparency

ALPATEC 745
Silicone printing and coating
Suitable for narrow ribbon coating
Good washfastness
High abrasion resistance
High transparency

ALPATEC 750
Silicone printing and coating
Suitable for narrow ribbon coating
Good washfastness
High abrasion resistance
High transparency

ALPATEC Bandage A
Silicone printing and coating
Component B is mentioned in the technical leaflet
Suitable for narrow ribbon coating
Coating
Two component system

APYROL BASE2 E
Flame retardants
Liquid
Soft handle
For BS 5852/1+2
Suited for paste coating

APYROL FCR-2
Water repellency/oil repellency
Cationic
High effectiveness
Water-based
Liquid

APYROL FFD E
Flame retardants
Liquid
Suited for polyester
Suited for polyamide
Flame inhibiting filler

APYROL FR CONC E
Flame retardants, Functional coatings
Liquid
Suited for polyester
Suited for polyamide
Flame inhibiting filler

APYROL GBO-E
Flame retardants, Functional coatings
Suited for polyester
Black-out coating
For DIN 4102/B1
Containing halogen

APYROL LV 21
Flame retardants, Functional coatings
For DIN 4102/B1
Suited for paste coating
Suited for backcoating of black-out vertical blinds and roller blinds
Containing halogen

APYROL PP 31
Flame retardants
Liquid
Free from antimony
Flame inhibiting filler
For BS 5852/1+2

APYROL PP 46
Flame retardants
Powder
Free from antimony
Flame inhibiting filler
Suited for paste coating

APYROL PREM E
Flame retardants
Soft handle
For BS 5852/1+2
Containing halogen
Semi-permanent

APYROL PREM2 E
Flame retardants
Soft handle
For BS 5852/1+2
Containing halogen
Semi-permanent

COLORDUR 005 WHITE
Flock adhesives, Functional coatings, Silicone printing and coating
Based on silicone
Dyestuff pigment suspension

COLORDUR 105 LEMON
Flock adhesives, Functional coatings, Silicone printing and coating
Based on silicone
Dyestuff pigment suspension

COLORDUR 115 GOLDEN YELLOW
Flock adhesives, Functional coatings, Silicone printing and coating
Based on silicone
Dyestuff pigment suspension

COLORDUR 185 ORANGE
Flock adhesives, Functional coatings, Silicone printing and coating
Based on silicone
Dyestuff pigment suspension

COLORDUR 215 RED
Flock adhesives, Functional coatings, Silicone printing and coating
Based on silicone
Dyestuff pigment suspension

COLORDUR 225 DARK RED
Flock adhesives, Functional coatings, Silicone printing and coating
Based on silicone
Dyestuff pigment suspension

COLORDUR 285 VIOLET
Flock adhesives, Functional coatings, Silicone printing and coating
Based on silicone
Dyestuff pigment suspension

COLORDUR 305 BLUE
Flock adhesives, Functional coatings, Silicone printing and coating
Based on silicone
Dyestuff pigment suspension

COLORDUR 355 MARINE
Flock adhesives, Functional coatings, Silicone printing and coating
Based on silicone
Dyestuff pigment suspension

COLORDUR 405 GREEN
Flock adhesives, Functional coatings, Silicone printing and coating
Based on silicone
Dyestuff pigment suspension

COLORDUR 465 OLIVE GREEN
Flock adhesives, Functional coatings, Silicone printing and coating
Based on silicone
Dyestuff pigment suspension

COLORDUR 705 BLACK
Flock adhesives, Functional coatings, Silicone printing and coating
Based on silicone
Dyestuff pigment suspension

COLORDUR AM ADDITIVE
Flock adhesives, Silicone printing and coating
Based on silicone
Migration prevention
Dyestuff pigment suspension

COLORDUR FL 1015 YELLOW
Flock adhesives, Functional coatings, Silicone printing and coating
Based on silicone
Dyestuff pigment suspension

COLORDUR FL 1815 ORANGE
Flock adhesives, Functional coatings, Silicone printing and coating
Based on silicone
Dyestuff pigment suspension

COLORDUR FL 2415 PINK
Flock adhesives, Functional coatings, Silicone printing and coating
Based on silicone
Dyestuff pigment suspension

COLORDUR FL 4015 GREEN
Flock adhesives, Functional coatings, Silicone printing and coating
Based on silicone
Dyestuff pigment suspension

ECOPERL 1
Water repellency/oil repellency
Washfast
Sprayable
Based on special functionalised polymers/waxes
Cationic

ECOPERL Active
Water repellency/oil repellency
Washfast
Based on special functionalised polymers/waxes
Cationic
High effectiveness

LAMETHAN 1 ET 25 BR 160
Functional coatings, Lamination
Washfast
Transparent
25 μm strong
Film based on polyester urethane

LAMETHAN ADH-1
Functional coatings, Lamination
Breathable
Suited for dry laminating
Good stability to washing at 40° C.
Stable foam adhesive

LAMETHAN ADH-L

Functional coatings, Lamination
Washfast
Transparent
Suited for paste coating
Suited for wet laminating

LAMETHAN ALF-K
Functional coatings, Lamination
Adhesive additive for bondings
Suited for dry laminating
Stable foam adhesive
Suited for stable foam coating

LAMETHAN LB 15-T BR 152DK
Functional coatings, Lamination
Transparent
15 μm strong
Breathable
Suited for dry laminating

LAMETHAN LB 25 BR 155
Functional coatings, Lamination
Transparent
25 μm strong
Suited for dry laminating
Good stability to washing at 40° C.

LAMETHAN LB 25 W BR 152
Lamination
25 μm strong
Breathable
Suited for dry laminating
Good stability to washing at 40° C.

LAMETHAN Tape DE 80
Functional coatings, Lamination
Polymer base: polyurethane
Transparent
Good stability to washing at 40° C.
Tape for seam sealing

LAMETHAN Tape ME 160
Functional coatings, Lamination
Polymer base: polyurethane
Transparent
Good stability to washing at 40° C.
Tape for seam sealing

LAMETHAN VL-H920 O BR150
Functional coatings, Lamination
Two coats with membrane and PES charmeuse
Breathable
Suited for dry laminating
Good stability to washing at 40° C.

LAMETHAN VL-H920 S BR 150
Functional coatings, Lamination
Two coats with membrane and PES charmeuse
Breathable
Suited for dry laminating
Good stability to washing at 40° C.

LAMETHAN VL-H920 W BR150
Functional coatings, Lamination
Two coats with membrane and PES charmeuse
Breathable
Suited for dry laminating
Good stability to washing at 40° C.

TUBICOAT A 12 E
Binders, Functional coatings
Anionic
Liquid
Formaldehyde-free
Polymer base: polyacrylate

TUBICOAT A 17
Binders, Functional coatings
Suitable for tablecloth coating
Anionic
Liquid
Self-crosslinking

TUBICOAT A 19
Binders, Functional coatings
Washfast
Anionic
Formaldehyde-free
Good stability to washing

TUBICOAT A 22
Binders, Functional coatings
Washfast
Medium-hard film
Anionic
Liquid

TUBICOAT A 23
Binders
Medium-hard film
Anionic
Liquid
Application for varying the handle

TUBICOAT A 28
Binders, Functional coatings
Anionic
Liquid
Formaldehyde-free
Good stability to washing

TUBICOAT A 36
Binders, Functional coatings
Washfast
Anionic
Liquid
Low formaldehyde

TUBICOAT A 37
Binders, Functional coatings
Washfast
Suitable for tablecloth coating
Anionic
Liquid

TUBICOAT A 41
Binders, Functional coatings
Anionic
Liquid
Self-crosslinking
Good fastnesses

TUBICOAT A 61
Binders, Functional coatings
Suitable for tablecloth coating
Liquid
Non-ionic
Self-crosslinking

TUBICOAT A 94
Binders, Functional coatings
Anionic
Liquid
Self-crosslinking
Good fastnesses

TUBICOAT AIB 20
Fashion coatings
Transparent
Suited for foam coating
Pearl Gloss Finish

TUBICOAT AOS
Foaming auxiliaries
Non-ionic
Foaming
Suited for the fluorocarbon finishing

TUBICOAT ASK
Functional coatings, Lamination
Adhesive additive for bondings
Transparent
Suited for paste coating
Suited for dry laminating

TUBICOAT B-H
Binders, Functional coatings
Polymer base: Styrene butadiene
Anionic
Liquid
Formaldehyde-free

TUBICOAT B 45
Binders, Functional coatings
Washfast
Polymer base: Styrene butadiene
Anionic
Liquid

TUBICOAT BO-NB
Functional coatings
Medium hard
Suited for black-out coating
Good flexibility at low temperatures
Suited for stable foam coating

TUBICOAT BO-W
Functional coatings
Suited for black-out coating
Impermeable for light
Suited for stable foam coating
Water vapour permeable

TUBICOAT BOS
Foaming auxiliaries
Anionic
Foaming
Foam stabilizer

TUBICOAT DW-FI
Functional coatings, Special products
Anionic
Suited for coating pastes
Suited for stable foam
Foamable

TUBICOAT E 4
Binders
Anionic
Self-crosslinking
Low formaldehyde
Polymer base: polyethylene vinyl acetate

TUBICOAT ELC
Functional coatings
Suited for paste coating
Black
Electrically conductive
Soft

TUBICOAT Emulgator HF
Functional coatings, Special products
Anionic
Dispersing
Suited for coating pastes
Suited for stable foam

TUBICOAT ENTSCHÄUMER N
Defoamers and deaerators
Liquid
Non-ionic
Silicone-free
Suited for coating pastes

TUBICOAT FIX FC
Fixing agents
Cationic
Water-based
Liquid
Formaldehyde-free

TUBICOAT FIX ICB CONC.
Fixing agents
Liquid
Non-ionic
Formaldehyde-free
Suited for crosslinking

TUBICOAT FIXIERER AZ
Fixing agents
Liquid
Suited for crosslinking
Based on polyaziridin
Unblocked

TUBICOAT FIXIERER FA
Fixing agents
Anionic
Water-based
Liquid
Low formaldehyde

TUBICOAT FIXIERER H 24
Fixing agents
Anionic
Water-based
Liquid
Formaldehyde-free

TUBICOAT FIXIERER HT
Fixing agents
Water-based
Liquid
Non-ionic
Suited for crosslinking

TUBICOAT FOAMER NY
Foaming auxiliaries
Non-ionic
Foaming
Suited for the fluorocarbon finishing
Non-yellowing

TUBICOAT GC PU
Fashion coatings
Washfast
Soft handle
Polymer base: polyurethane
Transparent

TUBICOAT GRIP
Functional coatings
Slip resistant
Suited for stable foam coating
Soft

TUBICOAT HEC
Thickeners
Powder
Non-ionic
Stable to electrolytes
Stable to shear forces

TUBICOAT HOP-S
Special products
Anionic
Suited for coating pastes
Coating
Adhesion promoter

TUBICOAT HS 8
Binders
Anionic
Liquid
Formaldehyde-free
Hard film

TUBICOAT HWS-1
Functional coatings
Suited for paste coating
Water-proof
Suited for giant umbrellas and tents

TUBICOAT KL-TOP F
Fashion coatings, Functional coatings
Washfast
Polymer base: polyurethane
Transparent
Suited for paste coating

TUBICOAT KLS-M
Fashion coatings, Functional coatings
Washfast
Soft handle
Polymer base: polyurethane
Breathable

TUBICOAT MAF
Fashion coatings
Washfast
Matrix effect
Improves the rubbing fastnesses
Soft handle

TUBICOAT MD TC 70
Fashion coatings
Vintage wax
Suited for foam coating
Suited for topcoats

TUBICOAT MEA
Functional coatings
Washfast
Polymer base: polyurethane
Suited for paste coating
Suited for topcoat coatings

TUBICOAT MG-R
Fashion coatings
Washfast
Soft handle
Suited for paste coating
Duo Leather Finish

TUBICOAT MOP NEU
Functional coatings, Special products
Washfast
Anionic
Foamable
Finish

TUBICOAT MP-D
Fashion coatings, Functional coatings
Washfast
Soft handle
Medium hard
Breathable

TUBICOAT MP-W
Functional coatings
Washfast
Polymer base: polyurethane
Breathable
Water-proof

TUBICOAT NTC-SG
Functional coatings
Washfast
Transparent
Suited for paste coating
Medium hard

TUBICOAT PERL A22-20
Fashion coatings
Suited for paste coating
Suited for foam coating
Pearl Gloss Finish

TUBICOAT PERL HS-1
Functional coatings
Suited for paste coating
Suited for black-out coating
Suited for pearlescent coating
Suited for topcoat coatings

TUBICOAT PERL PU SOFT
Fashion coatings
Washfast
Scarabaeus effect
Soft handle
Polymer base: polyurethane

TUBICOAT PERL VC CONC.
Fashion coatings, Functional coatings
Soft handle
Polymer base: polyurethane
Suited for paste coating
Suited for black-out coating

TUBICOAT PHV
Functional coatings
Medium hard
Suited for three-dimensional dot coating

TUBICOAT PSA 1731
Functional coatings, Lamination
Transparent
Suited for paste coating
Suited for dry laminating
Non-breathable

TUBICOAT PU-UV
Binders
Anionic
Liquid
Formaldehyde-free
Good fastnesses

TUBICOAT PU 60
Binders
Anionic
Liquid
Application for varying the handle
Formaldehyde-free

TUBICOAT PU 80
Binders, Functional coatings
Washfast
Anionic
Liquid
Can be washed off

TUBICOAT PUH-BI
Binders
Anionic
Liquid
Formaldehyde-free
Hard film

TUBICOAT PUL
Functional coatings
Polymer base: polyurethane
Suited for paste coating
Suited for three-dimensional dot coating
Slip resistant

TUBICOAT PUS
Binders, Functional coatings
Anionic
Liquid
Formaldehyde-free
Polymer base: polyurethane

TUBICOAT PUW-M
Binders
Medium-hard film
Anionic
Liquid
Formaldehyde-free

TUBICOAT PUW-S
Binders
Anionic
Liquid
Formaldehyde-free
Good stability to washing

TUBICOAT PW 14
Binders, Functional coatings
Anionic
Formaldehyde-free
Heat-sealable
Not wetting

TUBICOAT SA-M
Functional coatings
Washfast
Suited for paste coating
Suited for three-dimensional dot coating

TUBICOAT SCHÄUMER HP
Foaming auxiliaries, Functional coatings
Non-ionic
Foaming
Suited for the fluorocarbon finishing

TUBICOAT SF-BASE
Fashion coatings
Washfast
Soft handle
Suited for foam coating
Silk gloss effect

TUBICOAT SHM
Foaming auxiliaries
Anionic
Foam stabilizer

TUBICOAT SI 55
Special products
Pseudo-cationic
Suited for coating pastes
Foamable
Coating

TUBICOAT STABILISATOR RP
Foaming auxiliaries
Anionic
Foam stabilizer

TUBICOAT STC 100
Fashion coatings, Functional coatings
Transparent
Breathable
Suited for stable foam coating

TUBICOAT STC 150
Fashion coatings, Functional coatings
Washfast
Soft handle
Transparent
Breathable

TUBICOAT STL
Functional coatings
Washfast
Slip resistant
Suited for stable foam coating
Soft

TUBICOAT TCT
Fashion coatings, Functional coatings
Washfast
Polymer base: polyurethane
Transparent
Suited for paste coating

TUBICOAT VA 10
Binders
Anionic
Liquid
Formaldehyde-free
Hard film

TUBICOAT VCP
Functional coatings
Suited for paste coating
Medium hard
Suited for black-out coating

TUBICOAT VERDICKER 17
Thickeners
Anionic
High efficiency
Synthetic

TUBICOAT VERDICKER ASD
Thickeners
Anionic
Quick swelling
Stable to shear forces
Pseudoplastic

TUBICOAT VERDICKER LP
Thickeners
Anionic
Stable to shear forces
Pseudoplastic
Dispersible

TUBICOAT VERDICKER PRA
Thickeners
Anionic
Liquid
Stable to electrolytes
Rheological additive

TUBICOAT WBH 36
Special products
Finish
Application for preventing roller deposits

TUBICOAT WBV
Special products
Non-ionic
Finish
Application for preventing roller deposits

TUBICOAT WEISS EU
Functional coatings, Special products
Suited for coating pastes
Suited for stable foam
Suited for topcoat coatings
Titanium dioxide paste

TUBICOAT WLI-LT KONZ
Functional coatings
Washfast
Suited for paste coating
Slip resistant
Soft

TUBICOAT WLI
Fashion coatings, Functional coatings
Washfast
Scarabaeus effect
Soft handle
Suited for paste coating

TUBICOAT WOT
Fashion coatings
Washfast
Soft handle
Suited for paste coating
Wash-out effect

TUBICOAT WX-TCA 70
Fashion coatings, Functional coatings
Vintage wax
Suited for paste coating
Suited for topcoat coatings

TUBICOAT WX BASE
Fashion coatings
Vintage wax
Soft handle
Suited for paste coating
Application in the prime coat

TUBICOAT ZP NEU
Water repellency/oil repellency
Zircon-paraffine base
Suited for aqueous systems
Cationic
Foamable

TUBIGUARD 10-F
Water repellency/oil repellency
Washfast
Sprayable
Cationic
Liquid

TUBIGUARD 21
Water repellency/oil repellency
Washfast
Cationic
High effectiveness
Water-based

TUBIGUARD 25-F
Water repellency/oil repellency
Washfast
Sprayable
Cationic
High effectiveness

TUBIGUARD 270
Functional coatings, Water repellency/oil repellency
Washfast
Cationic
High effectiveness
Liquid

TUBIGUARD 30-F
Water repellency/oil repellency
Washfast
Sprayable
Cationic
High effectiveness

TUBIGUARD 44 N
Water repellency/oil repellency
Washfast
Sprayable
Suited for aqueous systems
Liquid

TUBIGUARD 44N-F
Water repellency/oil repellency
Suited for aqueous systems
Non-ionic
Suited for polyester
Foamable

TUBIGUARD 66
Water repellency/oil repellency
Washfast
Sprayable
High effectiveness
Liquid

TUBIGUARD 90-F
Water repellency/oil repellency
Washfast
Cationic
High effectiveness
Liquid

TUBIGUARD AN-F
Water repellency/oil repellency
Washfast
Sprayable
Cationic
High effectiveness

TUBIGUARD FA2-F
Water repellency/oil repellency
Sprayable
Cationic
Suited for polyester
Foamable

TUBIGUARD PC3-F
Functional coatings, Water repellency/oil repellency
Washfast
Cationic
Liquid
Paste

TUBIGUARD SR 2010-F W
Water repellency/oil repellency
Cationic
High effectiveness
Foamable
Based on C6 fluorocarbon

In some embodiments, the chemical agents may include the following, which are supplied by CHT Bezema and are associated with certain selected leather or leather article) properties, which may be used to strengthen SFS binding to inkjet printing dye:

CHT-ALGINAT MVU
Ink jet printing preparation, Thickeners
Cationic
Powder
Anionic
High colour brilliance

PRISULON CR-F 50
Ink jet printing preparation, Thickeners
Liquid
Good outlines
High surface levelness
Good penetration

TUBIJET DU 01
Ink jet printing preparation
Antimigrant
Anionic
Liquid
Formaldehyde-free

TUBIJET NWA
Ink jet printing preparation
Liquid
Non-ionic
Without impact on the handle
Formaldehyde-free

TUBIJET PUS
Ink jet printing preparation
Film forming
Anionic
Liquid
Formaldehyde-free

TUBIJET VDK
Ink jet printing preparation
Liquid
Formaldehyde-free
Halogen-free
Flame protection effect

TUBIJET WET
Ink jet printing preparation
Anionic
Liquid
Without impact on the handle
Formaldehyde-free

In some embodiments, the chemical agents of the invention may include the following inkjet printing dyes, which are supplied by CHT Bezema and are associated with certain selected leather or leather article properties, which may be used in combination with SFS:

BEZAFLUOR BLUE BB
Pigments
High Performance
BEZAFLUOR (fluorescent pigments)

BEZAFLUOR GREEN BT
Pigments
High Performance
BEZAFLUOR (fluorescent pigments)

BEZAFLUOR ORANGE R
Pigments
High Performance
BEZAFLUOR (fluorescent pigments)

BEZAFLUOR PINK BB
Pigments
High Performance
BEZAFLUOR (fluorescent pigments)

BEZAFLUOR RED R
Pigments
High Performance
BEZAFLUOR (fluorescent pigments)

BEZAFLUOR VIOLET BR
Pigments
High Performance
BEZAFLUOR (fluorescent pigments)

BEZAFLUOR YELLOW BA
Pigments
High Performance
BEZAFLUOR (fluorescent pigments)

BEZAPRINT BLACK BDC
Pigments
Advanced
BEZAPRINT (classic pigments)

BEZAPRINT BLACK DT
Pigments
Advanced
BEZAPRINT (classic pigments)

BEZAPRINT BLACK DW
Pigments
Advanced
BEZAPRINT (classic pigments)

BEZAPRINT BLACK GOT
Pigments
High Performance
BEZAKTIV GOT (GOTS)

BEZAPRINT BLUE BN
Pigments
Advanced
BEZAPRINT (classic pigments)

BEZAPRINT BLUE BT
Pigments
Advanced
BEZAPRINT (classic pigments)

BEZAPRINT BLUE GOT
Pigments
High Performance
BEZAKTIV GOT (GOTS)

BEZAPRINT BLUE RR
Pigments
Advanced
BEZAPRINT (classic pigments)

BEZAPRINT BLUE RT
Pigments
Advanced
BEZAPRINT (classic pigments)

BEZAPRINT BLUE RTM
Pigments
Advanced
BEZAPRINT (classic pigments)

BEZAPRINT BLUE TB
Pigments
Advanced
BEZAPRINT (classic pigments)

BEZAPRINT BORDEAUX K2R
Pigments
Advanced
BEZAPRINT (classic pigments)

BEZAPRINT BROWN RP
Pigments
Advanced
BEZAPRINT (classic pigments)

BEZAPRINT BROWN TM
Pigments
Advanced
BEZAPRINT (classic pigments)

BEZAPRINT CITRON 10G
Pigments
Advanced
BEZAPRINT (classic pigments)

BEZAPRINT CITRON GOT
Pigments
High Performance
BEZAKTIV GOT (GOTS)

BEZAPRINT GREEN 2B
Pigments
Advanced
BEZAPRINT (classic pigments)

BEZAPRINT GREEN BS
Pigments
Advanced
BEZAPRINT (classic pigments)

BEZAPRINT GREEN BT
Pigments
Advanced
BEZAPRINT (classic pigments)

BEZAPRINT GREY BB
Pigments
Advanced
BEZAPRINT (classic pigments)

BEZAPRINT NAVY GOT
Pigments
High Performance
BEZAKTIV GOT (GOTS)

BEZAPRINT NAVY RRM
Pigments
Advanced
BEZAPRINT (classic pigments)

BEZAPRINT NAVY TR
Pigments
Advanced
BEZAPRINT (classic pigments)

BEZAPRINT OLIVE GREEN BT
Pigments
Advanced
BEZAPRINT (classic pigments)

BEZAPRINT ORANGE 2G
Pigments
Advanced
BEZAPRINT (classic pigments)

BEZAPRINT ORANGE GOT
Pigments
High Performance
BEZAKTIV GOT (GOTS)

BEZAPRINT ORANGE GT
Pigments
Advanced
BEZAPRINT (classic pigments)

BEZAPRINT ORANGE RG
Pigments
Advanced
BEZAPRINT (classic pigments)

BEZAPRINT PINK BW
Pigments
Advanced
BEZAPRINT (classic pigments)

BEZAPRINT RED 2BN
Pigments
Advanced
BEZAPRINT (classic pigments)

BEZAPRINT RED GOT
Pigments
High Performance
BEZAKTIV GOT (GOTS)

BEZAPRINT RED KF
Pigments
Advanced
BEZAPRINT (classic pigments)

BEZAPRINT RED KGC
Pigments
Advanced
BEZAPRINT (classic pigments)

BEZAPRINT SCARLET GRL
Pigments
Advanced
BEZAPRINT (classic pigments)

BEZAPRINT SCARLET RR
Pigments
Advanced
BEZAPRINT (classic pigments)

BEZAPRINT TURQUOISE GT
Pigments
Advanced
BEZAPRINT (classic pigments)

BEZAPRINT VIOLET FB
Pigments
Advanced
BEZAPRINT (classic pigments)

BEZAPRINT VIOLET KB
Pigments
Advanced
BEZAPRINT (classic pigments)

BEZAPRINT VIOLET R
Pigments
Advanced
BEZAPRINT (classic pigments)

BEZAPRINT VIOLET TN
Pigments
Advanced
BEZAPRINT (classic pigments)

BEZAPRINT YELLOW 2GN
Pigments
Advanced
BEZAPRINT (classic pigments)

BEZAPRINT YELLOW 3GT
Pigments
Advanced
BEZAPRINT (classic pigments)

BEZAPRINT YELLOW 4RM
Pigments
Advanced
BEZAPRINT (classic pigments)

BEZAPRINT YELLOW GOT
Pigments
High Performance
BEZAKTIV GOT (GOTS)

BEZAPRINT YELLOW RR
Pigments
Advanced
BEZAPRINT (classic pigments)

In some embodiments, the chemical agents of the invention may include the following, which are supplied by Lamberti SPA and are associated with certain selected leather or leather article properties, which may be used to strengthen SFS binding on coated or repaired surfaces or SFS may be used for enhancing such chemical agent properties:

### Pre Treatment:

Waterborne Polyurethanes Dispersions
Rolflex AFP.
   Aliphatic polyether polyurethane dispersion in water. The product has high hydrolysis resistance, good breaking load resistance and excellent tear resistance.
Rolflex ACF.
   Aliphatic polycarbonate polyurethane dispersion in water. The product shows good PU and PVC bonding properties, excellent abrasion resistance as well as chemical resistance, included alcohol.
Rolflex V 13.
   Aliphatic polyether/acrylic copolymer polyurethane dispersion in water. The product has good thermoadhesive properties and good adhesion properties on PVC.
Rolflex K 80.
   Aliphatic polyether/acrylic copolymer polyurethane dispersion in water. ROLFLEX K 80 is specifically designed as a high performing adhesive for textile lamination. The product has excellent perchloroethylene and water fastness.
Rolflex ABC.
   Aliphatic polyether polyurethane dispersion in water. Particularly, the product presents very high water column, excellent electrolytes resistance, high LOI index, high resistance to multiple bending.
Rolflex ADH.
   Aliphatic polyether polyurethane dispersion in water. The product has a very high water column resistance.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex PU 147.
   Aliphatic polyether polyurethane dispersion in water. This product shows good film forming properties at room temperature. It has high fastness to light and ultraviolet radiation and good resistance to water, solvent and chemical agents, as well as mechanical resistance.
Rolflex SG.
   Aliphatic polyether polyurethane dispersion in water. Due to its thermoplastic properties it is suggested to formulate heat activated adhesives at low temperatures.
Elafix PV 4.
   Aliphatic blocked isocyanate Nano-dispersion used in order to give antifelting and antipilling properties to pure wool fabrics and his blend.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

Oil and Water Repellents
Lamgard FT 60.
   General purpose fluorocarbon resin for water and oil repellency; by padding application.
Lamgard 48.
   High performance fluorocarbon resin for water and oil repellency; by padding application. High rubbing fastness.
Imbitex NRW3
   Wetting agent for water-and oil repellent finishing.
Lamgard EXT.
   Crosslinker for fluorocarbon resins to improve washing fastness.

Flame Retardants
Piroflam 712.
   Non-permanent flame retardant compound for padding and spray application.
Piroflam ECO.
   Alogen free flame retardant compound for back coating application for all kind of fibers.
Piroflam UBC.
   Flame retardant compound for back coating application for all kind of fibers.

Crosslinkers
Rolflex BK8.
   Aromatic blocked polyisocyanate in water dispersion. It is suggested as a cross-linking agent in coating pastes based of polyurethane resins to improve washing fastness.
Fissativo 05.
   Water dispersible aliphatic polyisocyanate suitable as crosslinking agent for acrylic and polyurethane dispersions to improve adhesion and wet and dry scrub resistance.
Resina MEL.
   Melamine-formaldehyde resin.
Cellofix VLF.
   Low formaldehyde melamine resin.

Thickeners
Lambicol CL 60.
   Fully neutralized synthetic thickener for pigment printing in oil/water emulsion; medium viscosity type
Viscolam PU conc.
   Nonionic polyurethane based thickener with pseudoplastic behavior
Viscolam 115 new.
   Acrylic thickener not neutralized
Viscolam PS 202.
   Nonionic polyurethane based thickener with newtonian behavior Viscolam 1022.
   Nonionic polyurethane based thickener with moderate pseudoplastic behavior.

### Dyeing

Dispersing Agents
Lamegal BO.
   Liquid dispersing agent non ionic, suitable for direct, reactive, disperse dyeing and PES stripping
Lamegal DSP.
   Dispersing/anti back-staining agent in preparation, dyeing and soaping of dyed and printed materials. Antioligomer agent.
Lamegal 619.
   Effective low foam dispersing leveling agent for dyeing of PES Lamegal TLS.
   Multi-purpose sequestering and dispersing agent for all kind of textile process

Levelling Agents
Lamegal A 12.
   Leveling agent for dyeing on wool, polyamide and its blends with acid or metalcomplex dyes

Fixing Agents
Lamfix L.
   Fixing agent for direct and reactive dyestuffs, containing formaldehyde
Lamfix LU conc.
   Formaldehyde free cationic fixing agent for direct and reactive dyes. It does not affect the shade and light fastness.
Lamfix PA/TR.
   Fixing agent to improve the wet fastness of acid dyes on polyamide fabrics, dyed or printed and polyamide yarns. Retarding agent in dyeing of Polyamide/cellulosic blends with direct dyes.

Special Resins
Denifast TC.
   Special resin for cationization of cellulose fibers to obtain special effects (“DENIFAST system” and “DENISOL system”).
Cobral DD/50.
   Special resin for cationization of cellulose fibers to obtain special effect (“DENIFAST system” and “DENISOL system”).

Antireducing Agents
Lamberti Redox L2S gra.
   Anti-reducing agent in grain form. 100% active content Lamberti Redox L2S liq.
   Anti-reducing agent in liquid form for automatic dosage.

Anticreasing Agent
Lubisol AM.
   Lubricating and anti creasing agent for rope wet operation on all kind of fibers and machines.

### Pigment Dye

Antimigrating Agent
Neopat Compound 96/m conc.
   Compound, developed as migration inhibitor for continuous dyeing process with pigments (pad-dry process).

Binding Agent
Neopat Binder PM/S conc.
   Concentrated version of a specific binder used to prepare pad-liquor for dyeing with pigments (pad-dry process).

All in One Agent
Neopat Compound PK1.
   High concentrated compound specifically developed as migration inhibitor with specific binder for continuous dyeing process with pigments (pad-dry process) all in one

Delavè Agent
Neopat compound FTN.
   High concentrated compound of surfactants and polymers specifically developed for pigment dyeing and pigment-reactive dyeing process; especially for medium/dark shades for wash off effect

### Traditional Finishing Agents

Wrinkle Free Treatment
Cellofix ULF conc.
   Anti-crease modified glyoxalic resin for finishing of cottons, cellulosics and blend with synthetics fibers.
Poliflex PO 40.
   Polyethilenic resin for waxy, full and slippy handle by foulard applications.
Rolflex WF.
   Aliphatic waterborned Nano-PU dispersion used as extender for wrinkle free treatments.

### Softeners

Texamina C/FPN.
   Cationic softening agent with a very soft handle particularly recommended for application by exhaustion for all kind of fabrics. Suitable also for cone application.
Texamina C SAL flakes.
   100% cationic softening agent in flakes form for all type of fabrics. Dispersible at room temperature.
Texamina CL LIQ.
   Anphoteric softening agent for all types of fabrics. Not yellowing.
Texamina HVO.
   Anphoteric softening agent for woven and knitted fabrics of cotton, other cellulosics and blends. Gives a soft, smooth and dry handle. Applied by padding.
Texamina SIL.
   Nonionic silicon dispersion in water. Excellent softening, lubricating and anti-static properties for all fibre types by padding.
Texamina SILK.
   Special cationic softener with silk protein inside. Gives a “swollen touch” particularly suitable for cellulosic, wool, silk.
Lamfinish LW.
   All-in compound based on special polymeric hydrophilic softeners; by coating, foulard, and exhaustion.
Elastolam E50.
   General purpose mono-component silicone elastomeric softener for textile finishing.
Elastolam EC 100.
   Modified polysiloxane micro-emulsion which gives a permanent finishing, with extremely soft and silky handle.

Handle Modifier
Poliflex CSW.
   Cationic anti-slipping agent.
Poliflex R 75.
   Parafine finishing agent to give waxy handle.
Poliflex s.
   Compound specifically developed for special writing effects.
Poliflex m.
   Compound for special dry-waxy handle.
Lamsoft SW 24.
   Compound for special slippy handle specifically developed for coating application.
Lamfinish SLIPPY.
   All-in compound to get a slippy touch; by coating.
Lamfinish GUMMY.
   All-in compound to get a gummy touch; by coating.
Lamfinish OLDRY.
   All-in compound to get dry-sandy touch especially suitable for vintage effects; by coating

Waterborne Polyurethanes Dispersions
Rolflex LB 2.
   Aliphatic waterborned PU dispersion particularly suggested for the formulation of textile coatings where bright and rigid top finish is required. It is particularly suitable as a finishing agent for organza touch on silk fabrics. Transparent and shiny.
Rolflex HP 51.
   Aliphatic waterborned PU dispersion particularly suggested for the formulation of textile coatings for outwear, luggage, technical articles especially where hard and flexible touch is required. Transparent and shiny.
Rolflex PU 879.
   Aliphatic waterborned PU dispersion particularly suggested for the formulation of textile coatings for outwear, luggage, technical articles where a medium-hard and flexible touch is required.
Rolflex ALM.
   Aliphatic waterborned PU dispersion particularly suggested for the formulation of textile coatings for outwear, luggage, technical articles where a soft and flexible touch is required. Can be also suitable for printing application.
Rolflex AP.
   Aliphatic waterborned PU dispersion particularly suggested for the formulation of textile coatings for outwear, fashion where a soft and gummy touch is required.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex K 110.
   Gives to the coated fabric a full, soft, and slightly sticky handle with excellent fastness on all types of fabrics.
Rolflex OP 80.
   Aliphatic waterborned PU dispersion particularly suggested for the formulation of textile coatings for outwear, luggage and fashion finishes where an opaque non writing effect is desired.
Rolflex NBC.
   Aliphatic waterborned PU dispersion generally used by padding application as a filling and zero formaldehyde sizing agent. Can be used for outwear and fashion finishings where a full, elastic and non sticky touch is required.
Rolflex PAD.
   Aliphatic waterborned PU dispersion specifically designed for padding application for outwear, sportswear and fashion applications where a full, elastic and non sticky touch is required. Excellent washing and dry cleaning fastness as well as good bath stability.
Rolflex PN.
   Aliphatic waterborned PU dispersion generally applied by padding application for outerwear and fashion high quality applications where strong, elastic non sticky finishes are required.
Elafix PV 4.
   Aliphatic blocked isocyanate Nano-dispersion used in order to give antifelting and antipilling properties to pure wool fabrics and his blend.
Rolflex SW3.
   Aliphatic waterborned PU dispersion particularly suggested to be used by padding application for the finishing of outwear, sportswear and fashion where a slippery and elastic touch is required. It is also a good antipilling agent. Excellent in wool application.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

Other Resins
Textol 110.
   Handle modifier with very soft handle for coating finishes Textol RGD.
   Water emulsion of acrylic copolymer for textile coating, with very rigid handle.
Textol SB 21.
   Butadienic resin for finishing and binder for textile printing Appretto PV/CC.
   Vinylacetate water dispersion for rigid stiffening Amisolo B.
   CMS water dispersion for textile finishing as stiffening agent Lamovil RP.
   PVOH stabilized solution as stiffening agent

### Technical Finishing Agents

Waterborne Polyurethanes Dispersions
Rolflex AFP.
   Aliphatic polyether polyurethane dispersion in water. The product has high hydrolysis resistance, good breaking load resistance and excellent tear resistance.
Rolflex ACF.
   Aliphatic polycarbonate polyurethane dispersion in water. The product shows good PU and PVC bonding properties, excellent abrasion resistance as well as chemical resistance, included alcohol.
Rolflex V 13.
   Aliphatic polyether/acrylic copolymer polyurethane dispersion in water. The product has good thermoadhesive properties and good adhesion properties on PVC.
Rolflex K 80.
   Aliphatic polyether/acrylic copolymer polyurethane dispersion in water. ROLFLEX K 80 is specifically designed as a high performing adhesive for textile lamination. The product has excellent perchloroethylene and water fastness.
Rolflex ABC.
   Aliphatic polyether polyurethane dispersion in water. Particularly, the product presents very high water column, excellent electrolytes resistance, high LOI index, high resistance to multiple bending.
Rolflex ADH.
   Aliphatic polyether polyurethane dispersion in water. The product has a very high water column resistance.
Rolflex W4.
   Aliphatic waterborned PU dispersion particularly suggested for the formulation of textile coatings for clothing, outwear where a full, soft and non sticky touch is required.
Rolflex ZB7.
   Aliphatic waterborned PU dispersion particularly suggested for the formulation of textile coatings for clothing, outwear, sportswear, fashion and technical articles for industrial applications. The product has a very high charge digestion properties, electrolites stability and excellent mechanical and tear resistance. Can be also suitable for foam coating and printing application.
Rolflex BZ 78.
   Aliphatic waterborned PU dispersion particularly suggested for the formulation of textile coatings for clothing, outwear, sportswear, fashion and technical articles for industrial applications. The product has an excellent hydrolysis resistance, a very high charge digestion and electrolites stability and an excellent mechanical and tear resistance. Can be also suitable for foam coating and printing application.
Rolflex PU 147.
   Aliphatic polyether polyurethane dispersion in water. This product shows good film forming properties at room temperature. It has high fastness to light and ultraviolet radiation and good resistance to water, solvent and chemical agents, as well as mechanical resistance.
Rolflex SG.
   Aliphatic polyether polyurethane dispersion in water. Due to its thermoplastic properties it is suggested to formulate heat activated adhesives at low temperatures.
Elafix PV 4.
   Aliphatic blocked isocyanate Nano-dispersion used in order to give antifelting and antipilling properties to pure wool fabrics and his blend.
Rolflex C 86.
   Aliphatic cationic waterborned PU dispersion particularly suggested for the formulation of textile coatings for clothing, outwear, fashion where medium-soft and pleasant full touch is required. Fabrics treated with the product can be dyed with a selection of dyes, to get double-color effects of different intensity.
Rolflex CN 29.
   Aliphatic cationic waterborned PU dispersion particularly suggested for the formulation of textile coatings for clothing, outwear, fashion where soft and pleasant full touch is required. Fabrics treated with the product can be dyed with a selection of dyes, to get double-color effects of different intensity.

Oil and Water Repellents
Lamgard FT 60.
   General purpose fluorocarbon resin for water and oil repellency; by padding application.
Lamgard 48.
   High performance fluorocarbon resin for water and oil repellency; by padding application. High rubbing fastness.
Imbitex NRW3.
   Wetting agent for water-and oil repellent finishing.
Lamgard EXT.
   Crosslinker for fluorocarbon resins to improve washing fastness.

Flame Retardants
Piroflam 712.
   Non-permanent flame retardant compound for padding and spray application.
Piroflam ECO.
   Alogen free flame retardant compound for back coating application for all kind of fibers.
Piroflam UBC.
   Flame retardant compound for back coating application for all kind of fibers

Crosslinkers
Rolflex BK8.
   Aromatic blocked polyisocyanate in water dispersion. It is suggested as a cross-linking agent in coating pastes based of polyurethane resins to improve washing fastness.
Fissativo 05.
   Water dispersible aliphatic polyisocyanate suitable as crosslinking agent for acrylic and polyurethane dispersions to improve adhesion and wet and dry scrub resistance.
Resina MEL.
   Melammine-formaldheyde resin.
Cellofix VLF.
   Low formaldehyde malammine resin.

Thickeners
Lambicol CL 60.
   Fully neutralized synthetic thickener for pigment printing in oil/water emulsion; medium viscosity type
Viscolam PU conc.
   Nonionic polyurethane based thickener with pseudoplastic behavior
Viscolam 115 new.
   Acrylic thickener not neutralized
Viscolam PS 202.
   Nonionic polyurethane based thickener with newtonian behavior
Viscolam 1022.
   Nonionic polyurethane based thickener with moderate pseudoplastic behavior.

In some embodiments, the chemical agent may include one or more of a silicone, an acidic agent, a dyeing agent, a pigment dye, a traditional finishing agent, and a technical finishing agent. The dyeing agent may include one or more of a dispersing agent, a levelling agent, a fixing agent, a special resin, an antireducing agent, and an anticreasing agent. The pigment dye may include one or more of an antimigrating agent, a binding agent, an all in one agent, and a delave agent. The traditional finishing agent may include one or more of a wrinkle free treatment, a softener, a handle modifier, a waterborne polyurethanes dispersion, and other resins. The technical finishing agent may include one or more of a waterborne polyurethanes dispersion, an oil repellant, a water repellant, a crosslinker, and a thickener.

In some embodiments, certain chemical agents of the invention may be provided by one or more of the following chemical suppliers: Adrasa, AcHitex Minerva, Akkim, Archroma, Asutex, Avocet dyes, BCC India, Bozzetto group, CHT, Clariant, Cleanly, Dilube, Dystar, Eksoy, Erca group, Genkim, Giovannelli e Figli, Graf Chemie, Huntsman, KDN Bio, Lamberti, LJ Specialties, Marlateks, Montegauno, Protex, Fulcra Chemicals, Ran Chemicals, Fratelli Ricci, Ronkimya, Sarex, Setas, Silitex, Soko Chimica, Tanatex Chemicals, Union Specialties, Zaitex, Zetaesseti, and Z Schimmer.

In some embodiments, the chemical agent may include an acidic agent. Accordingly, in some embodiments, SFS may include an acidic agent. In some embodiments, an acidic agent may be a Bronsted acid. In an embodiment, the acidic agent includes one or more of citric acid and acetic acid. In an embodiment, the acidic agent aids the deposition and coating of SPF mixtures (i.e., SFS coating) on the leather or leather article to be coated as compared to the absence of such acidic agent. In an embodiment, the acidic agent improves crystallization of the SPF mixtures at the textile to be coated.

In an embodiment, the acidic agent is added at a concentration by weight (% w/w or % w/v) or by volume (v/v) of greater than about 0.001%, or greater than about 0.002%, or greater than about 0.003%, or greater than about 0.004%, or greater than about 0.005%, or greater than about 0.006%, or greater than about 0.007%, or greater than about 0.008%, or greater than about 0.009%, or greater than about 0.01%, or greater than about 0.02%, or greater than about 0.03%, or greater than about 0.04%, or greater than about 0.05%, or greater than about 0.06%, or greater than about 0.07%, or greater than about 0.08%, or greater than about 0.09%, or greater than about 0.1%, or greater than about 0.2%, or greater than about 0.3%, or greater than about 0.4%, or greater than about 0.5%, or greater than about 0.6%, or greater than about 0.7%, or greater than about 0.8%, or greater than about 0.9%, or greater than about 1.0% or greater than about 2.0%, or greater than about 3.0%, or greater than about 4.0%, or greater than about 5.0%.

In an embodiment, the acidic agent is added at a concentration by weight (% w/w or % w/v) or by volume (v/v) of less than about 0.001%, or less than about 0.002%, or less than about 0.003%, or less than about 0.004%, or less than about 0.005%, or less than about 0.006%, or less than about 0.007%, or less than about 0.008%, or less than about 0.009%, or less than about 0.01%, or less than about 0.02%, or less than about 0.03%, or less than about 0.04%, or less than about 0.05%, or less than about 0.06%, or less than about 0.07%, or less than about 0.08%, or less than about 0.09%, or less than about 0.1%, or less than about 0.2%, or less than about 0.3%, or less than about 0.4%, or less than about 0.5%, or less than about 0.6%, or less than about 0.7%, or less than about 0.8%, or less than about 0.9%, or less than about 1.0% or less than about 2.0%, or less than about 3.0%, or less than about 4.0%, or less than about 5.0%.

In some embodiments, SFS may have a pH of less than about 9, or less than about 8.5, or less than about 8, or less than about 7.5, or less than about 7, or less than about 6.5, or less than about 6, or less than about 5.5, or less than about 5, or less than about 4.5, or less than about 4, or greater than about 3.5, or greater than about 4, or greater than about 4.5, or greater than about 5, or greater than about 5.5, or greater than about 6, or greater than about 6.5, or greater than about 7, or greater than about 7.5, or greater than about 8, or greater than about 8.5.

In some embodiments, SFS may include an acidic agent, and may have a pH of less than about 9, or less than about 8.5, or less than about 8, or less than about 7.5, or less than about 7, or less than about 6.5, or less than about 6, or less than about 5.5, or less than about 5, or less than about 4.5, or less than about 4, or greater than about 3.5, or greater than about 4, or greater than about 4.5, or greater than about 5, or greater than about 5.5, or greater than about 6, or greater than about 6.5, or greater than about 7, or greater than about 7.5, or greater than about 8, or greater than about 8.5.

In an embodiment, the chemical agent may include silicone. In some embodiments, a SFS may include silicone. In some embodiments, the leather or leather article may be pretreated (i.e., prior to SFS application) or post-treated (i.e., after SFS application) with silicone.

In some embodiments, silicone may include a silicone emulsion.

The term “silicone,” may generally refer to a broad family of synthetic polymers, mixtures of polymers, and/or emulsions thereof, that have a repeating silicon-oxygen backbone including, but not limited to, polysiloxanes. In some embodiments, a silicone may include any silicone species disclosed herein.

Describing the compositions and coatings more broadly, silicone may be used, for example to improve hand, but may also increase the water repellency (or reduce water transport properties) of a material coated with silicone.

In some embodiments, SFS may include silicone in a concentration by weight (% w/w or % w/v) or by volume (v/v) of less than about 25%, or less than about 20%, or less than about 15%, or less than about 10%, or less than about 9%, or less than about 8%, or less than about 7%, or less than about 6%, or less than about 5%, or less than about 4%, or less than about 3%, or less than about 2%, or less than about 1%, or less than about 0.9%, or less than about 0.8%, or less than about 0.7%, or less than about 0.6%, or less than about 0.5%, or less than about 0.4%, or less than about 0.3%, or less than about 0.2%, or less than about 0.1%, or less than about 0.01%, or less than about 0.001%.

In some embodiments, SFS may include silicone in a concentration by weight (% w/w or % w/v) or by volume (v/v) of greater than about 25%, or greater than about 20%, or greater than about 15%, or greater than about 10%, or greater than about 9%, or greater than about 8%, or greater than about 7%, or greater than about 6%, or greater than about 5%, or greater than about 4%, or greater than about 3%, or greater than about 2%, or greater than about 1%, or greater than about 0.9%, or greater than about 0.8%, or greater than about 0.7%, or greater than about 0.6%, or greater than about 0.5%, or greater than about 0.4%, or greater than about 0.3%, or greater than about 0.2%, or greater than about 0.1%, or greater than about 0.01%, or greater than about 0.001%.

In some embodiments, SFS may be supplied in a concentrated form suspended in water. In some embodiments, SFS may have a concentration by weight (% w/w or % w/v) or by volume (v/v) of less than about 50%, or less than about 45%, or less than about 40%, or less than about 35%, or less than about 30%, or less than about 25%, or less than about 20%, or less than about 15%, or less than about 10%, or less than about 5%, or less than about 4%, or less than about 3%, or less than about 2%, or less than about 1%, or less than about 0.1%, or less than about 0.01%, or less than about 0.001%, or less than about 0.0001%, or less than about 0.00001%. In some embodiments, SFS may have a concentration by weight (% w/w or % w/v) or by volume (v/v) of greater than about 50%, or greater than about 45%, or greater than about 40%, or greater than about 35%, or greater than about 30%, or greater than about 25%, or greater than about 20%, or greater than about 15%, or greater than about 10%, or greater than about 5%, or greater than about 4%, or greater than about 3%, or greater than about 2%, or greater than about 1%, or greater than about 0.1%, or greater than about 0.01%, or greater than about 0.001%, or greater than about 0.0001%, or greater than about 0.00001%.

In some embodiments, an SFS coating may include SFS, as described herein. In some embodiments, SFS may include a silicone and/or an acidic agent. In some embodiments, SFS may include a silicone and an acidic agent. In some embodiments, the SFS may include a silicone, an acidic agent, and/or an additional chemical agent, wherein the additional chemical agent may be one or more of the chemical agents described herein. In some embodiments, SFS may include a silicone emulsion and an acidic agent, such as acetic acid or citric acid.

In some embodiments, the coating processes of the invention may include a finishing step for the resulting coated materials. In some embodiments, the finishing or final finishing of the materials that are coated with SFS under the processes of the invention may include sueding, steaming, brushing, polishing, compacting, raising, tigering, shearing, heatsetting, waxing, air jet, calendaring, pressing, shrinking, treatment with polymerizer, coating, lamination, and/or laser etching. In some embodiments, finishing of the SFS coated materials may include treatment of the textiles with an AIRO® 24 dryer that may be used for continuous and open-width tumbling treatments of woven, non-woven, and knitted fabrics.

### EXAMPLES

The following examples are put forth so as to provide those of ordinary skill in the art with a complete disclosure and description of how to make and use the described embodiments, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

### Example 1—Silk Solutions Used for Treating Leather

A number of silk solutions are prepared for the treatment of leather, as described in Table 1, and maybe used as described herein.

TABLE 1
Silk formulations for different stages of leather treatment

| Type of | Titration | |
|---|---|---|
| Silk | Agent (TA) | Formulation Process |
| 6% 1:1 | Ammonium | Mix 1 part low MW with 1 part med MW; Titrate |
| (L:M) pH 8 | Hydroxide | stepwise with dilute TA (1:100 stock) |
| 6% 2:1 | Ammonium | Mix 2 parts low MW with 1 part med MW; Titrate |
| (L:M) pH 8 | Hydroxide | stepwise with dilute TA (1:100 stock) |
| 6% 3:1 | Ammonium | Mix 3 parts low MW with 1 part med MW; Titrate |
| (L:M) pH 8 | Hydroxide | stepwise with dilute TA (1:100 stock) |
| 6% 4:1 | Ammonium | Mix 4 parts low MW with 1 part med MW; Titrate |
| (L:M) pH 8 | Hydroxide | stepwise with dilute TA (1:100 stock) |
| 6% 5:1 | Ammonium | Mix 5 parts low MW with 1 part med MW; Titrate |
| (L:M) pH 8 | Hydroxide | stepwise with dilute TA (1:100 stock) |
| 6% 6:1 | Ammonium | Mix 6 parts low MW with 1 part med MW; Titrate |
| (L:M) pH 8 | Hydroxide | stepwise with dilute TA (1:100 stock) |
| 6% 7:1 | Ammonium | Mix 7 parts low MW with 1 part med MW; Titrate |
| (L:M) pH 8 | Hydroxide | stepwise with dilute TA (1:100 stock) |
| 6% 8:1 | Ammonium | Mix 8 parts low MW with 1 part med MW; Titrate |
| (L:M) pH 8 | Hydroxide | stepwise with dilute TA (1:100 stock) |
| 6% 9:1 | Ammonium | Mix 9 parts low MW with 1 part med MW; Titrate |
| (L:M) pH 8 | Hydroxide | stepwise with dilute TA (1:100 stock) |
| 6% 1:2 | Ammonium | Mix 1 part low MW with 2 parts med MW; Titrate |
| (L:M) pH 8 | Hydroxide | stepwise with dilute TA (1:100 stock) |
| 6% 1:3 | Ammonium | Mix 1 part low MW with 3 parts med MW; Titrate |
| (L:M) pH 8 | Hydroxide | stepwise with dilute TA (1:100 stock) |
| 6% 1:4 | Ammonium | Mix 1 part low MW with 4 parts med MW; Titrate |
| (L:M) pH 8 | Hydroxide | stepwise with dilute TA (1:100 stock) |
| 6% 1:5 | Ammonium | Mix 1 part low MW with 5 parts med MW; Titrate |
| (L:M) pH 8 | Hydroxide | stepwise with dilute TA (1:100 stock) |
| 6% 1:6 | Ammonium | Mix 1 part low MW with 6 parts med MW; Titrate |
| (L:M) pH 8 | Hydroxide | stepwise with dilute TA (1:100 stock) |
| 6% 1:7 | Ammonium | Mix 1 part low MW with 7 parts med MW; Titrate |
| (L:M) pH 8 | Hydroxide | stepwise with dilute TA (1:100 stock) |
| 6% 1:8 | Ammonium | Mix 1 part low MW with 8 parts med MW; Titrate |
| (L:M) pH 8 | Hydroxide | stepwise with dilute TA (1:100 stock) |
| 6% 1:9 | Ammonium | Mix 1 part low MW with 9 parts med MW; Titrate |
| (L:M) pH 8 | Hydroxide | stepwise with dilute TA (1:100 stock) |
| 6% 1:1 | Acetic Acid | Mix 1 part low MW with 1 part med MW; Titrate |
| (L:M) pH 4 | | stepwise with stock TA |
| 6% 2:1 | Acetic Acid | Mix 2 parts low MW with 1 part med MW; Titrate |
| (L:M) pH 4 | | stepwise with stock TA |
| 6% 3:1 | Acetic Acid | Mix 3 parts low MW with 1 part med MW; Titrate |
| (L:M) pH 4 | | stepwise with stock TA |
| 6% 4:1 | Acetic Acid | Mix 4 parts low MW with 1 part med MW; Titrate |
| (L:M) pH 4 | | stepwise with stock TA |
| 6% 5:1 | Acetic Acid | Mix 5 parts low MW with 1 part med MW; Titrate |
| (L:M) pH 4 | | stepwise with stock TA |
| 6% 6:1 | Acetic Acid | Mix 6 parts low MW with 1 part med MW; Titrate |
| (L:M) pH 4 | | stepwise with stock TA |
| 6% 7:1 | Acetic Acid | Mix 7 parts low MW with 1 part med MW; Titrate |
| (L:M) pH 4 | | stepwise with stock TA |
| 6% 8:1 | Acetic Acid | Mix 8 parts low MW with 1 part med MW; Titrate |
| (L:M) pH 4 | | stepwise with stock TA |
| 6% 9:1 | Acetic Acid | Mix 9 parts low MW with 1 part med MW; Titrate |
| (L:M) pH 4 | | stepwise with stock TA |
| 6% 1:2 | Acetic Acid | Mix 1 part low MW with 2 parts med MW; Titrate |
| (L:M) pH 4 | | stepwise with stock TA |
| 6% 1:3 | Acetic Acid | Mix 1 part low MW with 3 parts med MW; Titrate |
| (L:M) pH 4 | | stepwise with stock TA |
| 6% 1:4 | Acetic Acid | Mix 1 part low MW with 4 parts med MW; Titrate |
| (L:M) pH 4 | | stepwise with stock TA |
| 6% 1:5 | Acetic Acid | Mix 1 part low MW with 5 parts med MW; Titrate |
| (L:M) pH 4 | | stepwise with stock TA |
| 6% 1:6 | Acetic Acid | Mix 1 part low MW with 6 parts med MW; Titrate |
| (L:M) pH 4 | | stepwise with stock TA |
| 6% 1:7 | Acetic Acid | Mix 1 part low MW with 7 parts med MW; Titrate |
| (L:M) pH 4 | | stepwise with stock TA |
| 6% 1:8 | Acetic Acid | Mix 1 part low MW with 8 parts med MW; Titrate |
| (L:M) pH 4 | | stepwise with stock TA |
| 6% 1:9 | Acetic Acid | Mix 1 part low MW with 9 parts med MW; Titrate |
| (L:M) pH 4 | | stepwise with stock TA |
| 1% 1:1 | Ammonium | Dilute silk stocks to 1% w/v; Mix 1 part low MW with 1 |
| (L:M) pH 8 | Hydroxide | part med MW; Titrate stepwise with dilute TA (1:100 |
| | | stock) |
| 1% 2:1 | Ammonium | Dilute silk stocks to 1% w/v; Mix 2 parts low MW with 1 |
| (L:M) pH 8 | Hydroxide | part med MW; Titrate stepwise with dilute TA (1:100 |
| | | stock) |
| 1% 3:1 | Ammonium | Dilute silk stocks to 1% w/v; Mix 3 parts low MW with 1 |
| (L:M) pH 8 | Hydroxide | part med MW; Titrate stepwise with dilute TA (1:100 |
| | | stock) |
| 1% 4:1 | Ammonium | Dilute silk stocks to 1% w/v; Mix 4 parts low MW with 1 |
| (L:M) pH 8 | Hydroxide | part med MW; Titrate stepwise with dilute TA (1:100 |
| | | stock) |
| 1% 5:1 | Ammonium | Dilute silk stocks to 1% w/v; Mix 5 parts low MW with 1 |
| (L:M) pH 8 | Hydroxide | part med MW; Titrate stepwise with dilute TA (1:100 |
| | | stock) |
| 1% 6:1 | Ammonium | Dilute silk stocks to 1% w/v; Mix 6 parts low MW with 1 |
| (L:M) pH 8 | Hydroxide | part med MW; Titrate stepwise with dilute TA (1:100 |
| | | stock) |
| 1% 7:1 | Ammonium | Dilute silk stocks to 1% w/v; Mix 7 parts low MW with 1 |
| (L:M) pH 8 | Hydroxide | part med MW; Titrate stepwise with dilute TA (1:100 |
| | | stock) |
| 1% 8:1 | Ammonium | Dilute silk stocks to 1% w/v; Mix 8 parts low MW with 1 |
| (L:M) pH 8 | Hydroxide | part med MW; Titrate stepwise with dilute TA (1:100 |
| | | stock) |
| 1% 9:1 | Ammonium | Dilute silk stocks to 1% w/v; Mix 9 parts low MW with 1 |
| (L:M) pH 8 | Hydroxide | part med MW; Titrate stepwise with dilute TA (1:100 |
| | | stock) |
| 1% 1:2 | Ammonium | Dilute silk stocks to 1% w/v; Mix 1 part low MW with 2 |
| (L:M) pH 8 | Hydroxide | parts med MW; Titrate stepwise with dilute TA (1:100 |
| | | stock) |
| 1% 1:3 | Ammonium | Dilute silk stocks to 1% w/v; Mix 1 part low MW with 3 |
| (L:M) pH 8 | Hydroxide | parts med MW; Titrate stepwise with dilute TA (1:100 |
| | | stock) |
| 1% 1:4 | Ammonium | Dilute silk stocks to 1% w/v; Mix 1 part low MW with 4 |
| (L:M) pH 8 | Hydroxide | parts med MW; Titrate stepwise with dilute TA (1:100 |
| | | stock) |
| 1% 1:5 | Ammonium | Dilute silk stocks to 1% w/v; Mix 1 part low MW with 5 |
| (L:M) pH 8 | Hydroxide | parts med MW; Titrate stepwise with dilute TA (1:100 |
| | | stock) |
| 1% 1:6 | Ammonium | Dilute silk stocks to 1% w/v; Mix 1 part low MW with 6 |
| (L:M) pH 8 | Hydroxide | parts med MW; Titrate stepwise with dilute TA (1:100 |
| | | stock) |
| 1% 1:7 | Ammonium | Dilute silk stocks to 1% w/v; Mix 1 part low MW with 7 |
| (L:M) pH 8 | Hydroxide | parts med MW; Titrate stepwise with dilute TA (1:100 |
| | | stock) |
| 1% 1:8 | Ammonium | Dilute silk stocks to 1% w/v; Mix 1 part low MW with 8 |
| (L:M) pH 8 | Hydroxide | parts med MW; Titrate stepwise with dilute TA (1:100 |
| | | stock) |
| 1% 1:9 | Ammonium | Dilute silk stocks to 1% w/v; Mix 1 part low MW with 9 |
| (L:M) pH 8 | Hydroxide | parts med MW; Titrate stepwise with dilute TA (1:100 |
| | | stock) |
| 6% med | Ammonium | Titrate 6% Med MW silk stepwise with dilute TA (1:100 |
| pH 13 | Hydroxide | stock) |
| 6% med | Ammonium | Titrate 6% Med MW silk stepwise with dilute TA (1:100 |
| pH 12 | Hydroxide | stock) |
| 6% med | Ammonium | Titrate 6% Med MW silk stepwise with dilute TA (1:100 |
| pH 11 | Hydroxide | stock) |
| 6% med | Ammonium | Titrate 6% Med MW silk stepwise with dilute TA (1:100 |
| pH 10 | Hydroxide | stock) |
| 6% med | Ammonium | Titrate 6% Med MW silk stepwise with dilute TA (1:100 |
| pH 9 | Hydroxide | stock) |
| 6% med | Ammonium | Titrate 6% Med MW silk stepwise with dilute TA (1:100 |
| pH 8 | Hydroxide | stock) |
| 6% med | Ammonium | Titrate 6% Med MW silk stepwise with dilute TA (1:100 |
| pH 7 | Hydroxide and/or | stock) |
| | Acetic Acid | |
| 6% low | Acetic Acid | Titrate 6% low MW silk stepwise with stock TA |
| pH 6 | | |
| 6% low | Acetic Acid | Titrate 6% low MW silk stepwise with stock TA |
| pH 5 | | |
| 6% low | Acetic Acid | Titrate 6% low MW silk stepwise with stock TA |
| pH 4 | | |
| 6% med | Acetic Acid | Titrate 6% med MW silk stepwise with stock TA |
| pH 3 | | |
| 6% low | Acetic Acid | Titrate 6% low MW silk stepwise with stock TA |
| pH 2 | | |
| 1% low | Acetic Acid | Dilute 6% silk low MW stock to 1% w/v; Titrate |
| pH 6 | | stepwise with stock TA |
| 1% low | Acetic Acid | Dilute 6% silk low MW stock to 1% w/v; Titrate |
| pH 5 | | stepwise with stock TA |
| 1% low | Acetic Acid | Dilute 6% silk low MW stock to 1% w/v; Titrate |
| pH 4 | | stepwise with stock TA |
| 1% low | Acetic Acid | Dilute 6% silk low MW stock to 1% w/v; Titrate |
| pH 3 | | stepwise with stock TA |
| 1% low | Acetic Acid | Dilute 6% silk low MW stock to 1% w/v; Titrate |
| pH 2 | | stepwise with stock TA |
| 1% med | Acetic Acid | Dilute 6% silk med MW stock to 1% w/v; Titrate |
| pH 6 | | stepwise with stock TA |
| 1% med | Acetic Acid | Dilute 6% silk med MW stock to 1% w/v; Titrate |
| pH 5 | | stepwise with stock TA |
| 1% med | Acetic Acid | Dilute 6% silk med MW stock to 1% w/v; Titrate |
| pH 4 | | stepwise with stock TA |
| 1% med | Acetic Acid | Dilute 6% silk med MW stock to 1% w/v; Titrate |
| pH 3 | | stepwise with stock TA |
| 1% med | Acetic Acid | Dilute 6% silk med MW stock to 1% w/v; Titrate |
| pH 2 | | stepwise with stock TA |

Silk formulations as described herein may be used before, during, or after various leather processing steps, including:

Drying—Drying of hand and autosprayed skins may be done in production line ovens used during normal leather processing. The autosprayed skins may be dried one or more times in between one or more spray treatments, e.g., spray>dry>spray>dry. Oven temperature may vary between 70-75° C. and each dry round may last ˜25 seconds.

Stamping—Stamping may be used during the production process of leathers. During the process, a skin is compressed (treated side up) between two metal plates (approx. 5-6 m²), the top plate operating at 57° C. The skin is compressed at this temperature for 2 seconds at 100 kg/cm². Qualitatively speaking, the stamping process may add sheen to the leather sample.

Finiflex—A typical processing step for plongé leathers, this mechanical treatment may be used as a final step for silk-doped leathers. The skin is processed in two halves on this machine—the skin half is lifted into and compressed by a rotating heated metallic wheel (93° C.; 20 kg/m²; d_{wheel}=0.3 m) for 4 seconds. The skin is then pulled out, flipped, and the other half is treated in the same way.

Uniflex—The Uniflex treatment is similar to the Finiflex treatment, used at the final stage of leather processing. During this process, a skin is fed onto a feeder belt into two pressing cylinders (each 0.3 m in diameter). The top cylinder is heated to 60° C., while the bottom cylinder is unheated. Together, the cylinders compress the skin at 30 bar for 3-5 seconds.

Polishing—The polisher shaves off some of the surface treatment(s) done on the leather in prior processing steps (physical abrasion). At earlier stages in leather processing this serves to “open up” the skin for more effective adhesion of fixation/pigmentation agents in a similar way to the mechanical stretching process which occurs right before trimming of the skins.

Autosprayer—Unless otherwise noted, when skins are sprayed using the in-house automatic spray machine they may be sprayed in one or more rounds with intermediate drying treatments. Spraying fluid (silk, silicone treatment, etc.) may be pumped into the nozzle feed lines at 3 bar, and fed into the nozzle inlet (D_{nozzle}=0.6 mm) at a pressure between 0.8-1.2 bar. The spray volume of the AUTO sprayer may vary between 0.8-1.0 g/ft². The residence volume of the spraying fluid may be approximately 2-2.5 L. Various silk formulations described herein may be able to be fed into such machine and sprayed evenly onto skins.

The hand spray process may involve one or more coats, e.g., two passes each of different orientation, coat 1 vertically oriented spray pattern, and coat 2 horizontally-oriented spray pattern, of silk deposited onto half of one skin, with the other half covered up as a control. Hand-spray coating volumes may be approximately 50 mL per coat.

6% coated skins may have a noticeably darker sheen when placed under viewing light, and may be slightly stiffer to the touch compared to the untreated control half.

### Example 2: Using a Silk and/or SPF Composition to Repair, Mask, or Hide Follicle or Other Defects in Leather

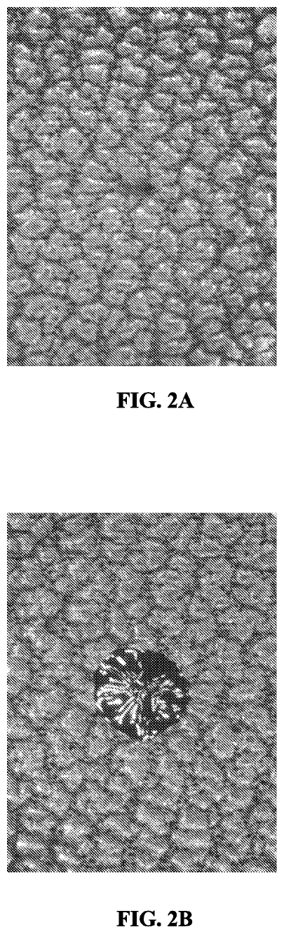

A follicle or other surface or sub-surface defect in leather or hides can be masked, hidden, or repaired using one or more silk or SPF compositions as described herein, for example as shown in FIGS. 2A-7C. A composition including from about 1% to about 6% v/v cam be used as a coating and/or mixing agent, and a composition having higher silk and/or SPF concentration, for example up to, about, or above 30% v/v, can be used as a filling agent for defects. These compositions can include various classes of substances, for example polysaccharides, polysaccharide blends, triglycerides, organic acids, surfactants, etc. The silk and/or SPF compositions can include additional agents to alter viscosity, or used as gelling agents, plasticizers, to adjust color and/or luster. A composition includes 6% v/v low molecular weight silk solution blended with 1% v/v xanthan gum powder (gelation agent), and/or glycerol-silk blends (<1% v/v glycerol to ˜25% v/v glycerol) with glycerol acting as a plasticizer.

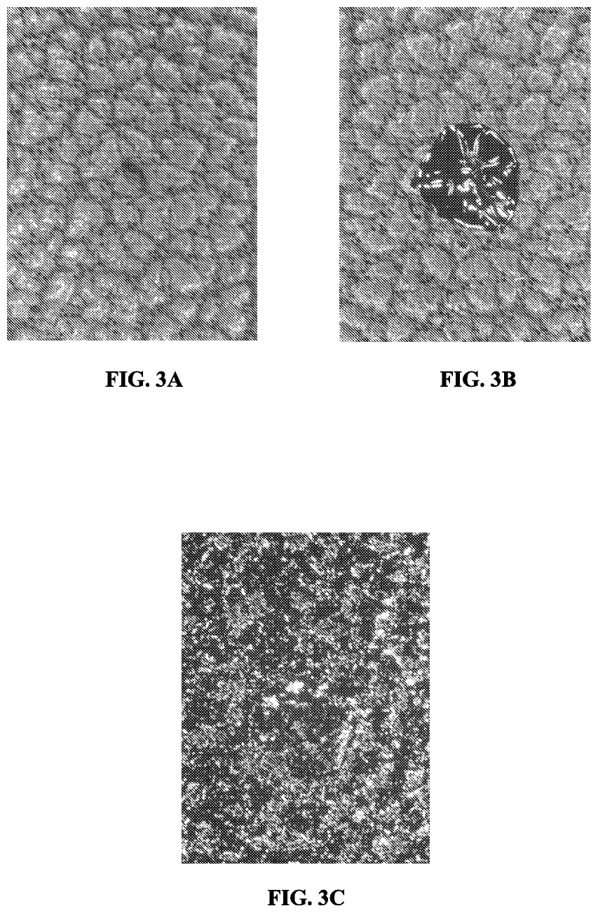

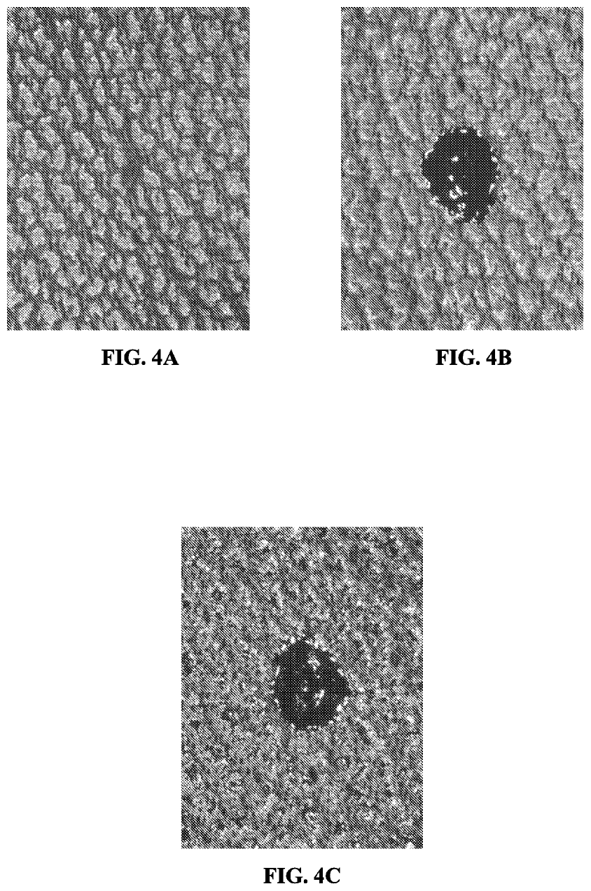

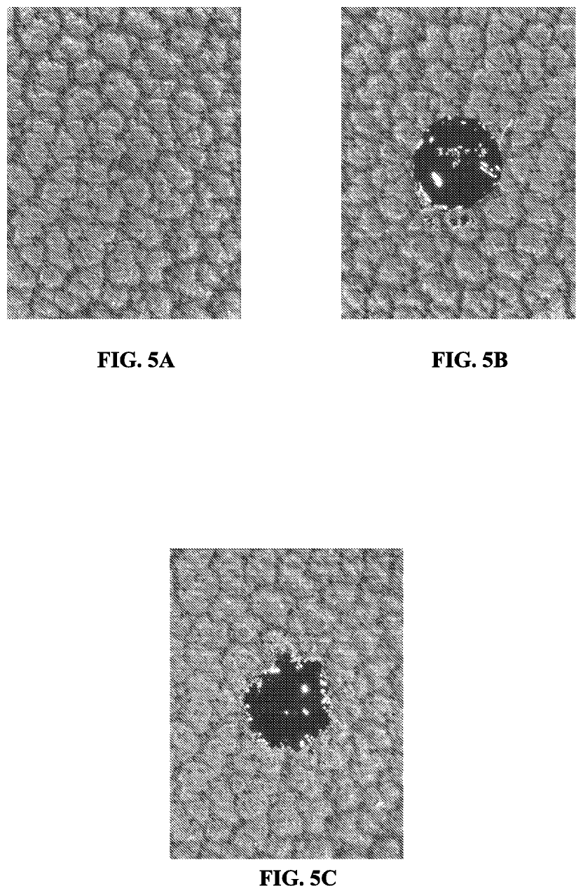

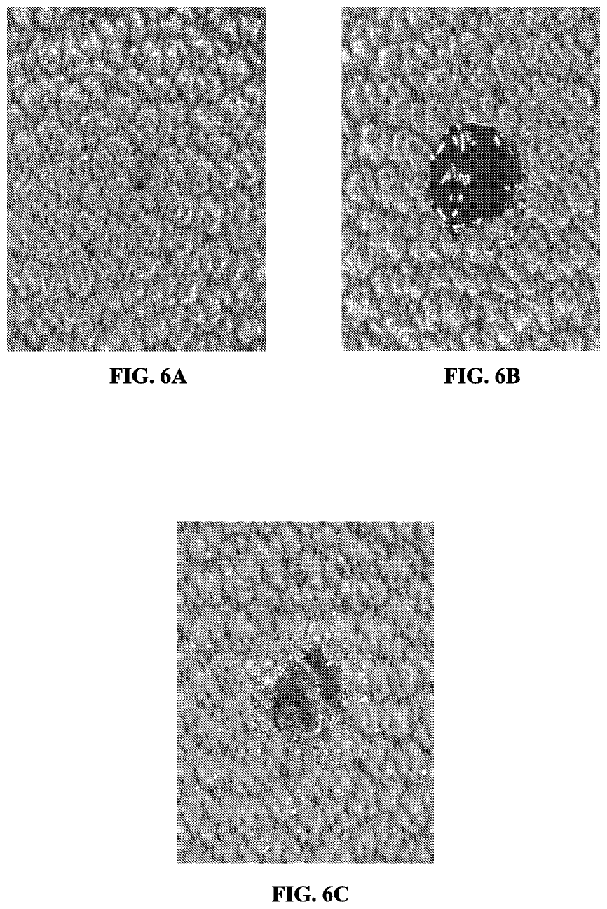

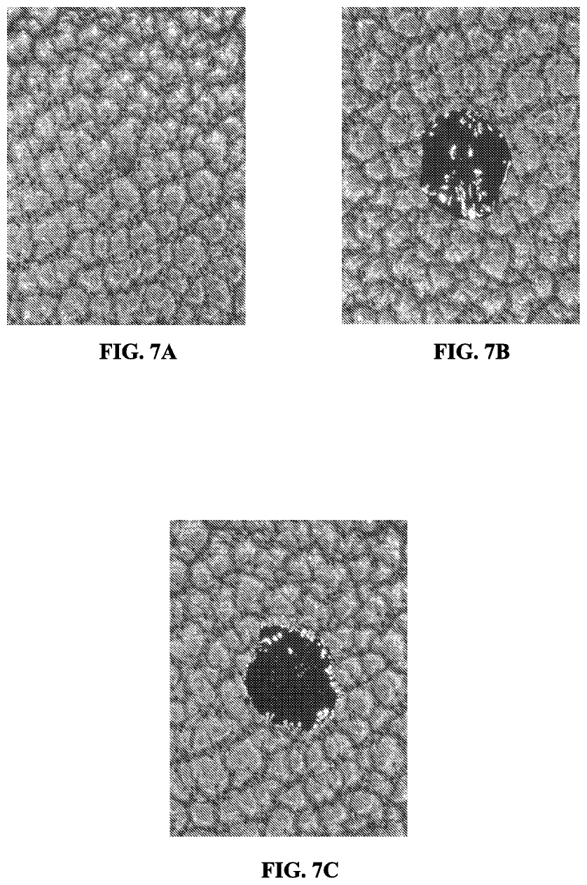

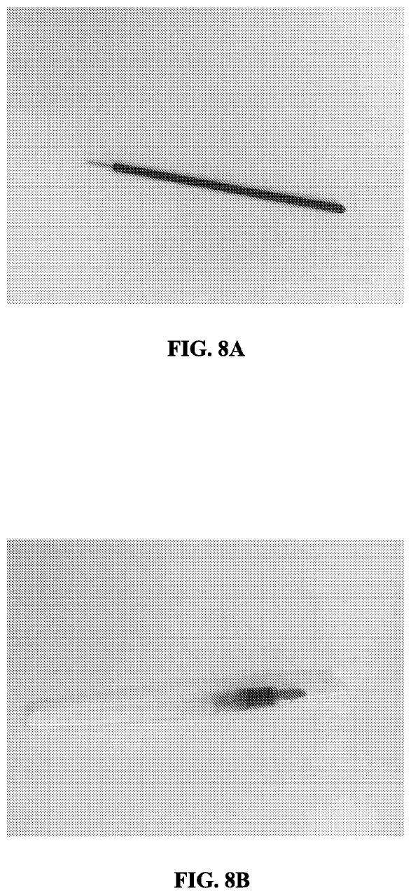

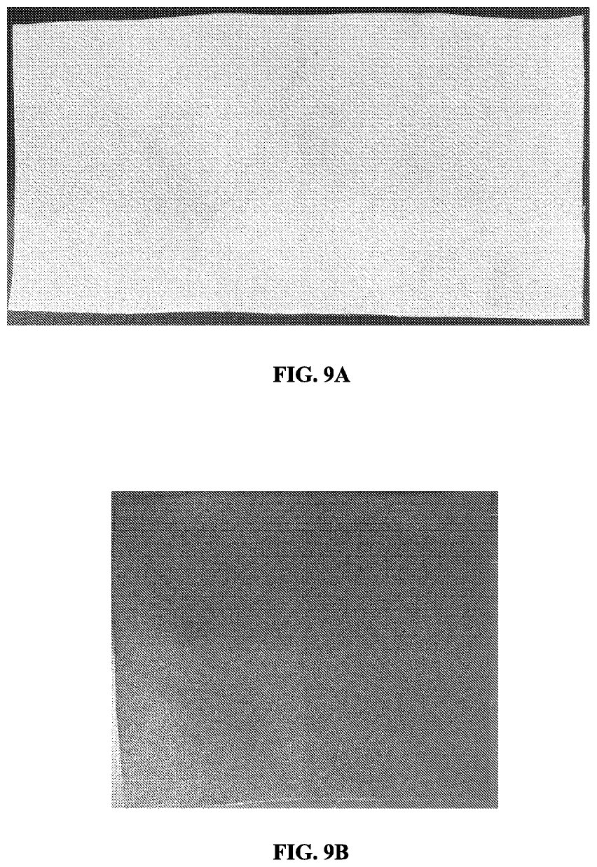

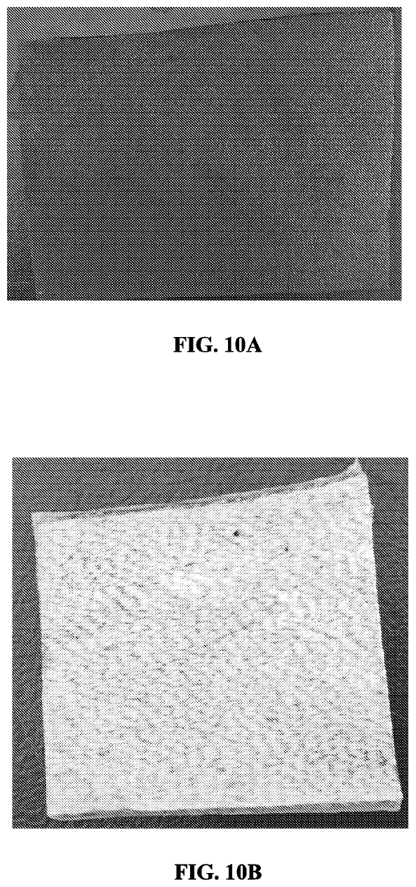

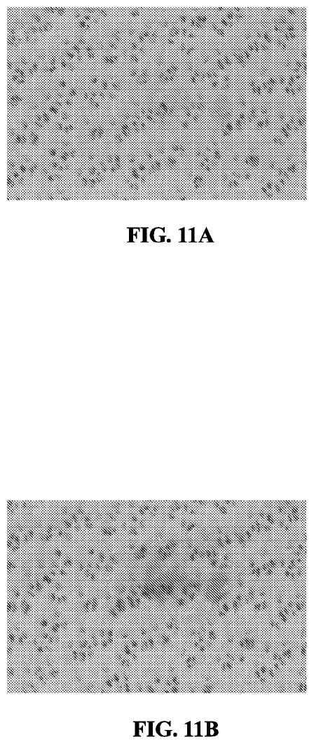

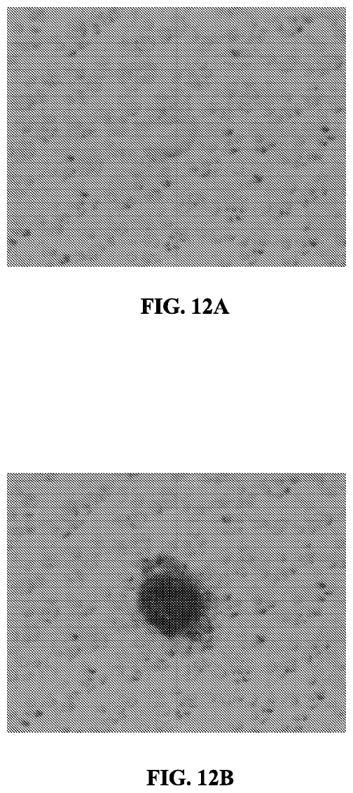

FIG. 2A shows a leather defect prior to repairing, and FIG. 2B shows the repaired defect filled with a composition as described herein. FIG. 3A shows a leather defect prior to repairing, while FIG. 3B shows the repaired defect filled with a composition as described herein, and FIG. 3C shows the repaired defect filled with a composition as described herein and then coated with Unithane 2132 NF. FIG. 4A shows a leather defect prior to repairing, while FIG. 4B shows the repaired defect filled with a composition as described herein, and FIG. 4C shows the repaired defect filled with a composition as described herein and then coated with Unithane 351 NF. FIG. 5A shows a leather defect prior to repairing, while FIG. 5B shows the repaired defect filled with a composition as described herein, and FIG. 5C shows the repaired defect filled with a composition as described herein and then coated with Silky Top 7425 NF. FIG. 6A shows a leather defect prior to repairing, while FIG. 6B shows the repaired defect filled with a composition as described herein, and FIG. 6C shows the repaired defect filled with a composition as described herein and then coated with Uniseal 9049. FIG. 7A shows a leather defect prior to repairing, while FIG. 7B shows the repaired defect filled with a composition as described herein, and FIG. 7C shows the repaired defect filled with a composition as described herein and then coated with a 6% M silk coating. FIGS. 8A and 8B show an eyeliner brush—applicator for a defect filling process (FIG. 8A), and a brush pen/marker filled with silk as applicator for a defect filling process (FIG. 8B). FIGS. 9A and 9B show a sample of undyed lambskin leather (left side—uncoated, right side—coated with 6% low MW silk, 4 seconds autospray; FIG. 9A), and a sample of dyed lambskin leather (left side—uncoated, right side—coated with 6% low MW silk, 4 seconds autospray; FIG. 9B). FIGS. 10A and 10B show a sample of bovine leather coated with 6% low MW silk, 4 seconds autospray (FIG. 10A), and a sample of undyed lambskin leather coated with 6% low MW silk mixed with 1% Clariant Hostaperm Violet RL Spec Pigment. FIGS. 11A and 11B show a sample of undyed lambskin leather defect filled with 21% med MW silk with brush pen, before (FIG. 11A), and after (FIG. 11B). FIGS. 12A and 12B show a sample of undyed lambskin leather defect filled with 21% M silk with 1% Clariant Hostaperm Violet RL Spec Pigment applied with an eyeliner brush applicator, before (FIG. 12A), and after (FIG. 12B).

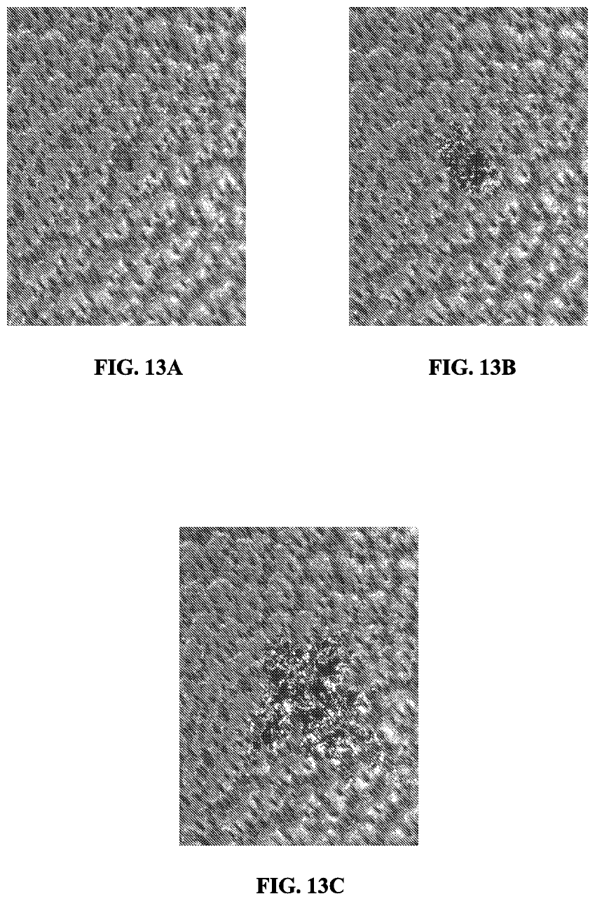

FIGS. 13A to 13C show application of a defect filler composition using an eyeliner-type applicator, resulting in enhanced control of the topography of silk deposition to more accurately match natural patters on leather surface; FIG. 13A: unfilled defect; FIG. 13B: one round of application using an eyeliner brush; and FIG. 13C: second round of application using an eyeliner brush (24% low MW silk).

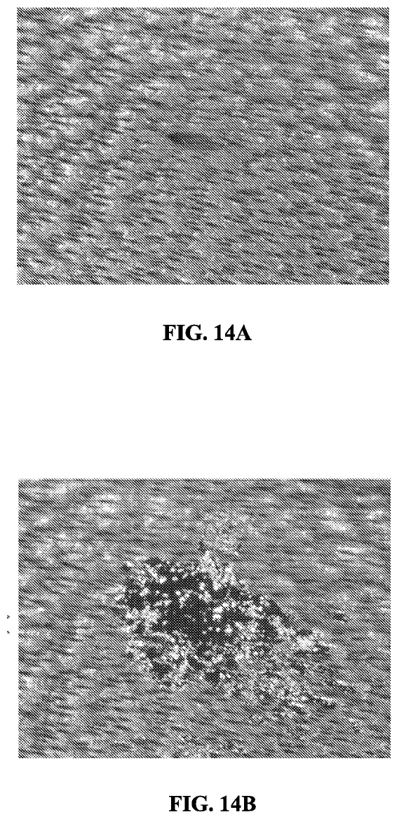

FIGS. 14A and 14B show application of a defect filler composition using a brush pen applicator; FIG. 14A: unfilled defect; and FIG. 14B: filled defect.

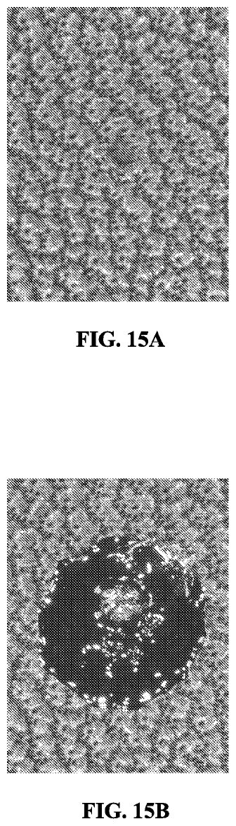

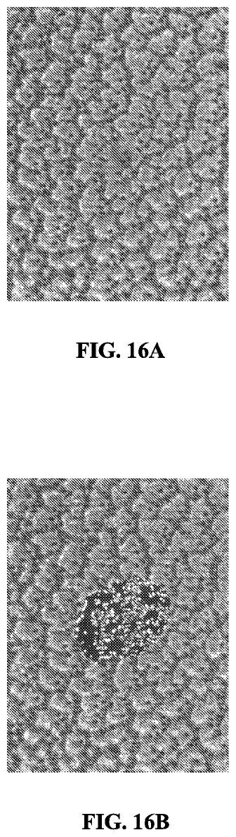

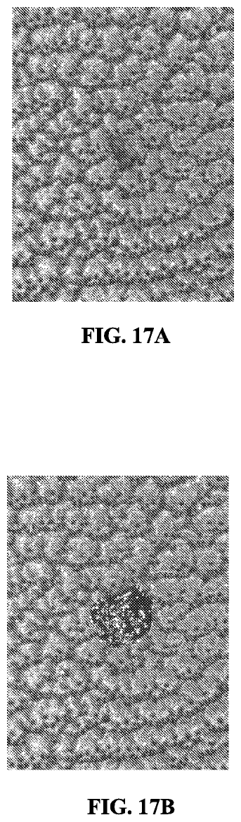

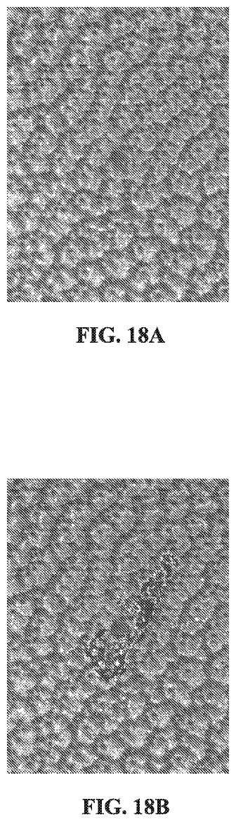

FIGS. 15A and 15B show application of a defect filler composition using a pipette applicator; FIG. 15A: unfilled defect; and FIG. 15B: defect filled with 10 μL high concentration (˜21% w/v) silk composition. FIGS. 16A and 16B show application of a defect filler composition using a pipette applicator; FIG. 16A: unfilled defect; and FIG. 16B: defect filled with 5 μL high concentration (˜21% w/v) silk composition. FIGS. 17A and 17B show application of a defect filler composition using a pipette applicator; FIG. 17A: unfilled defect; and FIG. 17B: defect filled with 1 μL high concentration (˜21% w/v) silk composition. FIGS. 18A and 18B show application of a defect filler composition using a pipette applicator; FIG. 18A: unfilled defect; and FIG. 18B: defect filled with 0.1 μL high concentration (˜21% w/v) silk composition. Volumes ranging between 5 μL and 1 μL appear optimal for filling certain small defects.

On the application of silk/silk blends to leather surface: the silk/silk blend can be applied for the purpose of addressing defects in the following manners—handheld manual tools such as brushes, scrapers, paddles; dipping an entire skin in a silk/silk blend; a compound application tool such as a silk “pen”, or gel applicator (“hot glue gun”-like applicator); direct pouring of silk/silk blend onto skin or skin section; by a gloved hand or finger; by a print jet nozzle or a similar automated application device or system.

### Example 3: Aqueous Formulations of Silk Fibroin for Repairing, Masking, or Hiding Follicle or Other Defects in Leather

Aqueous formulations of silk fibroin and those blended with a variety of additives, including Gellan Gum (GG) and Glycerol (GLY) can be applied as even coatings on the surface of leathers (including lambskin) in order to fill in and disguise “pinhole” defects present on the leather surface. These formulations are compatible with and can sustain the chemical agents and mechanical treatments typically employed in the standard industry finishing process for lambskin leathers. The ability of these formulations to fill in and “mask” specific defect types allows finished leather skins that would normally be graded as Grade II and III skins to be given a Grade I selection, increasing their resale value to textile partners. This allows leather tanneries to augment their manufacturing practices in a way that increases the proportion of Grade I skins on hand using a coating process that is sustainable and compatible with all aspects of leather processing after the Dye Stage.

Table 2 details the range of Silk-based coatings formulated with GG and GLY, their characteristics and relevant process parameters.

TABLE 2
Silk-based coatings formulated with GG and GLY

| | Concentration | | | Wet Coating | |
|---|---|---|---|---|---|
| | (% wt. OR % vol. | | | Thickness | |
| Additive | silk solution) | | pH | (μm) | Titrants |
| GG | 0.1-1.0% | wt. | 5-10 | 4-60 | NH₄OH (5%) |
| | | | | | Citric Acid |
| | | | | | (10% w/v) |
| GLY | 0.1-25% | vol. | 5-10 | 4-60 | NH₄OH (5%) |
| | | | | | Citric Acid |
| | | | | | (10% w/v) |

Both GG- and GLY-silk formulations were made using MID (medium) molecular weight silk at a silk solution concentration of 6% w/v (60 mg/mL), though that concentration can vary from 0.5-10% w/v (5-100 mg/mL). The final prepared formulations were applied to leather skin samples using a wire bar coater (TQC industries).

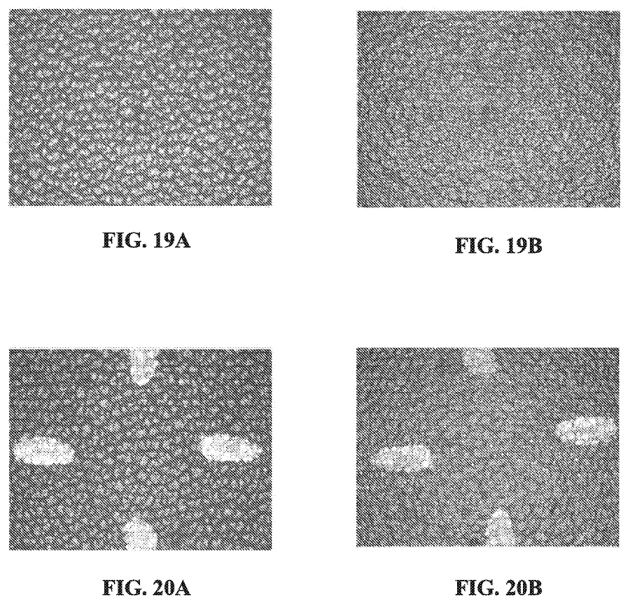

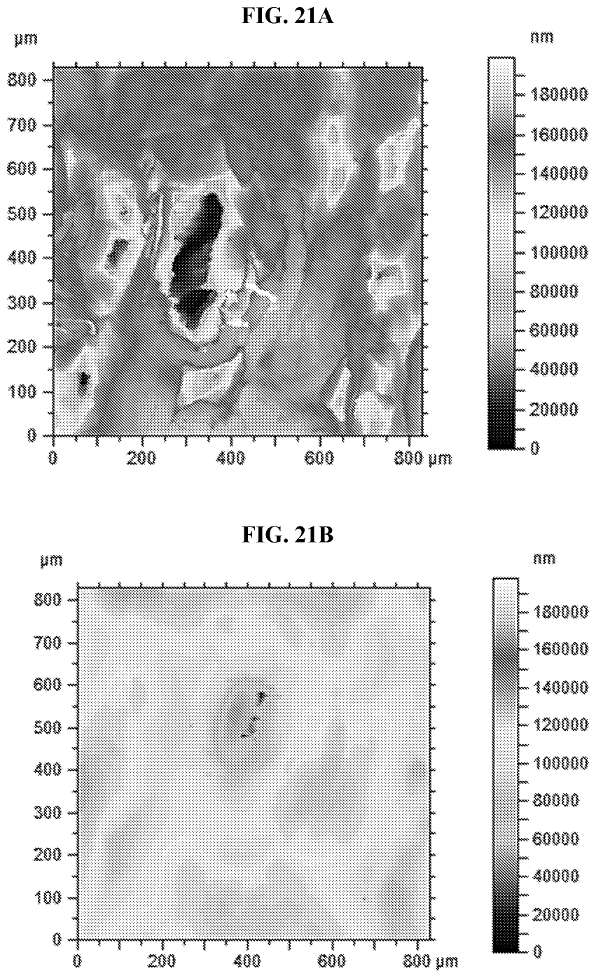

FIGS. 19A and 19B illustrate before and after images of a leather sample coated with a GG-silk formulation variant; leather sample before (FIG. 19A) and after (FIG. 19B) coating with Silk+0.5% wt. GG pH 9.75; coating applied using wire bar coater 20 μm (TQC Industries); defect is in the center of the field of view of all images, magnification is approximately 3×. FIGS. 20A and 20B illustrate before and after images of a leather sample coated with a GLY-silk formulation variant; leather sample before (FIG. 20A) and after (FIG. 20B) coating with Silk+10% vol. GLY pH 8; coating applied using wire bar coater 20 μm (TQC Industries); defect is in the center of the field of view of all images, magnification is approximately 3×.

### Example 4: Optical Profilometry of Point Filling with 5 μL 6% Mid Silk-GG

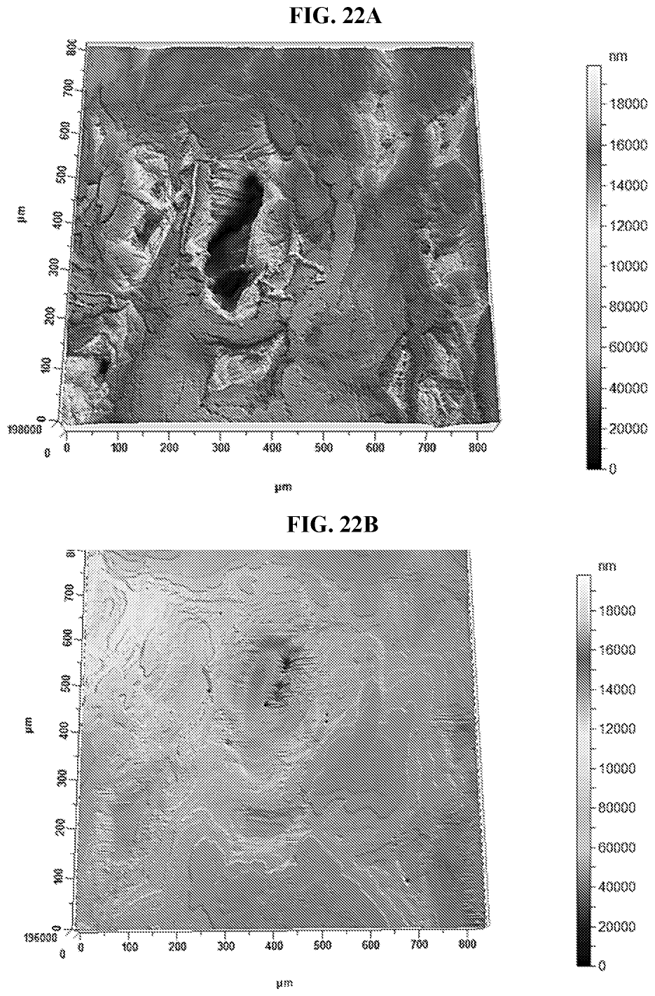

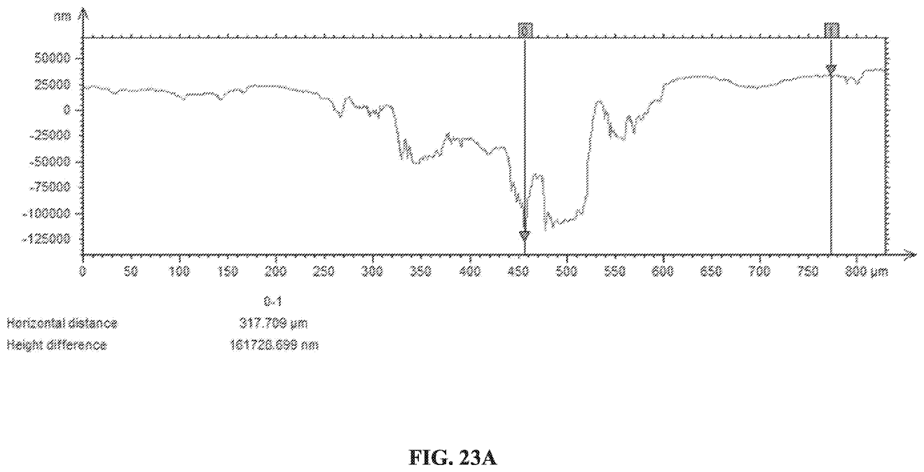

2D and 3D images and one dimensional topography traces of leather samples coated with GG-silk were obtained by optical profilometry. FIGS. 21A and 21B illustrate before and after images (2D) of a leather sample coated with GG-silk before (FIG. 21A) and after (FIG. 21B) coating with Silk+0.5% wt. GG via point filling. Defect is in the center of the field of view of both images. Images were captured using a Taylor Hobson CCI HD optical profilometer. FIGS. 22A and 22B illustrate before and after images (3D) of a leather sample coated with GG-silk before (FIG. 22A) and after (FIG. 22B) coating with Silk+0.5% wt. GG via point filling. Defect is in the center of the field of view of both images. Images were captured using a Taylor Hobson CCI HD optical profilometer. FIGS. 23A and 23B illustrate before and after topography traces of a leather sample coated with GG-silk before (FIG. 23A) and after (FIG. 23B) coating with Silk+0.5% wt. GG via point filling. Traces were captured using a Taylor Hobson CCI HD optical profilometer.

### Example 5: Modulating Viscosity of Silk Fibroin-Based Coatings for Filling Defects on Leather

Various polysaccharides, including Low-acyl content Gellan gum (GG) can be used as rheology modifiers for silk-based formulations so they may be applied as coatings on leather surfaces. Varying the weight content of GG alters the viscosity of the formulation, which in turn allows the silk fibroin component to provide various finishing and filling/masking/impregnation effects.

Silk fibroin solutions that are too fluid tend to penetrate too deeply into certain leather variants such as lambskin, reducing their efficiency and applicability as filling/masking agents for surface defects. Using GG to increase the viscosity of the silk formulation allows the fibroin protein to settle closer to the grain-side surface of the leather, allowing more of the dry weight fraction of the silk to settle into defect cavities, thus providing more efficient filling.

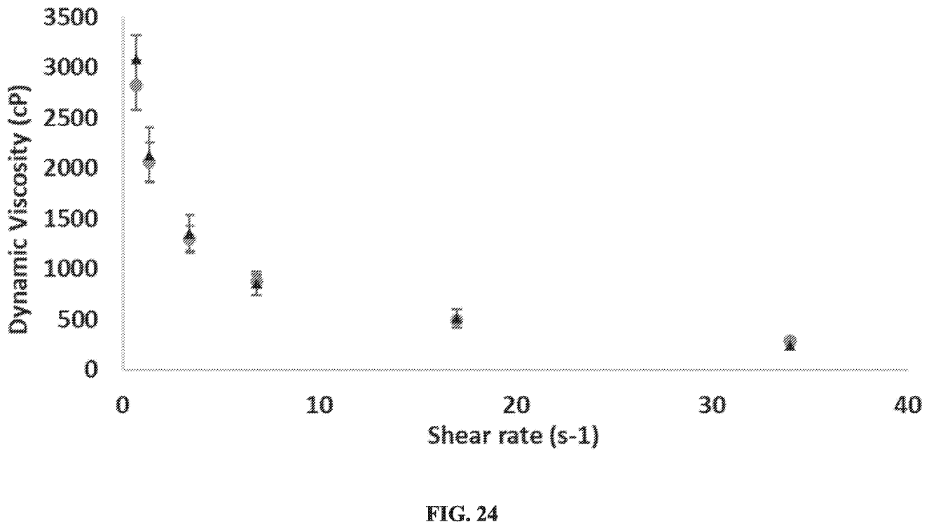

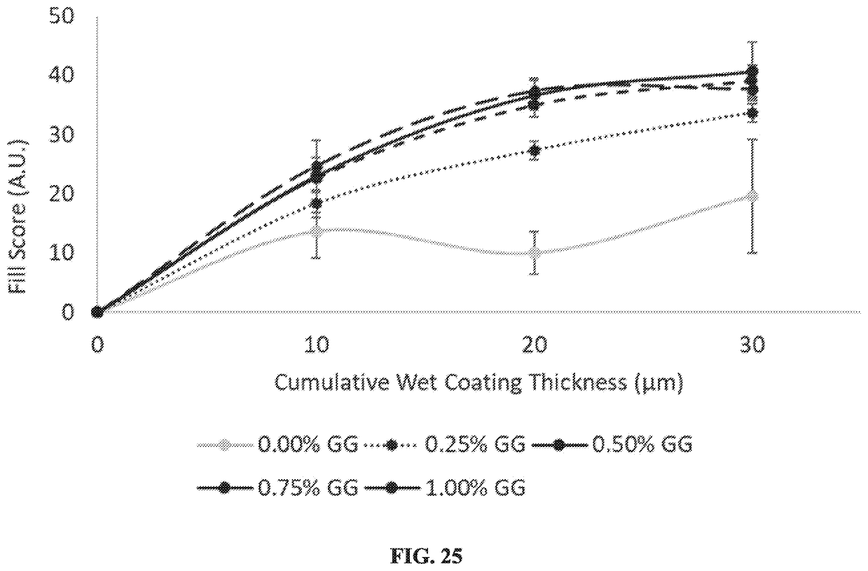

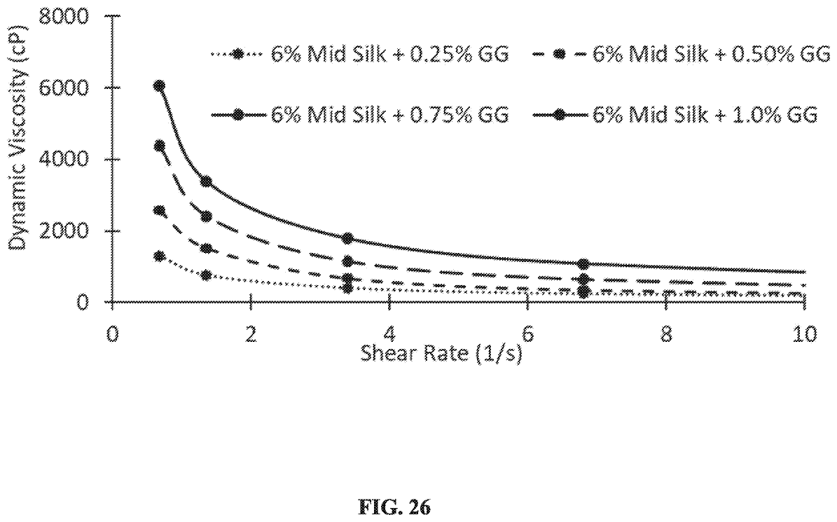

FIG. 24 is a chart illustrating viscosity as a function of shear rate for two independent batches of silk-based coating formulations for leather (6% MID MW silk fibroin+0.5% w/v GG). Batch A (Triangle) and Batch B (Circle) refer to two separate manufacturing batches of purified silk fibroin solution—the curve illustrates the reproducibility of the silk formulations after the addition of Gellan gum in terms of their rheological properties. FIG. 25 is a chart illustrating the fill score as a function of Gellan gum (GG) content. Higher GG concentration (higher viscosity) silk formulations demonstrated improved defect filling compared to lower GG concentration formulations. N=3 replicate coating samples per treatment group. FIG. 26 is a chart illustrating viscosity as a function of shear rate for 6% Mid MW silk fibroin solutions containing different concentrations of GG.

### Example 6: Silk Fibroin-Based Defect Filling Agents for Lambskin Leather

Surface defects on leather, for example lambskin leather, decrease the value of the skins and limits the overall available supply. Aqueous formulations of silk fibroin and those blended with a variety of additives, including Low-acyl content Gellan gum (GG) can be applied as even coatings on the surface of leathers (including lambskin) in order to fill in and disguise “pinhole” defects present on the leather surface. These formulations are compatible with and can sustain chemical agents and mechanical treatments typically employed throughout standard finishing processes for lambskin leathers.

Finishing formulations based on natural chemistry platforms such as silk fibroin that can fill in and mask these defects not only address this issue but do so in a sustainable manner. Specifically, the ability of these formulations to fill in and “mask” specific defect types allows finished leather skins that would normally not be selected as ‘top grade’ be given top grade selection, thus increasing their resale value to textile partners. This allows leather tanneries to augment their manufacturing practices in a way that increases the proportion of top grade skins on hand using a coating process that is sustainable and compatible with all aspects of leather finishing.

Summarized in Table 3 are exemplary silk-based coatings formulated with GG and other additives, their characteristics and relevant process parameters. Silk Fibroin-GG (SF-GG) formulations can be made using MID or LOW molecular weight silk at a silk solution concentration of 6% w/v (60 mg/mL), though that concentration can vary from 0.5-12% w/v (5-125 mg/mL).

TABLE 3
Silk-fibroin formulations

| Additive | Concentration | | Descriptor |
|---|---|---|---|
| Gellan Gum | 0.1-1.0% | w/v | Rheology Modifier |
| Carrageenan Gum | | | |
| Xanthan Gum | | | |
| Glycerol | 0.0-100 | mg/mL | Plasticizer |
| Sorbitol | | | |
| Glucose | | | |
| Sucrose | | | |
| Dextrose | | | |
| PEG 200, 400 | | | |
| Kollasol LOK | 0.0-1.0 | g/L | De-foaming agent |
| Stahl DF-13-444 | | | |

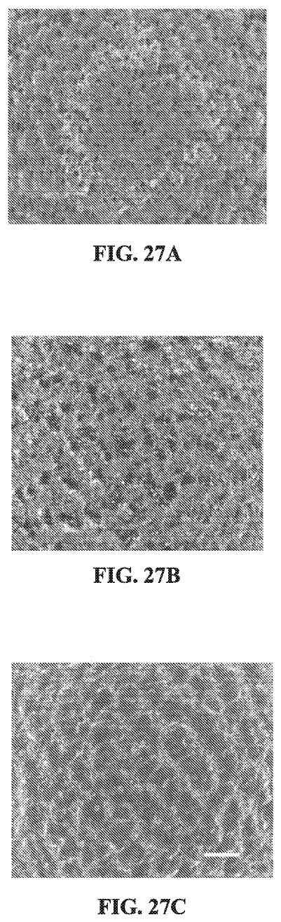

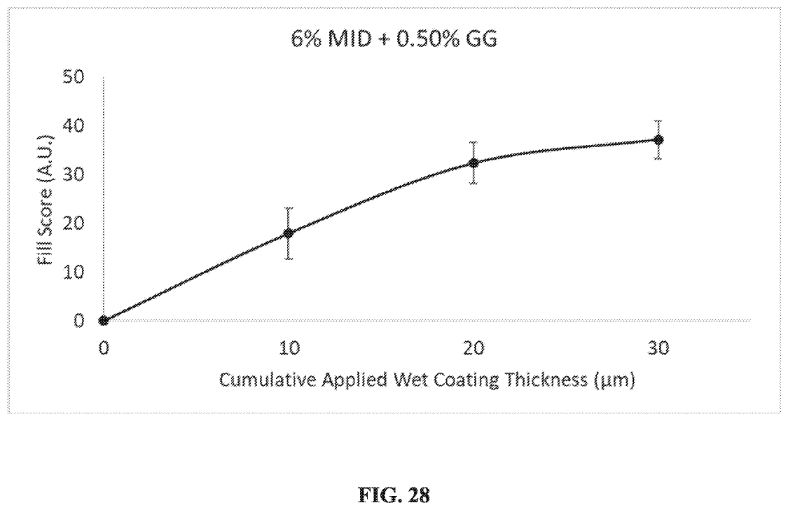

FIGS. 27A-27C are microscope images of lambskin leather sample coated with an SF-GG formulation variant. Leather sample before (FIG. 27A), after (FIG. 27B) coating with 6% MID MW Silk+0.5% w/v GG pH 9.75, and after finishing (FIG. 27C). The coating was applied using a wire bar coater (20 μm—TQC Industries). The defect site is in the center of the field of view all images, magnification is approximately 3×, scale bar approximately 1.0 mm. FIG. 28 illustrates an example defect filling performance for one SF-GG formulation variant (6% MID MW silk fibroin+0.5% w/v GG) applied to lambskin leather containing 10 defect sites. The coating was applied over n=3 layers using a wire bar coater (10 μm TQC Industries). Data points shown are the average of N=20 sample coatings.

Summarized in Table 4 are mechanical data for tensile testing of films cast from various silk-based coating formulations. Data was captured on an Instron system in a tension regime, data reported is mean±standard deviation for n=5 sample films (film thickness 95-200 μm).

TABLE 4
Tensile Strength Data for Cast Films of Silk-fibroin Formulations

| | Ultimate Tensile | Elongation | Modulus |
|---|---|---|---|
| Sample ID | Strength (MPa) | at Break (%) | (MPa) |
| 6% Mid MW | 48.78 ± 5.07 | 3.2 ± 0.9 | 19.44 ± 1.21 |
| 6% Low MW | 37.25 ± 10.20 | 3.0 ± 0.9 | 17.73 ± 2.38 |
| 1:1 Low:Mid MW | 46.08 ± 4.21 | 3.1 ± 1.1 | 19.20 ± 3.10 |
| 6% Mid MW + | 25.10 ± 11.85 | 1.8 ± 0.6 | 19.68 ± 2.30 |
| 0.5% w/v GG | | | |
| 6% Mid MW + 50% | 4.32 ± 1.72 | 52.1 ± 33.2 | 0.78 ± 0.26 |
| w/v GLY | | | |

### Example 7: Quantifying Defect Filling Performance of Silk-Fibroin Based Coatings on Leather

A combined visual and microscopy-based method designed to quantitatively differentiate the ability of various silk-based coatings to fill and/or mask pinhole surface defects on leather substrates is described. When comparing filling performance between a variety of coating formulations, it is often difficult to objectively compare how efficient one coating variant is over another in terms of its ability to fill and mask surface defects for a given applied coating mass. The method procedure is outlined below, with the specifics of the ‘Fill Score’ metric detailed in Table 5.

Sample Preparation: Leather samples are prepared at least in triplicate for each individual coating formulation to be tested. Cut samples in 3″×3″ squares with each containing at least N=10 surface ‘pinhole’ defects. Using the Lightbox (City+Residential lighting combined setting), carefully circle each of the 10 surface defects using a black pen, with a guide line aligned with the defect in the center of the circle so that all microscope images of the defect site are in the same orientation. Defects should be chosen that are at least ˜2-3 cm from the edge of the leather sample. Number the defect sites 1 through 10 using a silver Sharpie marking pen. Prior to coating the samples, image each defect site for each sample using the light microscope and weight the samples. Store sample images in such a way that each replicate maintains its own folder of sample images throughout the coating process.

Coating and Image Collection: After all uncoated samples have been weighed and imaged, clip the first sample onto the glass application table so that there is at least 3 cm between the bottom of the clip and the first defect. Using a 3 mL plastic pipette draw up 1-2 mL of coating formulation and deposit a trace onto the top of the leather sample above the defects. Exerting light downward pressure, place the 10 μm bar above the fluid trace and draw it down past the bottom edge of the leather sample. Take care not to rotate the bar or create uneven ‘pooling’ areas of coating formulation. Allow coated samples to dry under ambient conditions for at least 10-15 minutes after coating. After samples are dry, observe each of them in the lightbox and visually assess each defect site on each sample—record if any sites achieve scores of a 4 or 5 using the ratings scale in Table 5. Remove sample from the Lightbox and image each defect site on each sample using the light microscope. Weigh each sample using the digital balance. Repeat steps as needed (one, two, three more times, etc.) until several total rounds of coating, visual analysis and image collection have been completed. Once all coating, visual scoring and image collection has been completed for all samples, generate Fill Scores for all remaining defect sites that did not receive scores of 4 or 5 via visual analysis in between coating layers. Use the score system described in Table 5 to assign scores to all defect sites. Once all defect sites across all coating groups have received a fill score, generate a SUM score for each replicate by adding up the total scores for all 10 defect sites for each coating layer (layers 0, 1, 2, 3). SUM score metric ranges from 0 (all sites uncoated/completely unaffected by coating) to 50 (all sites filled and not visible to naked eye). Average the SUM score across all replicates for each experimental coating group calculated for each coating layer. Statistically significant differences in filling performance between coating groups are calculated using the Student's t-test for independent means.

Summarized in Table 5 is a scoring system developed to assign fill scores to individual defect sites present on a leather swatch (3″×3″). For each coating variant, N=3 swatches are coated in 10 μm increments (up to three layers per treatment), and each individual defect site (identified by the experimenter) is assigned a score after 0, 1, 2, and 3 layers have been applied. Those scores are summed across the 10 defect sites per swatch and then that sum is averaged across the three coating replicates to give the Fill Score metric for 0, 10 μm, 20 μm, and 30 μm of cumulative applied coating thickness.

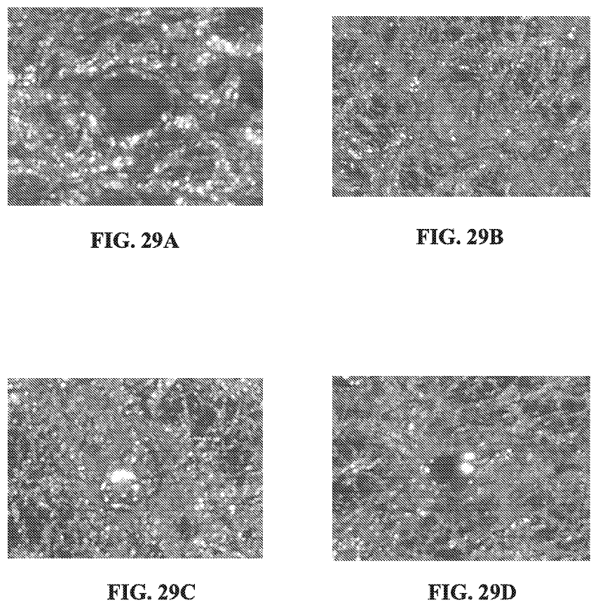

TABLE 5
Scoring System for Defect Fillings

| Score | Description | Exemplary Image |
|---|---|---|
| 0 | Uncoated defect site - coating has either not | FIG. 29A |
| | been applied or completely misses the defect | |
| | area (score assigned after assessment of | |
| | microscopy image) | |
| 1 | Minor reduction of defect size around edges of | FIG. 29B |
| | cavity - no filling or aggregation of coating in | |
| | defect cavity (score assigned after assessment | |
| | of microscopy image) | |
| 2 | Partial filling of defect cavity - noticeable | FIG. 29C |
| | build-up or partial build-up of coating material | |
| | (score assigned after assessment of | |
| | microscopy image) | |
| 3 | Defect appears filled, edges of coating | FIG. 29D |
| | formulation appear flush with grain surface | |
| | around defect site (score assigned after | |
| | assessment of microscopy image) | |
| 4 | Defect is filled with no meniscus/is flush | N/A |
| | with the grain of the leather but defect site can | |
| | still be seen with the naked eye (score | |
| | assigned after visual assessment) | |
| 5 | Defect is filled with no meniscus/is flush | N/A |
| | with the grain of the leather and the site can no | |
| | longer be identified by the observer after 5 | |
| | seconds within the area identified as | |
| | containing a defect (score assigned after | |
| | visual assessment) | |

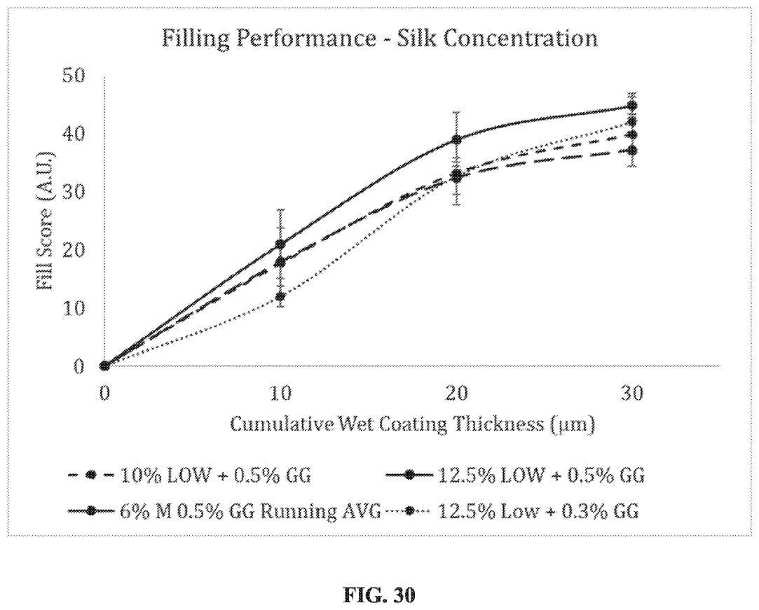

FIG. 30 illustrates an example Fill Score chart—Fill score as a function of applied wet coating thickness for various concentrations of silk fibroin-based formulations (3 applications at 10 μm using a wire bar coater—TQC Industries). Different silk concentrations for low MW (10-12.5% w/v) and mid MW (6% w/v) affect efficiency of filling as additional coating layers are applied. Higher silk concentrations and higher-GG content (12.5% w/v low mw+0.5% GG) formulations tend to demonstrate better filling characteristics than lower silk- and lower GG-content formulations.

### Example 8: Water Annealing of Silk Fibroin on Lambskin Leather for Water Resistant Effect

A process called “water annealing” can be used to make a silk coating on leather more water resistant. For some applications and use cases, it is important for leather to be able to repel water. Most water-repellant coatings are synthetic, and are often fluorinated chemicals. There exists a need for a more natural water-repellant leather coating. By coating leather with silk and performing the water annealing method, a natural water repellant coating can be accessed. Water annealing of silk materials is described in general in Hu et al., Biomacromolecules. 2011 May 9; 12(5): 1686-1696.

Sample Preparation: Each sample is affixed to a cardboard panel with tape and hand sprayed (ca. 10 psi) from a distance of approximately 6″ using the solution(s) indicated in Table 6. The spraying is done twice in succession—first in a quick up-down motion and then in a quick left-right motion. Total exposure time of leather is approximately 1.5-2 seconds; The leather is allowed to dry for at least 30 minutes; The leather is placed in a vacuum chamber (Realflo Stainless Steel Vacuum Chamber) with a petri dish of approx. 2 mL of DI water under static vacuum at approx. −14 psi. The time used to water anneal varies depending on the experiment; After water annealing, the leather is allowed to rest for at least 30 minutes.

Performance Test: A plastic pipette is used to dispense one drop of DI water on the surface of the silk-treated leather. The water drop is allowed to sit on the leather for 30 seconds and then is wiped away; The coated leather is inspected for the presence of a watermark on the leather. If no watermark is present, it is said that the coating is water resistant.

TABLE 6
Treatment parameters for exemplary leather samples

| | | Test |
|---|---|---|
| Sample | Treatment | Result |
| STI- | Handspray with 50% Uniseal 9049 in water for | Fail |
| 18080701- | four seconds. | |
| T029 | Let sit 30 minutes | |
| | Handspray with 6% Mid Silk in water according to | |
| | the procedure above. | |
| | Let sit 30 minutes. | |
| STI- | Handspray with 50% Uniseal 9049 in water for | Pass |
| 18080701- | four seconds. | |
| T030 | Let sit 30 minutes | |
| | Handspray with 6% Mid Silk in water according to | |
| | the procedure above. | |
| | Let sit 30 minutes. | |
| | Water anneal for 4 hours according to the | |
| | procedure above. | |

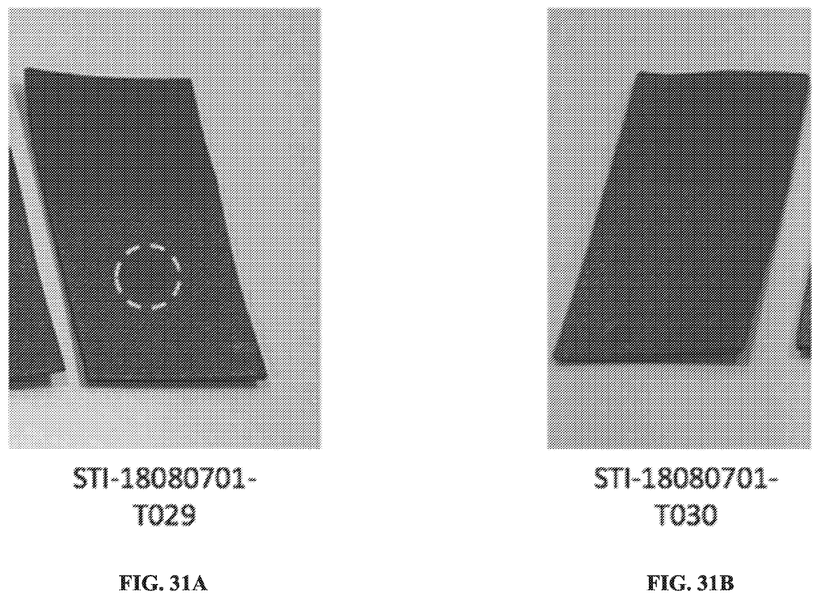

FIGS. 31A and 31B are images of leather samples STI-18080701-T029 (not water annealed; FIG. 31A) and STI-18080701-T030 (water annealed; FIG. 31B). After the water drop has been wiped away, no water drop remains on STI-18080701-T030 (FIG. 31B).

### Example 9: Silk Fibroin-Based Color Saturation Spray Treatments for Lambskin Leathers

Silk formulations applied to leather increases the saturation of leather color, and the amount of color change can be tuned by silk concentration. It is important for leather manufacturers to be able to access a wide variety of leather colors in order to satisfy the market's desire for new, rich leathers. Using a silk spray treatment in conjunction with typical dyeing techniques yields a palette of richer, more saturated colors to be used in leather production. In some embodiments, silk applied after dyeing yields a richer color.

Sample Preparation: Samples are hand sprayed with the silk formulations summarized in Table 7. Each sample is affixed to a cardboard panel with tape and hand sprayed (ca. 10 psi) from a distance of approximately 6″ using the solution indicated in Table 7. The spraying is done twice in succession—first in a quick up-down motion and then in a quick left-right motion. Total exposure time of leather is approximately 1.5-2 seconds.

TABLE 7
Description of Sample Preparation for
Leather Used in Color Saturation Study

| Sample | Substrate | Spray Coating |
|---|---|---|
| RSD-TXTL-287-T001 | Black bovine | None |
| RSD-TXTL-287-T002 | Brown lamb skin | None |
| RSD-TXTL-287-T003 | Magenta lamb skin | None |
| RSD-TXTL-287-T004 | Orange lamb skin | None |
| RSD-TXTL-287-T005 | Black bovine | 6% Mid |
| RSD-TXTL-287-T006 | Brown lamb skin | 6% Mid |
| RSD-TXTL-287-T007 | Magenta lamb skin | 6% Mid |
| RSD-TXTL-287-T008 | Orange lamb skin | 6% Mid |
| RSD-TXTL-287-T009 | Black bovine | 6% Low |
| RSD-TXTL-287-T010 | Brown lamb skin | 6% Low |
| RSD-TXTL-287-T011 | Magenta lamb skin | 6% Low |
| RSD-TXTL-287-T012 | Orange lamb skin | 6% Low |

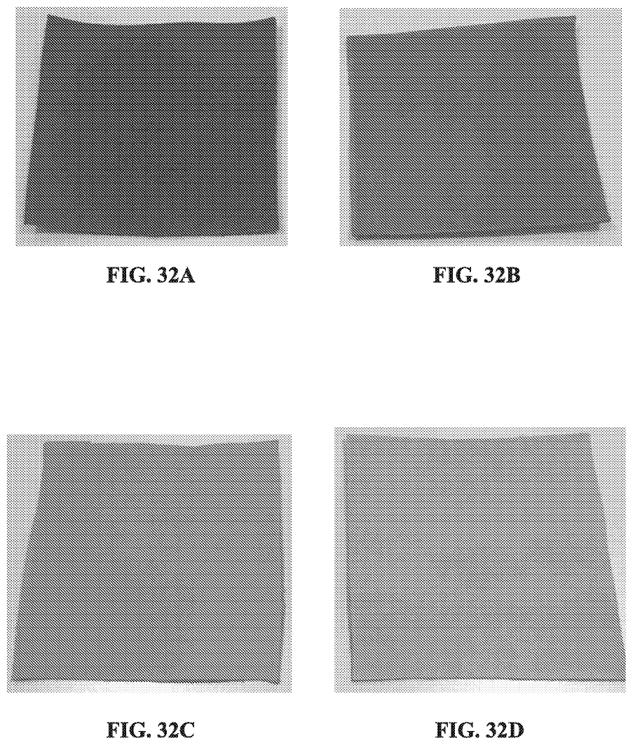

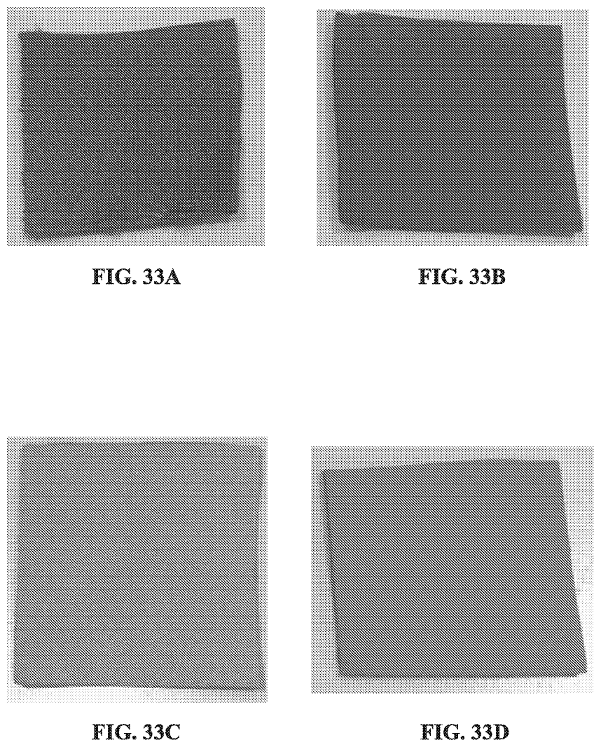

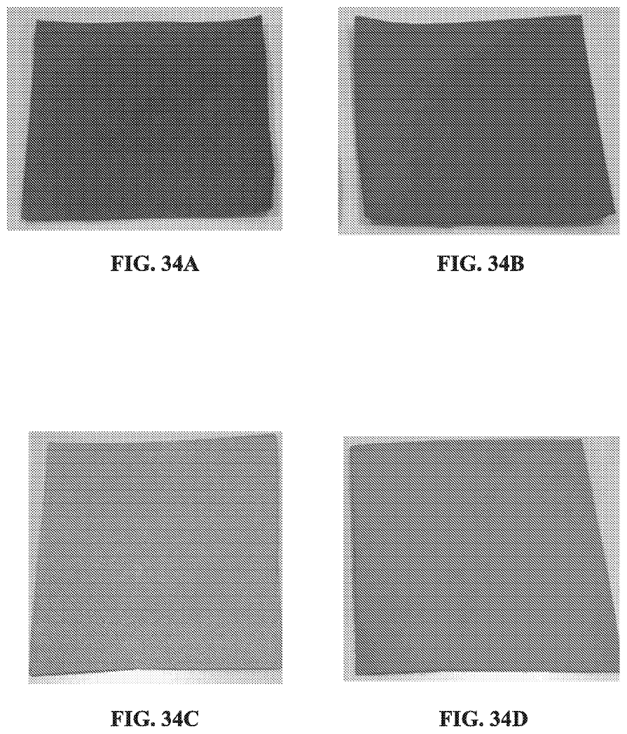

The silk-treated samples have a different color saturation from the untreated samples, as shown in FIGS. 32A-32D, 33A—33D, and 34A—34D, and summarized in Table 8. Colorimetry data was collected using a CM-700d Spectrophotometer (Konica Minolta).

L*, a*, and b* refer to the color parameters defined in the CIELAB color space, where L* is a measure of lightness from black (0) to white (100), a* is a measure of green (−) to red (+), and b* is a measure of blue (−) to yellow (+). The data in Table 8 show that the hue and saturation of leather is different for silk-coated vs non-silk-coated leather samples.

TABLE 8
Colorimetry data for samples T001-012

| | L* Avg | a* Avg | b* Avg |
|---|---|---|---|
| T001 | 23.4 ± 0.3 | 0.1 ± 0.1 | −0.7 ± 0.1 |
| T005 | 26.2 ± 0.4 | 0.0 ± 0.2 | −0.8 ± 0.1 |
| T009 | 26.4 ± 0.2 | 0.0 ± 0.0 | −0.9 ± 0.0 |
| T002 | 32.9 ± 1.4 | 8.9 ± 0.0 | 13.3 ± 0.3 |
| T006 | 27.5 ± 0.9 | 7.8 ± 0.3 | 9.6 ± 0.5 |
| T010 | 29.6 ± 1.3 | 8.7 ± 0.1 | 11.5 ± 0.8 |
| T003 | 36.7 ± 0.2 | 57.0 ± 0.1 | −3.0 ± 0.2 |
| T007 | 41.8 ± 0.2 | 52.5 ± 0.3 | 0.4 ± 0.8 |
| T011 | 42.0 ± 0.3 | 53.3 ± 0.4 | 0.5 ± 1.2 |
| T004 | 48.0 ± 0.4 | 37.7 ± 0.4 | 25.8 ± 0.4 |
| T008 | 39.5 ± 0.5 | 35.8 ± 0.5 | 24.8 ± 0.7 |
| T012 | 43.3 ± 0.1 | 37.8 ± 0.1 | 26.8 ± 0.2 |

### Example 10: Silk Fibroin-Based Gloss Enhancers for Lambskin Leathers

Silk formulations applied to leather increase the glossiness of leather, and the amount of gloss can be tuned with silk concentration. A glossy, lustrous appearance is often desired for finished leather articles. Leather alone does not have this glossy aspect. Usually glossiness is achieved using synthetic resins or additives. As described herein, naturally-derived silk fibroin can be used to produce similar or better levels of gloss.

Sample Preparation: Samples are hand sprayed with the silk formulation indicated in Table 9. Each sample is affixed to a cardboard panel with tape and hand sprayed (ca. 10 psi) from a distance of approximately 6″ using the solution indicated in Table 9. The spraying is done twice in succession—first in a quick up-down motion and then in a quick left-right motion. Total exposure time of leather is approximately 1.5-2 seconds. Samples are left out to dry for 15 minutes between applications.

TABLE 9
Sample Preparation for Blue Leather Used in Gloss Study

| Sample | Substrate | Testing Article | Spray 1 | Spray 2 | Spray 3 |
|---|---|---|---|---|---|
| T001A | Black bovine | Water | Water | Water | Water |
| T001B | leather | Water | Water | Water | Water |
| T001C | | Water | Water | Water | Water |
| T002A | | Low MW Silk | 0.57% | 0.57% | 1.41% |
| T002B | | Low MW Silk | Silk | Silk | Silk |
| T002C | | Low MW Silk | | | |
| T006A | | Mid MW Silk | | | |
| T006B | | Mid MW Silk | | | |
| T006C | | Mid MW Silk | | | |

Samples treated with silk instead of water are significantly glossier, as shown by gloss data (Table 10). 60° gloss values were generated using a WG60 Precision Glossmeter.

TABLE 10
Gloss values for leather samples after coating
with various materials (water or silk)

| | | Gloss Before | Gloss After |
|---|---|---|---|
| Sample | Coating Material | Coating | Coating |
| T001A | Water | 7.6 | 6.7 |
| T001B | Water | 6.1 | 5.9 |
| T001C | Water | 6.7 | 7 |
| T002A | Low MW Silk TFF-001-0204 Mix | 7.2 | 24.6 |
| | (Scale-Up) | | |
| T002B | Low MW Silk TFF-001-0204 Mix | 8.4 | 24.3 |
| | (Scale-Up) | | |
| T002C | Low MW Silk TFF-001-0204 Mix | 8.6 | 25.6 |
| | (Scale-Up) | | |
| T006A | Mid MW Silk TFF-001-0411 | 7.3 | 18.6 |
| | (Scale-Up) | | |
| T006B | Mid MW Silk TFF-001-0411 | 7.7 | 19.5 |
| | (Scale-Up) | | |
| T006C | Mid MW Silk TFF-001-0411 | 10.2 | 24.9 |
| | (Scale-Up) | | |

### Example 11: Stenciling of Silk Fibroin on Lambskin Leather for Two-Toned Effect

Silk patterns can be applied to leather using a stencil. It is important for leather manufacturers to be able to access a wide variety of leather finishes, including colors, sheens, and patterns in order to satisfy the market's desire for new, rich leathers. Using a silk spray treatment in conjunction with a stencil yields leather with intricate patterns on the surface. Compared to patterned leathers made by etching techniques, the silk-stencil process described herein is more straightforward.

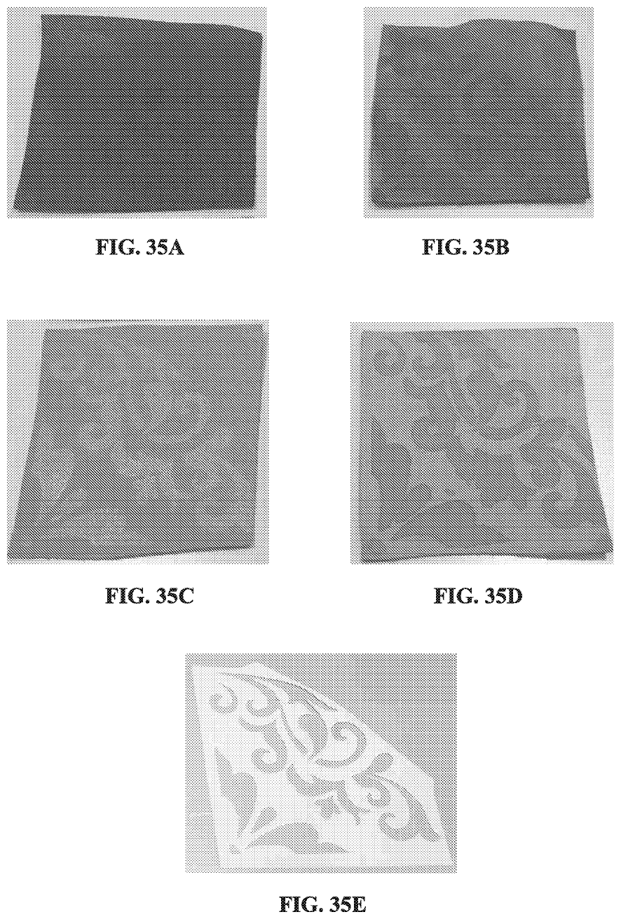

Sample Preparation: Samples are hand sprayed with the silk formulation indicated in Table 11. Each sample is affixed to a cardboard panel with tape with a stencil (FIG. 35E) on top of it and hand sprayed (ca. 10 psi) from a distance of approximately 6″ using the solution indicated in Table 11. The spraying is done twice in succession—first in a quick up-down motion and then in a quick left-right motion. Total exposure time of leather is approximately 1.5-2 seconds.

TABLE 11
Description of Sample Preparation
for Leather Used in Stencil Study

| Sample | Substrate | Spray Coating |
|---|---|---|
| RSD-TXTL-287-T013 | Black bovine | 6% Low with stencil |
| RSD-TXTL-287-T014 | Brown lambskin | 6% Low with stencil |
| RSD-TXTL-287-T015 | Magenta lambskin | 6% Low with stencil |
| RSD-TXTL-287-T016 | Orange lambskin | 6% Low with stencil |

Leather samples that are silk coated using a stencil provide an interesting and unique visual aspect (FIGS. 35A-35D; photographs of the leather samples T013-T016 (6% Low with stencil coating), along with the stencil used to make the coatings, FIG. 35E).

All patents, patent applications, and published references cited herein are hereby incorporated by reference in their entirety. While the methods of the present disclosure have been described in connection with the specific embodiments thereof, it will be understood that it is capable of further modification. Further, this application is intended to cover any variations, uses, or adaptations of the methods of the present disclosure, including such departures from the present disclosure as come within known or customary practice in the art to which the methods of the present disclosure pertain.

1. An article comprising a leather substrate and silk fibroin proteins or fragments thereof having an average weight average molecular weight in a range selected from between about 1 kDa and about 5 kDa, between about 5 kDa and about 10 kDa, between about 6 kDa and about 17 kDa, between about 10 kDa and about 15 kDa, between about 15 kDa and about 20 kDa, between about 17 kDa and about 39 kDa, between about 20 kDa and about 25 kDa, between about 25 kDa and about 30 kDa, between about 30 kDa and about 35 kDa, between about 35 kDa and about 40 kDa, between about 39 kDa and about 80 kDa, between about 40 kDa and about 45 kDa, between about 45 kDa and about 50 kDa, between about 60 kDa and about 100 kDa, and between about 80 kDa and about 144 kDa, and a polydispersity between 1 and about 5.

2. The article of claim 1, wherein the silk fibroin proteins or fragments thereof have a polydispersity between 1 and about 1.5, between about 1.5 and about 2, between about 2 and about 2.5, or between about 2.5 and about 3.

3-5. (canceled)

6. The article of claim 1, wherein the silk fibroin proteins or fragments thereof have a polydispersity between about 3 and about 3.5, between about 3.5 and about 4, between about 4 and about 4.5, or between about 4.5 and about 5.

7-9. (canceled)

10. The article of claim 1, further comprising about 0.001% (w/w) to about 10% (w/w) sericin relative to the silk fibroin proteins or fragments thereof.

11. The article of claim 1, wherein the silk fibroin proteins or fragments thereof do not spontaneously or gradually gelate and do not visibly change in color or turbidity when in an aqueous solution for at least 10 days prior to being added to the leather substrate.

12. The article of any one of claim 1, wherein a portion of the silk fibroin proteins or fragments thereof is coated on a surface of the leather substrate.

13. The article of claim 1, wherein a portion of the silk fibroin proteins or fragments thereof is infused into a layer of the leather substrate.

14. The article of claim 1, wherein a portion of the silk fibroin proteins or fragments thereof is in a recessed portion.

15. The article of claim 1, the article further comprising one or more polysaccharides selected from starch, cellulose, gum arabic, guar gum, xanthan gum, alginate, pectin, chitin, chitosan, carrageenan, inulin, and gellan gum.

16. The article of claim 15, wherein the gellan gum comprises low-acyl content gellan gum.

17. The article of claim 15, wherein the w/w ratio between the silk fibroin proteins or fragments thereof and the polysaccharide is selected from about 99:1, about 98:2, about 97:3, about 96:4, about 95:5, about 94:6, about 93:7, about 92:8, about 91:9, about 90:10, about 89:11, about 88:12, about 87:13, about 86:14, about 85:15, about 84:16, about 83:17, about 82:18, about 81:19, about 80:20, about 79:21, about 78:22, about 77:23, about 76:24, about 75:25, about 74:26, about 73:27, about 72:28, about 71:29, about 70:30, about 69:31, about 68:32, about 67:33, about 66:34, about 65:35, about 64:36, about 63:37, about 62:38, about 61:39, about 60:40, about 59:41, about 58:42, about 57:43, about 56:44, about 55:45, about 54:46, about 53:47, about 52:48, about 51:49, about 50:50, about 49:51, about 48:52, about 47:53, about 46:54, about 45:55, about 44:56, about 43:57, about 42:58, about 41:59, about 40:60, about 39:61, about 38:62, about 37:63, about 36:64, about 35:65, about 34:66, about 33:67, about 32:68, about 31:69, about 30:70, about 29:71, about 28:72, about 27:73, about 26:74, about 25:75, about 24:76, about 23:77, about 22:78, about 21:79, about 20:80, about 19:81, about 18:82, about 17:83, about 16:84, about 15:85, about 14:86, about 13:87, about 12:88, about 11:89, about 10:90, about 9:91, about 8:92, about 7:93, about 6:94, about 5:95, about 4:96, about 3:97, about 2:98, or about 1:99, about 100:1, about 50:1, about 25:1, about 24:1, about 23:1, about 22:1, about 21:1, about 20:1, about 19:1, about 18:1, about 17:1, about 16:1, about 15:1, about 14:1, about 13:1, about 12:1, about 11:1, abut 10:1, about 9:1, about 8:1, about 7:1, about 6:1, about 5:1, about 4:1, about 3:1, about 2:1, about 1:1, about 1:2, about 1:3, about 1:4, and about 1:5.

18. The article of claim 15, wherein the w/w ratio between the silk fibroin proteins or fragments thereof and the polysaccharide is selected from about 12:1, about 11.9:1, about 11.8:1, about 11.7:1, about 11.6:1, about 11.5:1, about 11.4:1, about 11.3:1, about 11.2:1, about 11.1:1, about 11:1, abut 10.9:1, abut 10.8:1, abut 10.7:1, abut 10.6:1, abut 10.5:1, abut 10.4:1, abut 10.3:1, abut 10.2:1, abut 10.1:1, abut 10:1, about 9.9:1, about 9.8:1, about 9.7:1, about 9.6:1, about 9.5:1, about 9.4:1, about 9.3:1, about 9.2:1, about 9.1:1, about 9:1, about 8.9:1, about 8.8:1, about 8.7:1, about 8.6:1, about 8.5:1, about 8.4:1, about 8.3:1, about 8.2:1, about 8.1:1, about 8:1, about 7.9:1, about 7.8:1, about 7.7:1, about 7.6:1, about 7.5:1, about 7.4:1, about 7.3:1, about 7.2:1, about 7.1:1, about 7:1, about 6.9:1, about 6.8:1, about 6.7:1, about 6.6:1, about 6.5:1, about 6.4:1, about 6.3:1, about 6.2:1, about 6.1:1, about 6:1, about 5.9:1, about 5.8:1, about 5.7:1, about 5.6:1, about 5.5:1, about 5.4:1, about 5.3:1, about 5.2:1, about 5.1:1, about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, and about 0.1:1.

19. The article of claim 1, the article further comprising one or more polyols, and/or one or more polyethers.

20. The article of claim 19, wherein the polyols comprise one or more of glycol, glycerol, sorbitol, glucose, sucrose, and dextrose.

21. The article of claim 19, wherein the polyethers comprise one or more polyethyleneglycols (PEGs).

22. The article of claim 19, wherein the w/w ratio between the silk fibroin proteins or fragments thereof and the one or more polyols and/or one or more polyethers is selected from about 5:1, about 4.9:1, about 4.8:1, about 4.7:1, about 4.6:1, about 4.5:1, about 4.4:1, about 4.3:1, about 4.2:1, about 4.1:1, about 4:1, about 3.9:1, about 3.8:1, about 3.7:1, about 3.6:1, about 3.5:1, about 3.4:1, about 3.3:1, about 3.2:1, about 3.1:1, about 3:1, about 2.9:1, about 2.8:1, about 2.7:1, about 2.6:1, about 2.5:1, about 2.4:1, about 2.3:1, about 2.2:1, about 2.1:1, about 2:1, about 1.9:1, about 1.8:1, about 1.7:1, about 1.6:1, about 1.5:1, about 1.4:1, about 1.3:1, about 1.2:1, about 1.1:1, about 1:1, about 0.9:1, about 0.8:1, about 0.7:1, about 0.6:1, about 0.5:1, about 0.4:1, about 0.3:1, about 0.2:1, about 0.1:1, about 1:0.1, about 1:0.2, about 1:0.3, about 1:0.4, about 1:0.5, about 1:0.6, about 1:0.7, about 1:0.8, about 1:0.9, about 1:1.1, about 1:1.2, about 1:1.3, about 1:1.4, about 1:1.5, about 1:1.6, about 1:1.7, about 1:1.8, about 1:1.9, about 1:2, about 1:2.1, about 1:2.2, about 1:2.3, about 1:2.4, about 1:2.5, about 1:2.6, about 1:2.7, about 1:2.8, about 1:2.9, about 1:3, about 1:3.1, about 1:3.2, about 1:3.3, about 1:3.4, about 1:3.5, about 1:3.6, about 1:3.7, about 1:3.8, about 1:3.9, about 1:4, about 1:4.1, about 1:4.2, about 1:4.3, about 1:4.4, about 1:4.5, about 1:4.6, about 1:4.7, about 1:4.8, about 1:4.9, and about 1:5.

23. The article of claim 1, the article further comprising one or more of a silicone, a dye, a pigment, and a polyurethane.

24-65. (canceled)
